(19) United States
(12) Patent Application Publication
(10) Pub. No.: US 2025/0206974 A1
(43) Pub. Date: Jun. 26, 2025

(54) ELECTRO-OPTIC INK COMPOSITION, COMPOUND, ELECTRO-OPTIC FILM, AND ELECTRO-OPTIC ELEMENT

(71) Applicant: Sumitomo Chemical Company, Limited, Chuo-ku, Tokyo (JP)

(72) Inventors: Takahiro SATO, Tsukuba-shi, Ibaraki (JP); Arihiro YASHIRO, Tsukuba-shi, Ibaraki (JP)

(21) Appl. No.: 18/848,510

(22) PCT Filed: Mar. 13, 2023
(86) PCT No.: PCT/JP2023/009632

§ 371 Date: Sep. 18, 2024

(30) Foreign Application Priority Data
Apr. 1, 2022 (JP) 2022-061954

(51) Int. Cl. C09D 11/52; G02F 1/061

(52) U.S. Cl. CPC C09D 11/52; G02F 1/061; G02F 2202/021

(57) ABSTRACT

An electro-optic ink composition containing at least one compound selected from a compound of formula (1′) and a compound of formula (1″), and an organic solvent having a boiling point of 120° C. or higher and a dipole moment of less than 3.0 debye.

D¹-X¹-A¹ (1′)

D¹ represents an electron-donating group. X¹ represents a predetermined divalent conjugated linking group or the like. A¹ represents a group of formula (a1).

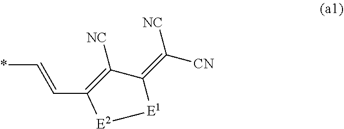

### TECHNICAL FIELD

The present invention relates to an electro-optic ink composition, a compound, an electro-optic film, and an electro-optic element.

### BACKGROUND ART

As an electro-optic (hereinafter, also abbreviated as “EO”) material applicable to a light control element (optical element) such as an optical modulator, an optical switch, an optical interconnect, an optoelectronic circuit, wavelength conversion, an electric field sensor, terahertz (THz) wave generation and detection, or an optical phased array, an inorganic ferroelectric EO material is conventionally used. However, the inorganic ferroelectric EO material has limitations in terms of high speed, miniaturization, and integration. Therefore, in order to achieve next-generation ultra-high-speed optical communication, a material capable of high-speed operation and capable of hybrid with silicon photonics is required.

An organic EO material has attracted attention from such a viewpoint. The organic EO material exhibits a large electro-optic effect as compared with the inorganic ferroelectric EO material, can operate at high speed, and can be miniaturized and integrated by hybrid with silicon photonics, and thus is expected as a material that performs next-generation optical communication.

A compound used for the organic EO material (hereinafter, also referred to as an “EO compound”) has, as a basic structure, a structure in which an electron donating donor and an electron withdrawing acceptor are linked by a divalent conjugated linking group. In order to increase an electro-optic coefficient (EO coefficient) of the EO material, it is known to adopt a donor having a high electron donating property and an acceptor having a high electron withdrawing property for the EO compound to increase the length of the divalent conjugated linking group. As an EO compound having such a structure, EO compounds having various structures have been reported (for example, Patent Document 1 and Non-Patent Document 1).

In preparing an EO element in which an optical waveguide is formed of an organic EO material, an EO ink composition containing an EO compound and an organic solvent is applied onto a substrate, the organic solvent is volatilized, and then the EO compound may be subjected to an orientation treatment in order to generate a secondary EO activity of the organic EO material (dry product of the EO ink composition). As a method for subjecting an EO compound to an orientation treatment, an electric field poling method is generally used. The electric field poling method is a method in which an electric field is applied to an EO material, and an EO compound is oriented in a direction of the applied electric field by a Coulomb force between dipole moment of the EO compound and the applied electric field. In such an electric field poling method, an electric field is usually applied in a state where heating is performed to a temperature near a glass transition temperature of a host material to promote a molecular motion of the EO compound.

### PRIOR ART DOCUMENTS

### Patent Document

Patent Document 1: JP-A-2004-501159

### Non-Patent Document

Non-Patent Document 1: Chem. Mater. 2008, 120, 6372-6377.

### DISCLOSURE OF THE INVENTION

### Problems to be Solved by the Invention

By the way, when an orientation treatment is performed on an EO compound, an organic solvent tends to remain in an organic EO material (dried product of an EO ink composition). According to studies of the present inventors, it has been found that a conventional EO compound has insufficient thermal stability with respect to an organic solvent remaining in an organic EO material, and may be decomposed by heating the organic EO material under a high temperature condition of a certain level or higher. In order to prevent such decomposition, it is necessary to be able to suppress thermal decomposition of the EO compound by an organic solvent when an ink composition for forming an organic EO material is heated at a high temperature (for example, 140° C.), and an EO ink composition having such excellent heating stability is required.

Therefore, a main object of the present invention is to provide an electro-optic ink composition having excellent heating stability.

### Means for Solving the Problems

The present inventors intensively conducted studies in view of the above problems, and have found that by combining mainly an EO compound having a predetermined structure and an organic solvent having predetermined physical properties, decomposition of the EO compound by the organic solvent can be suppressed, leading to completion of the present invention.

The present invention provides electro-optic ink compositions according to the following [1] to [3] and [8], compounds according to the following [4] to [7], electro-optic films according to the following [9] and [10], and an electro-optic element according to the following [11].

[1] An electro-optic ink composition containing at least one compound selected from the group consisting of a compound represented by the following formula (1′) and a compound represented by the following formula (1″), and an organic solvent having a boiling point of 120° C. or higher and a dipole moment of less than 3.0 debye.

[Chemical Formula 1]

D¹-X¹-A¹ (1′)
[In formula (1′), D¹ represents an electron-donating group.
X¹ represents a divalent conjugated linking group or a single bond.
A¹ represents a group represented by the following formula (a1).]

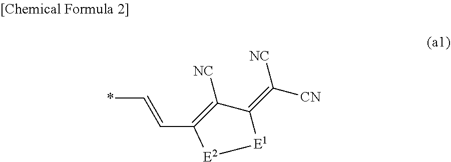

[In formula (a1), E¹ and E² each independently represent —C(R¹)(R²)—, —C(O)—, —O—, or —NR³—. Note that at least one of E¹ and E² is —O— or —NR³—.
R¹ and R² each independently represent a hydrogen atom, an alkyl group, a haloalkyl group, an aryl group, or a haloaryl group. Note that at least one of R¹ and R² is a group containing a halogen atom.
R³ represents a hydrogen atom or an alkyl group.
* represents a bonding position.]

[Chemical Formula 3]

D²-X²-A² (1″)
[In formula (1′), D² represents an electron-donating group.
X² represents a divalent conjugated linking group containing a divalent polycyclic condensed ring group. The divalent polycyclic condensed ring group is a divalent polycyclic condensed ring group having one or two thienothiophene rings, having at least one selected from the group consisting of an sp3 carbon atom and a silicon atom as a constituent element, and not containing a benzene ring, and the number of rings in the entire condensed ring of the divalent polycyclic condensed ring group is 4 to 10.
A² represents a group represented by the following formula (a2).]

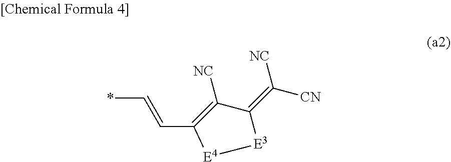

[In formula (a2), E³ and E⁴ each independently represent —C(R¹¹)(R¹²)—, —C(O)—, —O—, or —NR¹³—. Note that at least one of E³ and E⁴ is —O— or —NR¹³—.
R¹¹ and R¹² each independently represent a hydrogen atom, an alkyl group, or an aryl group.
R¹³ represents a hydrogen atom or an alkyl group.
* represents a bonding position.]

[2] The electro-optic ink composition according to [1], in which the D¹ and the D² are groups represented by the following formula (d1).

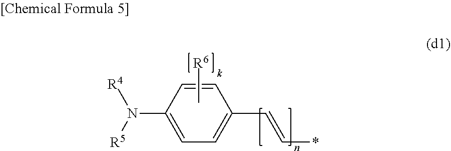

[In formula (d1), R⁴ and R⁵ each independently represent an alkyl group, a haloalkyl group, an acyloxyalkyl group, a trialkylsilyloxyalkyl group, an aryldialkylsilyloxyalkyl group, an alkyldiarylsilyloxyalkyl group, an aryl group, —R⁴¹—OH (R⁴¹ represents a divalent hydrocarbon group), —R⁴²—NH₂ (R⁴² represents a divalent hydrocarbon group), —R⁴³—SH (R⁴³ represents a divalent hydrocarbon group), or —R⁴⁴—NCO (R⁴⁴ represents a divalent hydrocarbon group). These groups may each have a crosslinkable group. R⁴ and R⁵ may be bonded to each other to form a ring together with atoms to which R⁴ and R⁵ are bonded.
R⁶ represents an alkyl group, an alkyloxy group, an aryl group, an aryloxy group, an aralkyloxy group, a trialkylsilyloxyalkyl group, an aryldialkylsilyloxyalkyl group, an alkyldiarylsilyloxyalkyl group, an alkenyloxy group, an alkynyloxy group, a hydroxy group, an amino group, a sulfanyl group, an isocyanate group, —R⁶¹—OH (R⁶¹ represents a divalent hydrocarbon group), —O—R⁶²—OH (R⁶² represents a divalent hydrocarbon group), —R⁶³—NH₂ (R⁶³ represents a divalent hydrocarbon group), —R⁶⁴—SH (R⁶⁴ represents a divalent hydrocarbon group), —R⁶⁵—NCO (R⁶⁵ represents a divalent hydrocarbon group), or —OC(═O)R⁶⁶ (R⁶⁶ represents a monovalent hydrocarbon group). These groups may each have a crosslinkable group. When there are a plurality of R⁶s, R⁶s may be the same as or different from each other. R⁶ may be bonded to R⁴ or R⁵ to form a ring together with atoms to which R⁶ and R⁴ or R⁵ are bonded.
k represents an integer of 0 to 4.
n represents 0 or 1.
* represents a bonding position.]

[3] The electro-optic ink composition according to [1] or [2], further containing an amorphous resin, in which the amorphous resin may form a covalent bond with the compound, or may form a crosslinked structure by reacting with a crosslinkable group of the compound.

[4]A compound represented by the following formula (1A).

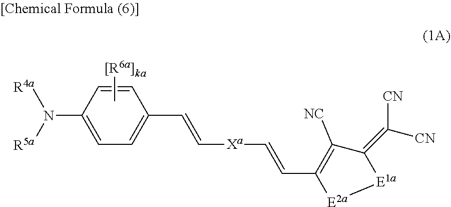

[In formula (1A), X^{a} represents a divalent polycyclic condensed ring group having two or more thiophene rings, having at least one selected from the group consisting of an sp3 carbon atom and a nitrogen atom as a constituent element, and not containing a benzene ring, and the divalent polycyclic condensed ring group may have a substituent.
E^{1a} and E^{2a} each independently represent —C(R^{1a})(R^{2a})—, —C(O)—, —O—, or —NR^{3a}—. Note that at least one of E^{1a} and E^{2a} is —O— or —NR^{3a}.
R^{1a} and R^{2a} each independently represent a hydrogen atom, an alkyl group, a haloalkyl group, an aryl group, or a haloaryl group. Note that at least one of R^{1a} and R^{2a} is a group containing a halogen atom.
R^{3a} represents a hydrogen atom or an alkyl group.
R^{4a} and R^{5a} each independently represent an alkyl group, a haloalkyl group, an acyloxyalkyl group, a trialkylsilyloxyalkyl group, an aryldialkylsilyloxyalkyl group, an alkyldiarylsilyloxyalkyl group, an aryl group, —R^{41a}—OH (R^{41a} represents a divalent hydrocarbon group), —R^{42a}—NH₂ (R^{42a} represents a divalent hydrocarbon group), —R^{43a}—SH (R^{43a} represents a divalent hydrocarbon group), or —R^{44a}—NCO (R^{44a} represents a divalent hydrocarbon group). These groups may each have a crosslinkable group. R^{4a} and R^{5a} may be bonded to each other to form a ring together with atoms to which R^{4a} and R^{5a} are bonded.
R^{6a} represents an alkyl group, an alkyloxy group, an aryl group, an aryloxy group, an aralkyloxy group, a trialkylsilyloxyalkyl group, an aryldialkylsilyloxyalkyl group, an alkyldiarylsilyloxyalkyl group, an alkenyloxy group, an alkynyloxy group, a hydroxy group, an amino group, a sulfanyl group, an isocyanate group, —R^{61a}—OH (R^{61a} represents a divalent hydrocarbon group), —O—R^{62a}—OH (R^{62a} represents a divalent hydrocarbon group), —R^{63a}—NH₂ (R^{63a} represents a divalent hydrocarbon group), —R^{64a}—SH (R^{64a} represents a divalent hydrocarbon group), —R^{65a}—NCO (R^{65a} represents a divalent hydrocarbon group), or —OC(═O)R^{66a}(R^{66a} represents a monovalent hydrocarbon group). These groups may each have a crosslinkable group. When there are a plurality of R^{6a}s, R^{6a}s may be the same as or different from each other. R^{6a} may be bonded to R^{4a} or R^{5a} to form a ring together with atoms to which R^{6a} and R^{4a} or R^{5a} are bonded.
ka represents an integer of 0 to 4.]

[5] The compound according to [4], in which the compound represented by the above formula (1A) is a compound represented by the following formula (2).

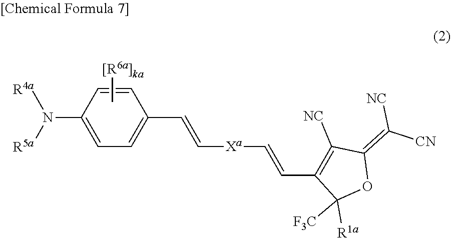

[In formula (2), X^{a}, R^{1a}, R^{4a}, R^{5a}, R^{6a}, and k^{a} have the same meanings as those described above, respectively.]

[6]A compound represented by the following formula (1B).

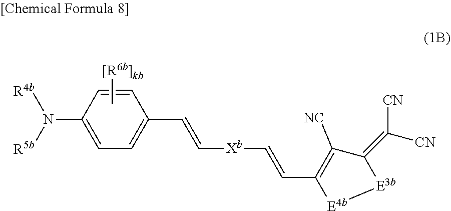

[In formula (1B), X^{b} represents a divalent polycyclic condensed ring group having one or two thienothiophene rings, having at least one selected from the group consisting of an sp3 carbon atom and a silicon atom as a constituent element, and not containing a benzene ring, and the number of rings in the entire condensed ring of the divalent polycyclic condensed ring group is 4 to 10. The divalent polycyclic condensed ring group may have a substituent.
E^{3b} and E^{4b} each independently represent —C(R^{11b})(R^{12b})—, —C(O)—, —O—, or —NR^{13b}—. Note that at least one of E^{3b} and E^{4b} is —O— or —NR^{13b}—.
R^{11b} and R^{12b} each independently represent a hydrogen atom, an alkyl group, or an aryl group.
R^{13b} represents a hydrogen atom or an alkyl group.
R^{4b} and R^{5b} each independently represent an alkyl group, a haloalkyl group, an acyloxyalkyl group, a trialkylsilyloxyalkyl group, an aryldialkylsilyloxyalkyl group, an alkyldiarylsilyloxyalkyl group, an aryl group, —R^{41b}—OH (R^{41b} represents a divalent hydrocarbon group), —R^{42b}—NH₂ (R^{42b} represents a divalent hydrocarbon group), —R^{43b}—SH (R^{43b} represents a divalent hydrocarbon group), or —R^{44b}—NCO (R^{44b} represents a divalent hydrocarbon group). These groups may each have a crosslinkable group. R^{4b} and R^{5b} may be bonded to each other to form a ring together with atoms to which R^{4b} and R^{5b} are bonded.
R^{6b} represents an alkyl group, an alkyloxy group, an aryl group, an aryloxy group, an aralkyloxy group, a trialkylsilyloxyalkyl group, an aryldialkylsilyloxyalkyl group, an alkyldiarylsilyloxyalkyl group, an alkenyloxy group, an alkynyloxy group, a hydroxy group, an amino group, a sulfanyl group, an isocyanate group, —R^{61b}—OH (R^{61b} represents a divalent hydrocarbon group), —O—R^{62b}—OH (R^{62b} represents a divalent hydrocarbon group), —R^{63b}—NH₂ (R^{63b} represents a divalent hydrocarbon group), —R^{64b}—SH (R^{64b} represents a divalent hydrocarbon group), —R^{65b}—NCO (R^{65b} represents a divalent hydrocarbon group), or —OC(═O)R^{66b}(R^{66b} represents a monovalent hydrocarbon group). These groups may each have a crosslinkable group. When there are a plurality of R^{6b}s, R^{6b}s may be the same as or different from each other. R^{6b} may be bonded to R^{4b} or R^{5b} to form a ring together with atoms to which R^{6b} and R^{4b} or R^{5b} are bonded.

kb represents an integer of 0 to 4.]

[7] A compound represented by the following formula (1C).

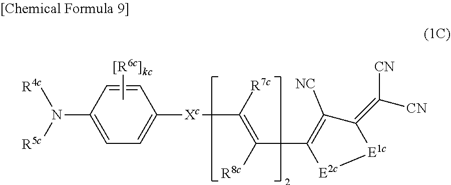

[In formula (1C), X^{c} represents a divalent polycyclic condensed ring group having two or more thiophene rings or a heteroarylene group having two or more thiophene rings, and the divalent polycyclic condensed ring group and the heteroarylene group may each have a substituent.
E^{1C} and E^{2C} each independently represent —C(R^{1C})(R^{2C})—, —C(O)—, —O—, or —NR^{3C}—. Note that at least one of E^{1C} and E^{2C} is —O— or —NR^{a}—.
R^{1C} and R^{2C} each independently represent a hydrogen atom, an alkyl group, a haloalkyl group, an aryl group, or a haloaryl group. Note that at least one of R^{1C} and R^{2C} is a group containing a halogen atom.
R^{3C} represents a hydrogen atom or an alkyl group.
R^{4C} and R^{5C} each independently represent an alkyl group, a haloalkyl group, an acyloxyalkyl group, a trialkylsilyloxyalkyl group, an aryldialkylsilyloxyalkyl group, an alkyldiarylsilyloxyalkyl group, an aryl group, —R^{41C}—OH (R^{41C} represents a divalent hydrocarbon group), —R^{42C}—NH₂ (R^{42c} represents a divalent hydrocarbon group), —R^{43C}—SH (R^{43C} represents a divalent hydrocarbon group), or —R^{44C}—NCO (R^{44C} represents a divalent hydrocarbon group). These groups may each have a crosslinkable group. R^{4C} and R^{5C} may be bonded to each other to form a ring together with atoms to which R^{4C} and R^{5C} are bonded.
R^{6C} represents an alkyl group, an alkyloxy group, an aryl group, an aryloxy group, an aralkyloxy group, a trialkylsilyloxyalkyl group, an aryldialkylsilyloxyalkyl group, an alkyldiarylsilyloxyalkyl group, an alkenyloxy group, an alkynyloxy group, a hydroxy group, an amino group, a sulfanyl group, an isocyanate group, —R^{61C}—OH (R^{61C} represents a divalent hydrocarbon group), —O—R^{62C}—OH (R^{62C} represents a divalent hydrocarbon group), —R^{63C}—NH₂ (R^{63C} represents a divalent hydrocarbon group), —R^{64C}—SH (R^{64C} represents a divalent hydrocarbon group), —R^{65C}—NCO (R^{65C} represents a divalent hydrocarbon group), or —OC(═O)R^{66C} (R^{66C} represents a monovalent hydrocarbon group). These groups may each have a crosslinkable group. When there are a plurality of R^{6C}s, R^{6C}s may be the same as or different from each other. R^{6C} may be bonded to R^{4C} or R^{5C} to form a ring together with atoms to which R^{6C} and R^{4C} or R^{5C} are bonded.
kc represents an integer of 0 to 4.
R^{7c} and R^{8c} each independently represent a hydrogen atom, an alkyl group, or an aryl group.]

[8] An electro-optic ink composition containing the compound according to any one of [4] to [7].

[9] An electro-optic film containing the electro-optic ink composition according to any one of [1] to [3] and [8] as a forming material.

[10] An electro-optic film containing the compound according to any one of [4] to [7].

[11] An electro-optic element including the electro-optic film according to [9] or [10].

In addition, the present invention relates to use of the compound according to any one of [4] to [6] as an electro-optic material. Furthermore, the present invention relates to use of a composition containing the compound according to any one of [4] to [6] as an electro-optic material.

### Effect of the Invention

The present invention provides an electro-optic ink composition having excellent heating stability. By using the ink compound in manufacturing an EO element, heat resistance required for a high-temperature process at the time of poling, a thermal curing process for fixing film orientation, a high-temperature process at the time of mounting, and the like can be improved, and the degree of freedom in an element manufacturing process can be increased. In addition, the present invention provides a compound suitable for such an ink compound, and an electro-optic ink composition, an electro-optic film, and an electro-optic element using the compound.

### MODE FOR CARRYING OUT THE INVENTION

Hereinafter, a preferred embodiment of the present embodiment will be described in detail.

### [Electro-Optic Ink Composition]

In one aspect, an EO ink composition of the present embodiment contains at least one compound (hereinafter, also referred to as a “predetermined compound”) selected from the group consisting of a compound represented by formula (1′) and a compound represented by formula (1″), and an organic solvent having a boiling point of 120° C. or higher and a dipole moment of less than 3.0 debye.

### <Compound Represented by Formula (1′)>

The compound represented by formula (1′) has a structure in which an electron-donating group (group having a donor structure) and an electron-withdrawing group (group having an acceptor structure) are linked by a predetermined linking group, and is used as an organic EO material.

[Chemical Formula 10]

D¹-X¹-A¹ (1′)

### Electron-Withdrawing Group (Group Having an Acceptor Structure) A¹

In formula (1′), A¹ is an electron-withdrawing group (group having an acceptor structure) and represents a group represented by the following formula (a1).

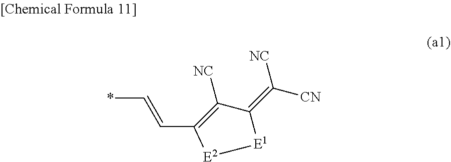

In formula (a1), E¹ and E² each independently represent —C(R¹)(R²)—, —C(O)—, —O—, or —NR³—. Note that at least one of E¹ and E² is —O— or —NR³—.

R¹ and R² each independently represent a hydrogen atom, an alkyl group, a haloalkyl group, an aryl group, or a haloaryl group. Note that at least one of R¹ and R² is a group containing a halogen atom.

The alkyl group as each of R¹ and R² may be linear, branched, cyclic. The number of carbon atoms of the alkyl group is usually 1 to 30 without including the number of carbon atoms of a substituent. Specific examples of the alkyl group include: a linear or branched alkyl group such as a methyl group, an ethyl group, a n-propyl group, an isopropyl group, a butyl group, an isobutyl group, a sec-butyl group, a tert-butyl group, a pentyl group, an isopentyl group, a 2-methylbutyl group, a 1-methylbutyl group, a hexyl group, an isohexyl group, a 3-methylpentyl group, a 2-methylpentyl group, a 1-methylpentyl group, a heptyl group, an octyl group, an isooctyl group, a 2-ethylhexyl group, a 3,7-dimethyloctyl group, a nonyl group, a decyl group, an undecyl group, a dodecyl group, a tetradecyl group, a hexadecyl group, an octadecyl group, or an eicosyl group; and a cyclic alkyl group such as a cyclopentyl group, a cyclohexyl group, or an adamantyl group.

The haloalkyl group as each of R¹ and R² is an alkyl group having one or more halogen atoms (for example, a fluorine atom, a chlorine atom, a bromine atom, or an iodine atom) as substituents. The number of carbon atoms of the haloalkyl group is preferably 1 to 20, more preferably 1 to 10, and still more preferably 1 to 5. Specific examples of the haloalkyl group include a fluoromethyl group, a difluoromethyl group, a trifluoromethyl group, a 2-fluoroethyl group, a 1,2-difluoroethyl group, a chloromethyl group, a 2-chloroethyl group, a 1,2-dichloroethyl group, a bromomethyl group, a 2-bromoethyl group, a 1-bromopropyl group, a 2-bromopropyl group, a 3-bromopropyl group, and an iodomethyl group.

The number of carbon atoms of the aryl group as each of R¹ and R² is usually 6 to 30 without including the number of carbon atoms of a substituent. Specific examples of the aryl group include a phenyl group, a 1-naphthyl group, a 2-naphthyl group, a 1-anthracenyl group, a 2-anthracenyl group, a 9-anthracenyl group, a 1-pyrenyl group, a 2-pyrenyl group, a 4-pyrenyl group, a 2-fluorenyl group, a 3-fluorenyl group, a 4-fluorenyl group, a 2-phenylphenyl group, a 3-phenylphenyl group, and a 4-phenylphenyl group.

The haloaryl group as each of R¹ and R² is an aryl group having one or more halogen atoms (for example, a fluorine atom, a chlorine atom, a bromine atom, or an iodine atom, preferably a fluorine atom) as substituents. Specific examples of the haloaryl group include a pentafluorophenyl group.

The alkyl group as R³ may be similar to the alkyl group exemplified for R¹ and R².

E¹ is preferably —O— or —NR³— because desired electro-optic characteristics are easily obtained. E² is —C(CF₃)(Ph)- (Ph: phenyl group) or —C(O)—, and more preferably —C(CF₃)(Ph)- from a viewpoint of enhancing an electron withdrawing property and improving an EO coefficient. A combination of E¹ and E² is preferably a combination of —O— and —C(CF₃)(Ph)- or a combination of —NR³— and —C(O)—, and more preferably a combination of —O— and —C(CF₃)(Ph)- from a viewpoint of synthesis.

Examples of the group represented by formula (a1) include groups represented by formulas (a1)-1 to (a1)-25. These groups may each further have a substituent. * represents a bonding position.

Note that, in the present specification, the substituent means a group that can be generally taken in the field of organic chemistry. Examples of the substituent include a halogen atom (a fluorine atom, a chlorine atom, a bromine atom, an iodine atom, or the like), a cyano group, an alkyl group, an alkenyl group, an alkynyl group, an aryl group, a heteroaryl group, an alkyloxy group, an aryloxy group, a hydroxy group, an amino group, and a substituted amino group. Groups as substituents may be similar to the groups exemplified in the present specification.

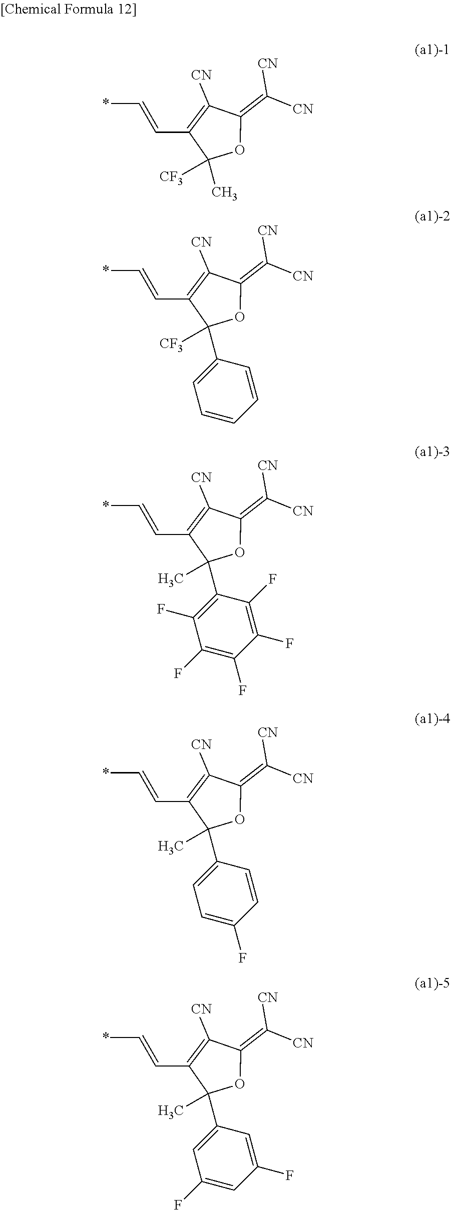

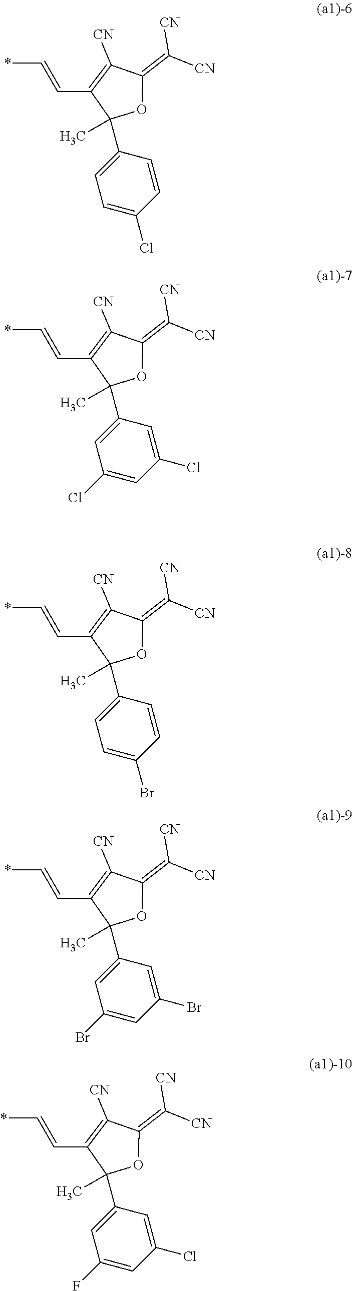

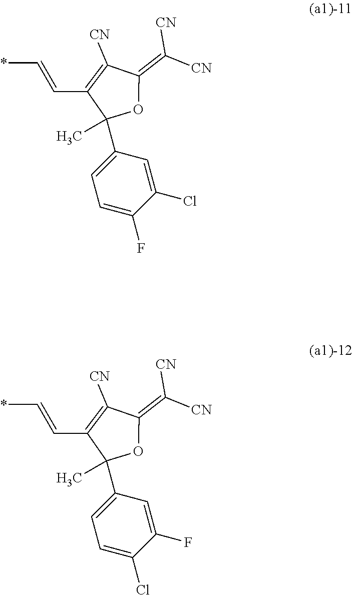 [SMILES: */C=C/C1=C(C#N)C(=C(C#N)C#N)OC1(C)c1ccc(F)c(Cl)c1 ; */C=C/C1=C(C#N)C(=C(C#N)C#N)OC1(C)c1ccc(Cl)c(F)c1]

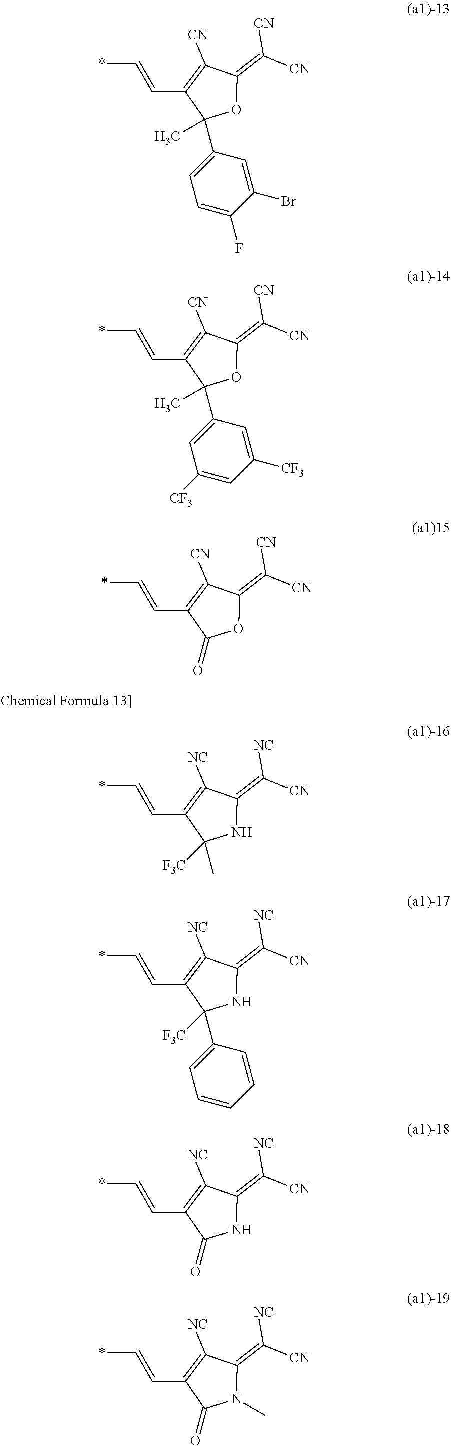

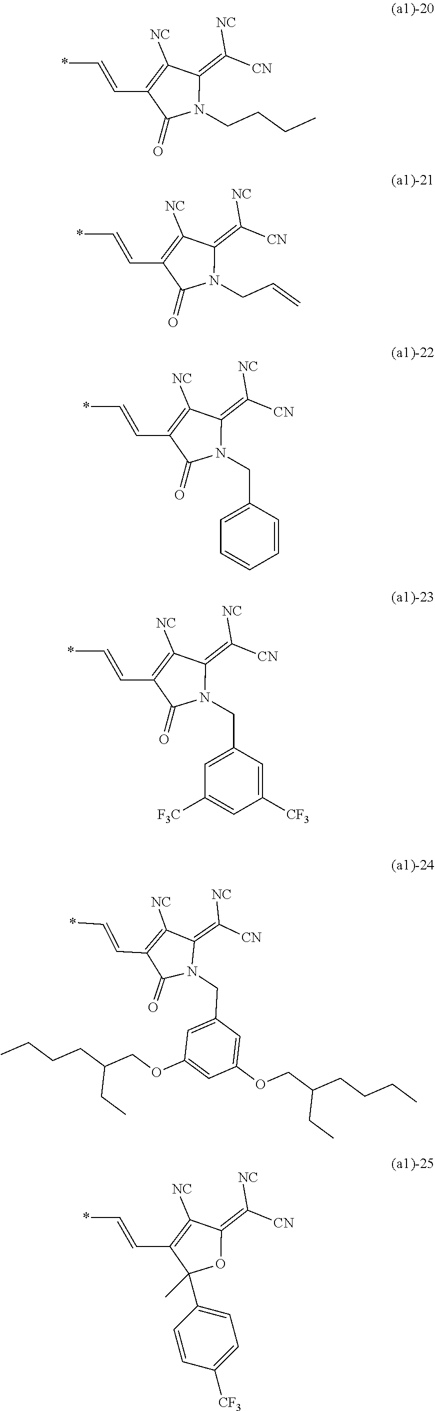

The group represented by formula (a1) is preferably a group represented by formula (a1)-1, (a1)-2, (a1)-18, (a1)-19, or (a1)-22, and more preferably a group represented by formula (a1)-1 or (a1)-2.

### Linking Group (Linking Bond) X¹

In formula (1′), X¹ represents a divalent conjugated linking group or a single bond. Here, the divalent conjugated linking group means a divalent linking group in which a conjugated system is connected from one bonding position to the other bonding position. X¹ is preferably a divalent conjugated linking group.

Examples of the divalent conjugated linking group as X¹ include a linking group represented by the following formula (x1).

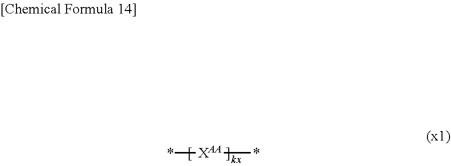

In formula (x1), examples of X^{A} include an arylene group, a heteroarylene group, a divalent polycyclic condensed ring group, CR^{X1}=CR^{X2}—, —C≡C—, —N═N—, -arylene group-Y—, and -heteroarylene group-Y—. These groups may each have a substituent. When there are a plurality of X^{AA}s, X^{AA}s may be the same as or different from each other. When there are a plurality of X^{AA}s and groups of —CR^{X1}=CR^{X2}— are adjacent to each other, R^{X1}s may be bonded to each other to form a ring together with atoms to which R^{X1}s are bonded. kx represents an integer of 1 to 10. * represents a bonding position.

kx represents an integer of 1 to 10. kx is preferably 1 to 3, more preferably 1 or 2, and still more preferably 1.

The number of carbon atoms of the arylene group is usually 6 to 30 without including the number of carbon atoms of a substituent. Specific examples of the aryl group include a group obtained by removing two hydrogen atoms directly bonded to carbon atoms constituting a ring from an aromatic compound such as benzene, naphthalene, anthracene, pyrene, or fluorene. The arylene group may have a substituent.

The number of carbon atoms of the heteroarylene group is usually 2 to 30 without including the number of carbon atoms of a substituent. Specific examples of the heteroarylene group include a group obtained by removing two hydrogen atoms directly bonded to carbon atoms constituting a ring from an aromatic heterocyclic compound such as furan, thiophene, pyrrole, oxazole, isoxazole, thiazole, isothiazole, imidazole, pyrazole, furazan, triazole, thiadiazole, oxadiazole, tetrazole, pyridine, pyridazine, pyrimidine, pyrazine, triazine, benzofuran, isobenzofuran, benzothiophene, thienothiophene, indole, isoindole, indolizine, isoquinoline, benzimidazole, benzothiazole, indazole, naphthyridine, quinoxaline, quinazoline, quinazolidine, cinnoline, phthalazine, purine, pteridine, carbazole, phenanthridine, acridine, β-carboline, perimidine, or phenanthroline. The heteroarylene group may have a substituent.

R^{X1} and R^{X2} each independently represent a hydrogen atom, an alkyl group, or an aryl group. R^{X1} and R^{X2} may be bonded to each other to form a ring together with atoms to which R^{X1} and R^{X2} are bonded. The alkyl group and the aryl group as each of R^{X1} and R^{X2} may be similar to the alkyl group and the aryl group exemplified for R¹ and R².

Y represents —O—, —S—, or —NR^{X3}—. R^{X3} represents a hydrogen atom, an alkyl group, or an aryl group. The alkyl group and the aryl group as R^{X3} may be similar to the alkyl group and the aryl group exemplified for R¹ and R².

The divalent polycyclic condensed ring group may have two or more thiophene rings. The number of thiophene rings is preferably 2 to 10, more preferably 2 to 8, and still more preferably 2 to 6. Note that, in a ring-condensed thiophene in which thiophenes are ring-condensed, the number of ring-condensed thiophenes is the number of thiophene rings. For example, in thienothiophene in which two thiophenes are ring-condensed, the number of thiophene rings is counted as 2.

The divalent polycyclic condensed ring group may have at least one selected from the group consisting of an sp3 carbon atom, a nitrogen atom, and a silicon atom as a constituent element. That is, the divalent polycyclic condensed ring group may have at least one group selected from the group consisting of a group represented by —C(R^{A})(R^{B})— in the ring, a group represented by —N(R^{C})— in the ring, and a group represented by —Si(R^{D})(R^{E})— in the ring. A carbon atom in —C(R^{A})(R^{B})— may be a tertiary carbon atom in which one of R^{A} and R^{B} is an alkyl group or the like and the other is a hydrogen atom, or a quaternary carbon atom in which both R^{A} and R^{B} are alkyl groups and the like, and is preferably a quaternary carbon atom.

The number of sp3 carbon atoms in the divalent polycyclic condensed ring group is preferably 1 to 6, more preferably 1 to 4, and still more preferably 1 or 2. The number of nitrogen atoms in the divalent polycyclic condensed ring group as X is preferably 1 to 6, more preferably 1 to 4, and still more preferably 1 or 2. The number of silicon atoms in the divalent polycyclic condensed ring group as X is preferably 1 to 6, more preferably 1 to 4, and still more preferably 1 or 2.

R^{A}, R^{B}, R^{C}, R^{D}, and R^{E} each independently represent a hydrogen atom, an alkyl group, an alkyloxy group, an alkylthio group, an aryl group, or a monovalent heterocyclic group. These groups may each have a substituent.

The alkyl group and the aryl group as each of R^{A}, R^{B}, R^{C}, R^{D}, and R^{E} may be similar to the alkyl group and the aryl group exemplified for R¹ and R².

The alkyl group in the alkyloxy group as each of R^{A}, R^{B}, R^{C}, R^{D}, and R^{E} may be linear, branched, or cyclic. The number of carbon atoms of the alkyloxy group is usually 1 to 30 without including the number of carbon atoms of a substituent. Specific examples of the alkyloxy group include a methoxy group, an ethoxy group, a propoxy group, an isopropoxy group, a butoxy group, an isobutoxy group, a tert-butoxy group, a pentyloxy group, a hexyloxy group, a heptyloxy group, an octyloxy group, a 2-ethylhexyloxy group, a nonyloxy group, a decyloxy group, a 3,7-dimethyloctyloxy group, a lauryloxy group, a cyclopropyloxy group, a cyclopentyloxy group, a cyclohexyloxy group, and an adamantyloxy group.

The alkyl group in the alkylthio group as each of R^{A}, R^{B}, R^{C}, R^{D}, and R^{E} may be linear, branched, or cyclic. The number of carbon atoms of the alkylthio group is usually 1 to 30 without including the number of carbon atoms of a substituent. Specific examples of the alkylthio group include a methylthio group, an ethylthio group, a propylthio group, an isopropylthio group, a butylthio group, an isobutylthio group, a tert-butylthio group, a pentylthio group, a hexylthio group, a heptylthio group, an octylthio group, a 2-ethylhexylthio group, a nonylthio group, a decylthio group, a 3,7-dimethyloctylthio group, a laurylthio group, a cyclopropylthio group, a cyclopentylthio group, a cyclohexylthio group, and an adamantylthio group.

The number of carbon atoms of the monovalent heterocyclic group as each of R^{A}, R^{B}, R^{C}, R^{D}, and R^{E} is usually 2 to 30 without including the number of carbon atoms of a substituent. Examples of the monovalent heterocyclic group include a group obtained by removing one hydrogen atom directly bonded to carbon atoms constituting a ring from a heterocyclic compound such as furan, thiophene, pyrrole, pyrroline, pyrrolidine, oxazole, isoxazole, thiazole, isothiazole, imidazole, imidazoline, imidazolidine, pyrazole, pyrazoline, prazolidine, furazan, triazole, thiadiazole, oxadiazole, tetrazole, pyran, pyridine, piperidine, thiopyran, pyridazine, pyrimidine, pyrazine, piperazine, morpholine, triazine, benzofuran, isobenzofuran, benzothiophene, thienothiophene, indole, isoindole, indolizine, indoline, isoindoline, chromene, chroman, isochromane, benzopyran, quinoline, isoquinoline, quinolidine, benzimidazole, benzothiazole, indazole, naphthyridine, quinoxaline, quinazoline, quinazolidine, cinnoline, phthalazine, purine, pteridine, carbazole, xanthene, phenanthridine, acridine, β-carboline, perimidine, phenanthroline, thianthrene, phenoxathiine, phenoxazine, phenothiazine, or phenazine.

Each of R^{A}, R^{B}, R^{C}, R^{D}, and R^{E} is preferably an alkyl group having 1 to 30 carbon atoms, a cycloalkyl group having 3 to 30 carbon atoms, or an aryl group having 6 to 30 carbon atoms from a viewpoint of maintaining heat resistance and suppressing aggregation between molecules.

The divalent conjugated linking group preferably contains a divalent polycyclic condensed ring group or a heteroarylene group. Examples of the divalent polycyclic condensed ring group include groups represented by formulas (X-1) to (X-40) * represents a bonding position.

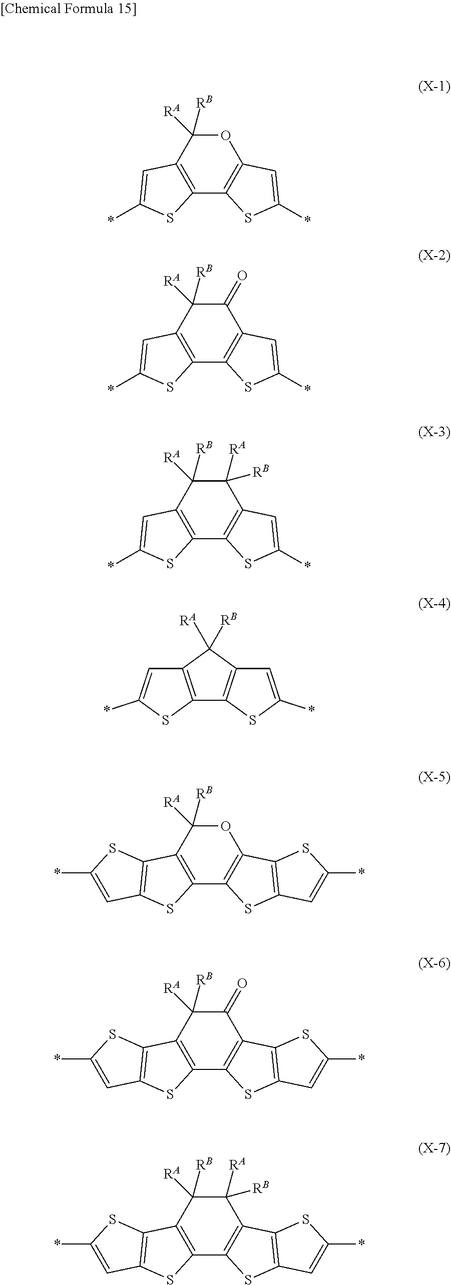

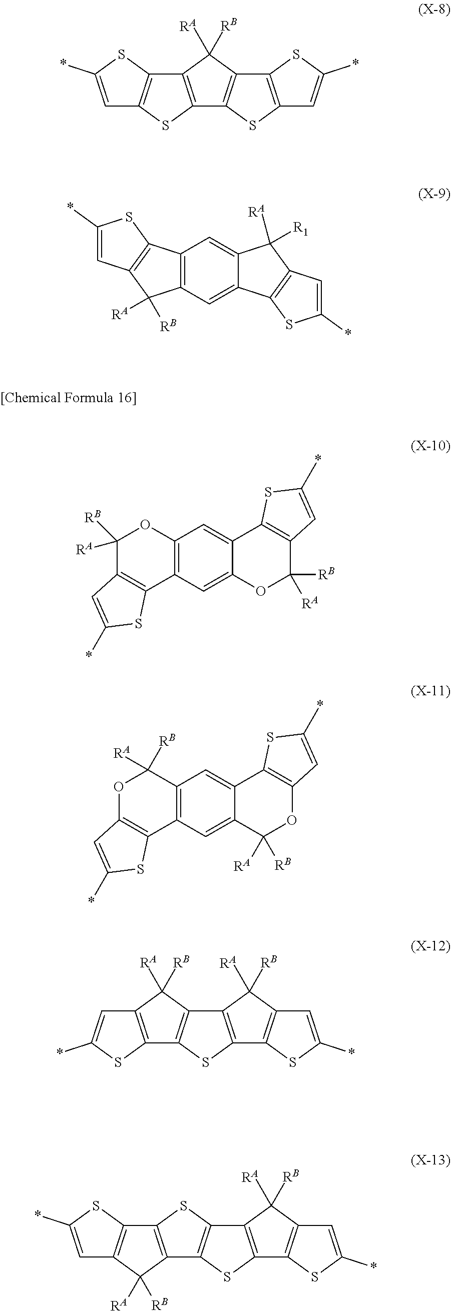

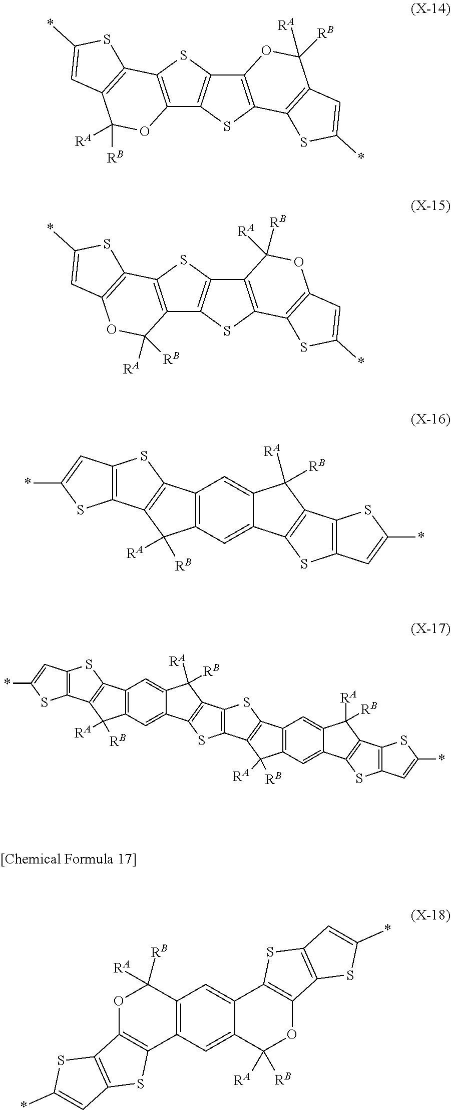

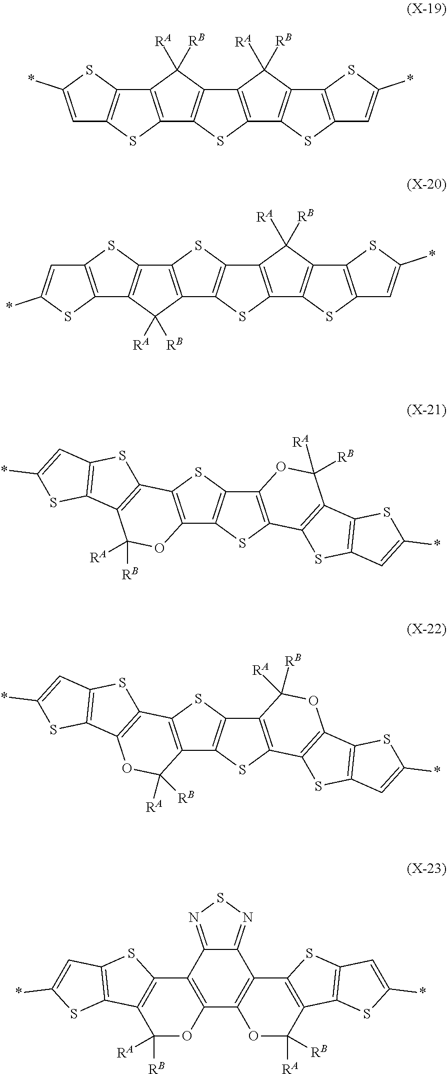

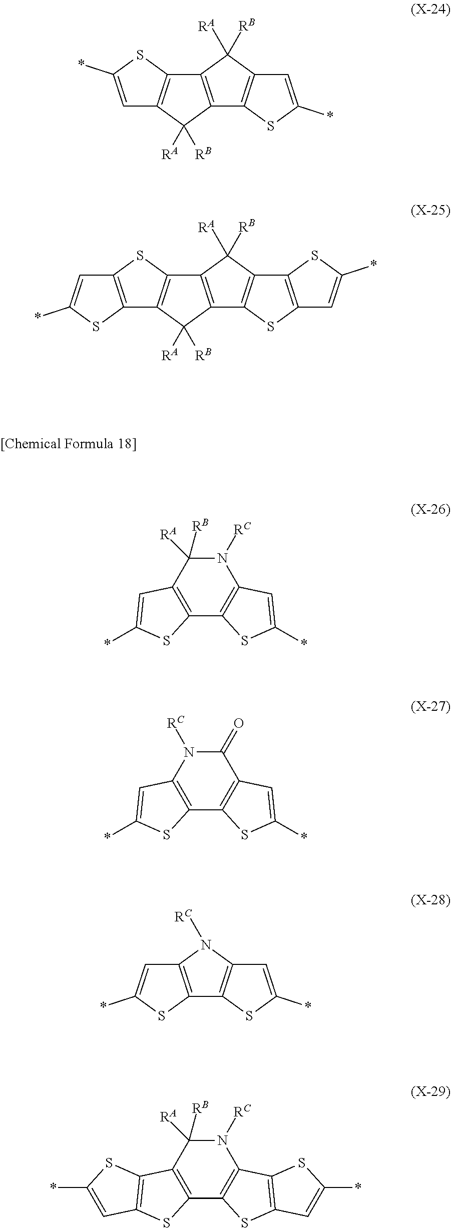

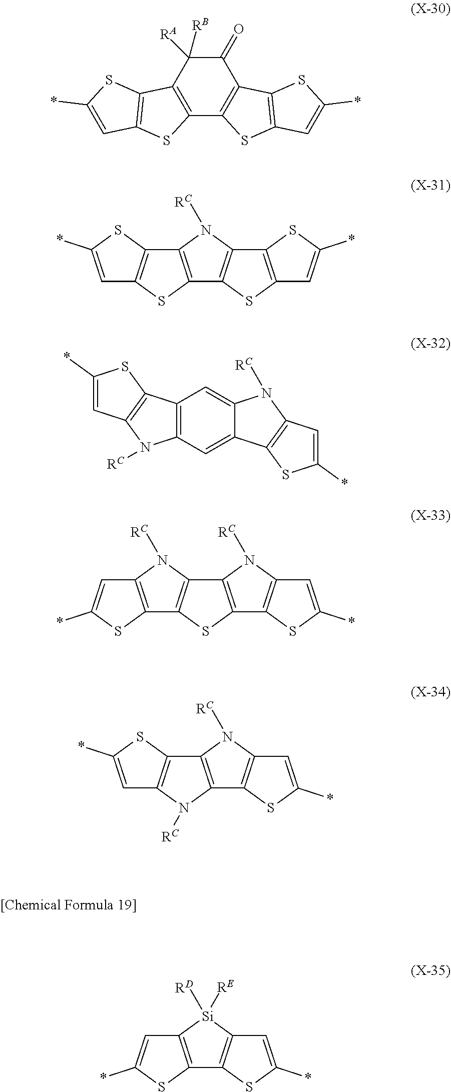

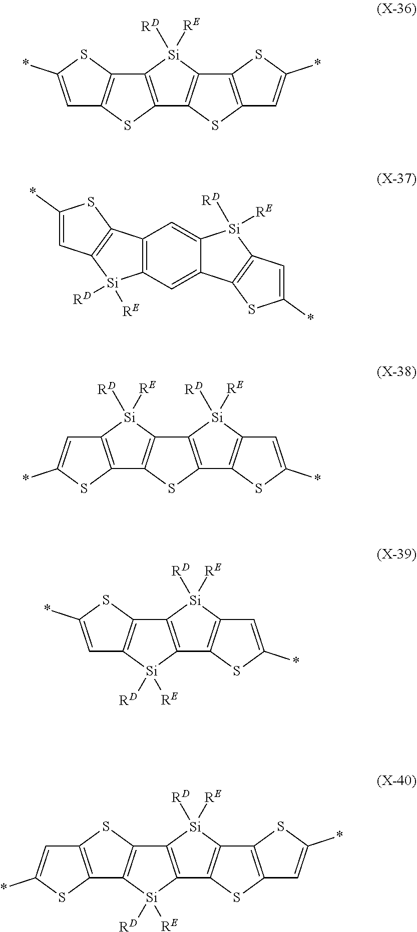

The divalent polycyclic condensed ring group having an sp3 carbon atom as a constituent element is preferably a group represented by any one of formulas (X-1), (X-4), (X-5), (X-8) to (X-22), (X-24), and (X-25), and more preferably a group represented by any one of formulas (X-1), (X-4), (X-5), (X-8), (X-9), (X-13), (X-24), and (X-25) from a viewpoint of suppressing aggregation between molecules.

The divalent polycyclic condensed ring group having a nitrogen atom as a constituent element is preferably a group represented by any one of formulas (X-26) to (X-28) and (X-34) from a viewpoint of suppressing aggregation between molecules.

The divalent polycyclic condensed ring group having a silicon atom as a constituent element is preferably a group represented by formula (X-35) or (X-36) from a viewpoint of suppressing aggregation between molecules.

The heteroarylene group is preferably a group obtained by removing two hydrogen atoms directly bonded to carbon atoms constituting a ring from thiophene or thienothiophene.

### Electron-Donating Group (Group Having a Donor Structure) D¹

In formula (1′), D¹ represents an electron-donating group. D¹ may be a group relatively exhibiting an electron donating property with respect to the group represented by formula (a1) as A¹.

Examples of D¹ include an alkyl group, an alkyloxy group, an aryloxy group, an alkylthio group, a hydroxy group, an amino group, a substituted amino group, and a substituted silyl group. D¹ may be an alkenyl group, an aryl group, an alkynyl group, a heteroaryl group, or the like having at least one group selected from the group consisting of these groups (an alkyl group, an alkyloxy group, an aryloxy group, an alkylthio group, a hydroxy group, an amino group, a substituted amino group, and a substituted silyl group) as substituents. These groups may each have a substituent.

The alkyl group as D¹ may be similar to the alkyl group exemplified for R¹ and R².

The alkyloxy group, the aryloxy group, and the alkylthio group as D¹ may be similar to the alkyloxy group, the aryloxy group, and the alkylthio group exemplified for R^{A}, R^{B}, R^{C}, R^{D}, and R^{E}.

The aryl group in the aryloxy group as D¹ may be similar to the aryl group exemplified for R¹ and R².

The substituted amino group as D¹ means an alkyl group which may have a substituent or an amino group having an aryl group which may have a substituent. Specific examples of the substituted amino group include a methylamino group, a dimethylamino group, an ethylamino group, a diethylamino group, a propylamino group, a dipropylamino group, an isopropylamino group, a diisopropylamino group, a butylamino group, an isobutylamino group, a tert-butylamino group, a pentylamino group, a hexylamino group, a cyclohexylamino group, a heptylamino group, an octylamino group, a 2-ethylhexylamino group, a nonylamino group, a decylamino group, a 3,7-dimethyloctylamino group, a laurylamino group, a cyclopentylamino group, a dicyclopentylamino group, a cyclohexylamino group, a dicyclohexylamino group, a pyrrolidyl group, a piperidyl group, a ditrifluoromethylamino group, a phenylamino group, and a diphenylamino group.

The substituted silyl group as D¹ means a silyl group having an alkyl group which may have a substituent or an aryl group which may have a substituent. Specific examples of the substituted silyl group include: a mono-substituted silyl group such as a methylsilyl group, an ethylsilyl group, or a phenylsilyl group; a disubstituted silyl group such as a dimethylsilyl group, a diethylsilyl group, or a diphenylsilyl group; and a trisubstituted silyl group such as a trimethylsilyl group, a triisopropylsilyl group, a tri-n-butylsilyl group, a tri-tert-butylsilyl group, a tri-isobutylsilyl group, a tert-butyl-dimethylsilyl group, or a tri-n-pentylsilyl group.

Examples of the alkenyl group as D¹ include an alkenyl group having 2 to 20 carbon atoms. Specific examples of the alkenyl group include an ethenyl group, a 1-propenyl group, a 2-propenyl group, a 1-methylethenyl group, a 1-butenyl group, a 2-butenyl group, a 3-butenyl group, a 1-methyl-1-propenyl group, a 1-methyl-2-propenyl group, a 2-methyl-1-propenyl group, and a 2-methyl-2-propenyl group. The alkenyl group may have a substituent.

The aryl group as D¹ may be similar to the aryl group exemplified for R¹ and R². The number of carbon atoms of the aryl group is preferably 6 to 20, and more preferably 6 to 10.

Examples of the alkynyl group as D¹ include an alkynyl group having 3 to 20 carbon atoms. Specific examples of the alkynyl group include a 2-propynyl group, a 1-methyl-2-propynyl group, a 1,1-dimethyl-2-propynyl group, a 2-butynyl group, a 3-butynyl group, a 1-pentynyl group, a 2-pentynyl group, a 3-pentynyl group, and a 4-pentynyl group. The alkynyl group may have a substituent.

The number of carbon atoms of the heteroaryl group as D¹ is usually 2 to 30 without including the number of carbon atoms of a substituent. Specific examples of the heteroaryl group include a group obtained by removing one hydrogen atom directly bonded to a carbon atom constituting a ring from an aromatic heterocyclic compound such as furan, thiophene, pyrrole, oxazole, isoxazole, thiazole, isothiazole, imidazole, pyrazole, furazan, triazole, thiadiazole, oxadiazole, tetrazole, pyridine, pyridazine, pyrimidine, pyrazine, triazine, benzofuran, isobenzofuran, benzothiophene, thienothiophene, indole, isoindole, indolizine, isoquinoline, benzimidazole, benzothiazole, indazole, naphthyridine, quinoxaline, quinazoline, quinazolidine, cinnoline, phthalazine, purine, pteridine, carbazole, phenanthridine, acridine, β-carboline, perimidine, or phenanthroline. The heteroaryl group may have a substituent.

Among these groups, D¹ is preferably an aryl group or a heteroaryl group having at least one group selected from the group consisting of an alkyloxy group, an aryloxy group, an alkylthio group, a hydroxy group, an amino group, and a substituted amino group as substituents, more preferably an aryl group having at least one group selected from this group as substituents, and still more preferably an aryl group having at least one group selected from the group consisting of an alkyloxy group and a substituted amino group as substituents because a desired EO coefficient is easily obtained when a predetermined compound is used for an organic EO material. The number of substitutions in the aryl group or the heteroaryl group is preferably 1 from a viewpoint of synthesis, and preferably 2 or 3 from a viewpoint of improving hyperpolarizability.

D¹ is preferably a group represented by the following formula (d1).

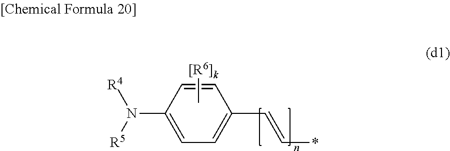

In formula (d1), R⁴ and R⁵ each independently represent an alkyl group, a haloalkyl group, an acyloxyalkyl group, a trialkylsilyloxyalkyl group, an aryldialkylsilyloxyalkyl group, an alkyldiarylsilyloxyalkyl group, an aryl group, —R⁴¹—OH (R⁴¹ represents a divalent hydrocarbon group), —R⁴²—NH₂ (R⁴² represents a divalent hydrocarbon group), —R⁴³—SH (R⁴³ represents a divalent hydrocarbon group), or —R⁴⁴—NCO (R⁴⁴ represents a divalent hydrocarbon group). These groups may each have a crosslinkable group. R⁴ and R⁵ may be bonded to each other to form a ring together with atoms to which R⁴ and R⁵ are bonded.

The alkyl group and the haloalkyl group as each of R⁴ and R⁵ may be similar to the alkyl group and the haloalkyl group exemplified for R¹ and R².

Examples of the acyloxyalkyl group as each of R⁴ and R⁵ include an alkyl group having one or more acyloxy groups as substituents. The number of carbon atoms of the acyloxyalkyl group is preferably 2 to 20, more preferably 3 to 10, and still more preferably 3 to 7.

Examples of the trialkylsilyloxyalkyl group, the aryldialkylsilyloxyalkyl group, and the alkyldiarylsilyloxyalkyl group as each of R⁴ and R⁵ include an alkyl group having one or more trialkylsilyloxy groups as substituents, an alkyl group having one or more aryldialkylsilyloxy groups as substituents, and an alkyl group having one or more alkyldiarylsilyloxy groups as substituents. The number of carbon atoms of each of the trialkylsilyloxyalkyl group, the aryldialkylsilyloxyalkyl group, and the alkyldiarylsilyloxyalkyl group is preferably 5 to 25, more preferably 10 to 22, and still more preferably 12 to 20.

The aryl group as each of R⁴ and R⁵ may be similar to the aryl group exemplified for R¹ and R². The number of carbon atoms of the aryl group is preferably 6 to 20, and more preferably 6 to 10.

Examples of the divalent hydrocarbon group as each of R⁴¹, R⁴², R⁴³, and R⁴⁴ in each of R⁴ and R⁵ include an alkanediyl group and a cycloalkanediyl group. Specific examples of the alkanediyl group include: a linear alkanediyl group such as a methylene group, an ethylene group, a trimethylene group, a tetramethylene group, a pentamethylene group, a hexamethylene group, an octamethylene group, a decamethylene group, or a dodecamethylene group; and a branched alkanediyl group such as a propylene group, an isopropylene group, an isobutylene group, a 2-methyltrimethylene group, an isopentylene group, an isohexylene group, an isooctylene group, a 2-ethylhexylene group, or an isodecylene group. Specific examples of the cycloalkanediyl group include a cyclopropylene group, a cyclopentylene group, a cyclohexylene group, and a cyclododecylene group. The number of carbon atoms of the alkanediyl group is preferably 1 to 20, more preferably 1 to 10, and still more preferably 1 to 5. The number of carbon atoms of the cycloalkanediyl group is preferably 3 to 20.

Each of R⁴ and R⁵ is preferably an alkyl group having 1 to 10 carbon atoms, an acyloxyalkyl group having 3 to 10 carbon atoms, a silyloxyalkyl group having 5 to 10 carbon atoms, an aryl group having 6 to 10 carbon atoms, —R⁴¹—OH (R⁴¹ represents an alkanediyl group having 1 to 10 carbon atoms), —R⁴²—NH₂ (R⁴² represents an alkanediyl group having 1 to 10 carbon atoms), —R⁴³—SH (R⁴³ represents an alkanediyl group having 1 to 10 carbon atoms), or —R⁴⁴—NCO (R⁴⁴ represents an alkanediyl group having 1 to 10 carbon atoms), and more preferably an alkyl group having 1 to 5 carbon atoms, an acyloxyalkyl group having 3 to 7 carbon atoms, a silyloxyalkyl group having 6 to 9 carbon atoms, —R⁴¹—OH (R⁴¹ represents an alkanediyl group having 1 to 5 carbon atoms), —R⁴²—NH₂ (R⁴² represents an alkanediyl group having 1 to 5 carbon atoms), —R⁴³—SH (R⁴³ represents an alkanediyl group having 1 to 5 carbon atoms), or —R⁴⁴—NCO (R⁴⁴ represents an alkanediyl group having 1 to 5 carbon atoms) from a viewpoint of exhibiting excellent EO characteristics.

Each of R⁴ and R⁵ may have a crosslinkable group. The crosslinkable group means a group that reacts with the same or a different group of another molecule located in the vicinity by irradiation with heat and/or active energy rays to form a crosslinked structure (to generate a novel chemical bond). Examples of the crosslinking group include: a radically polymerizable group such as a (meth)acryloyloxy group or a styryl group (vinylphenyl group); and a Diels-Alder polymerizable group that reacts with a dienophile group, such as an anthracenyl group or a benzocyclobutenyl group.

R⁴ and R⁵ may be bonded to each other to form a ring together with atoms to which R⁴ and R⁵ are bonded. When R⁴ and R⁵ are bonded to each other to form a ring, the ring is preferably a 5-membered ring or a 6-membered ring from a viewpoint of ensuring stability. The ring is preferably an aliphatic ring.

R⁶ represents an alkyl group, an alkyloxy group, an aryl group, an aryloxy group, an aralkyloxy group, a trialkylsilyloxyalkyl group, an aryldialkylsilyloxyalkyl group, an alkyldiarylsilyloxyalkyl group, an alkenyloxy group, an alkynyloxy group, a hydroxy group, an amino group, a sulfanyl group, an isocyanate group, —R⁶¹—OH (R⁶1 represents a divalent hydrocarbon group), —O—R⁶²—OH (R⁶² represents a divalent hydrocarbon group), —R⁶³—NH₂ (R⁶³ represents a divalent hydrocarbon group), —R⁶⁴—SH (R⁶⁴ represents a divalent hydrocarbon group), —R⁶⁵—NCO (R⁶⁵ represents a divalent hydrocarbon group), or —OC(═O)R⁶⁶ (R⁶⁶ represents a monovalent hydrocarbon group). These groups may each have a crosslinkable group. When there are a plurality of R⁶s, R⁶s may be the same as or different from each other. R⁶ may be bonded to R⁴ or R⁵ to form a ring together with atoms to which R⁶ and R⁴ or R⁵ are bonded.

The alkyl group as R⁶ may be similar to the alkyl group exemplified for R¹ and R². The number of carbon atoms of the alkyl group is preferably 1 to 20, more preferably 1 to 10, and still more preferably 1 to 5.

The alkyloxy group as R⁶ may be similar to the alkyloxy group exemplified for R^{A}, R^{B}, R^{C}, R^{D}, and R^{E}.

The aryl group and the aryl group of the aryloxy group as R⁶ may be similar to the aryl group as each of R¹ and R². The number of carbon atoms of the aryl group is preferably 6 to 20, and more preferably 6 to 10.

Examples of the aralkyl group of the aralkyloxy group as R⁶ include an alkyl group having one or more aryl groups as substituents. Specific examples of the aralkyl group include a benzyl group, a 1-phenylethyl group, a phenethyl group, a 1-naphthylmethyl group, a 2-naphthylmethyl group, a 1-naphthylethyl group, and a 2-naphthylethyl group.

The trialkylsilyloxyalkyl group, the aryldialkylsilyloxyalkyl group, and the alkyldiarylsilyloxyalkyl group as R⁶ may be similar to the trialkylsilyloxyalkyl groups, the aryldialkylsilyloxyalkyl groups, and the alkyldiarylsilyloxyalkyl groups exemplified for R⁴ and R⁵.

The alkenyl group of the alkenyloxy group as R⁶ may be similar to the alkenyl group exemplified for D¹.

The alkynyl group of the alkynyloxy group as R⁶ may be similar to the alkynyl group exemplified for D¹.

In R⁶, the divalent hydrocarbon group as each of R⁶¹, R⁶², R⁶³, R⁶⁴, and R⁶⁵ may be similar to the divalent hydrocarbon group exemplified for R⁴¹, R⁴², R⁴³, and R⁴⁴.

In R⁶, the monovalent hydrocarbon group as R⁶⁶ may be an alkyl group. The alkyl group may be similar to the alkyl group exemplified for R¹ and R².

R⁶ may have a crosslinkable group. The crosslinkable group may be similar to the crosslinkable groups exemplified for R⁴ and R⁵.

R⁶ may be bonded to R⁴ or R⁵ to form a ring together with atoms to which R⁶ and R⁴ or R⁵ are bonded. When R⁶ is bonded to R⁴ or R⁵ to form a ring, the ring is preferably a 5-membered ring or a 6-membered ring from a viewpoint of ensuring stability. The ring is preferably an aliphatic ring.

k represents an integer of 0 to 4. k is preferably 0 or 1, and more preferably 0.

n represents 0 or 1. n is preferably 1.

Examples of the compound represented by formula (1′) include compounds represented by formulas (1′)-1 to (1′)-26 and compounds represented by formulas (1A)-1 to (1A)-61 described later. These groups may each further have a substituent.

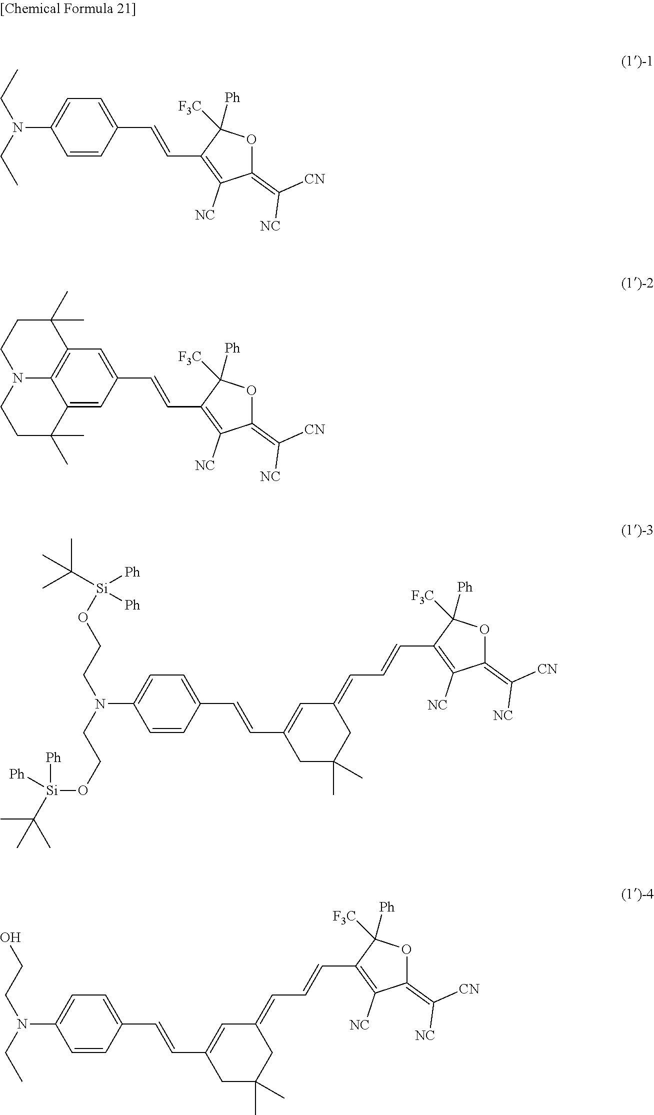 [SMILES: CCN(CC)c1ccc(/C=C/C2=C(C#N)C(=C(C#N)C#N)OC2(c2ccccc2)C(F)(F)F)cc1 ; CC1(C)CCN2CCC(C)(C)c3cc(/C=C/C4=C(C#N)C(=C(C#N)C#N)OC4(c4ccccc4)C(F)(F)F)cc1c32 ; CC1(C)CC(/C=C/c2ccc(N(CCO[Si](c3ccccc3)(c3ccccc3)C(C)(C)C)CCO[Si](c3ccccc3)(c3ccccc3)C(C)(C)C)cc2)=CC(=C/C=C/C2=C(C#N)C(=C(C#N)C#N)OC2(c2ccccc2)C(F)(F)F)/C1 ; CCN(CCO)c1ccc(/C=C/C2=CC(=C/C=C/C3=C(C#N)C(=C(C#N)C#N)OC3(c3ccccc3)C(F)(F)F)/CC(C)(C)C2)cc1]

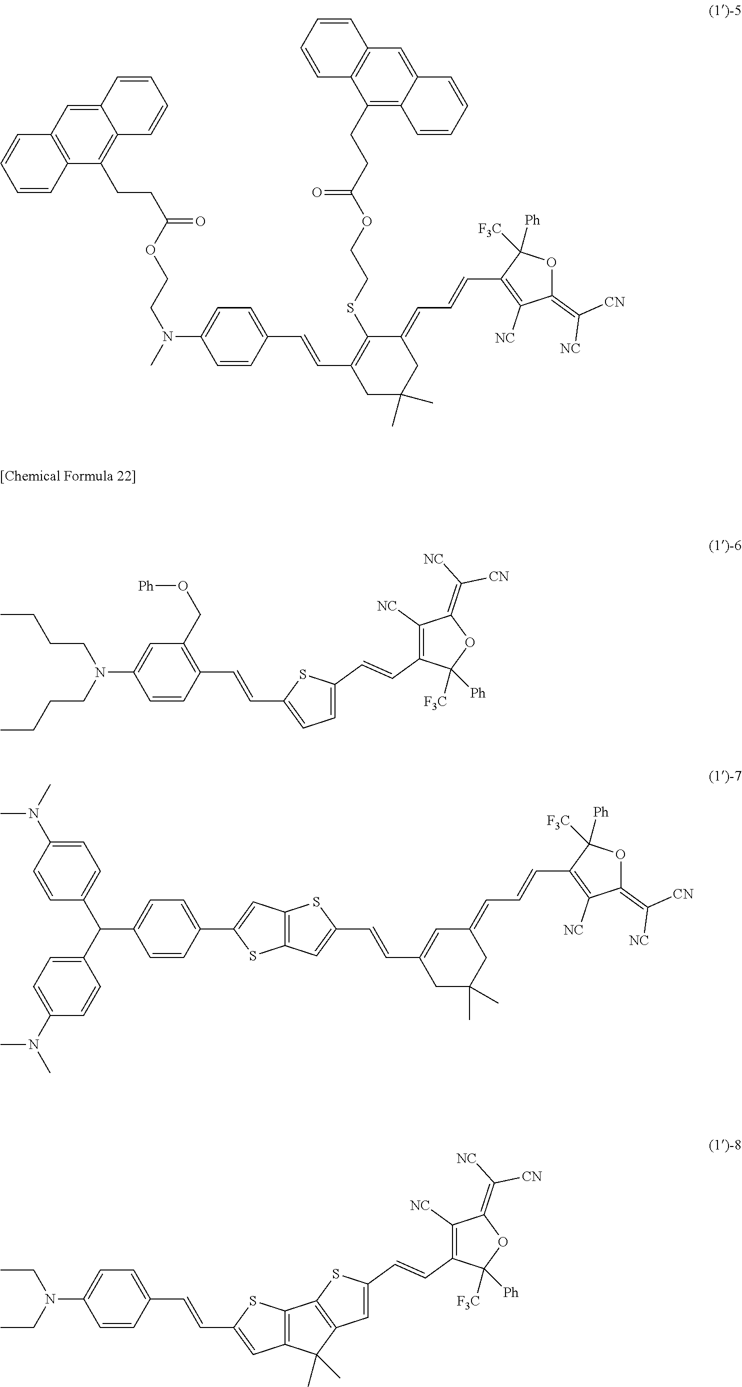 [SMILES: CN(CCOC(=O)CCc1c2ccccc2cc2ccccc12)c1ccc(/C=C/C2=C(SCCOC(=O)CCc3c4ccccc4cc4ccccc34)C(=C/C=C/C3=C(C#N)C(=C(C#N)C#N)OC3(c3ccccc3)C(F)(F)F)/CC(C)(C)C2)cc1 ; CCCCN(CCCC)c1ccc(/C=C/c2ccc(/C=C/C3=C(C#N)C(=C(C#N)C#N)OC3(c3ccccc3)C(F)(F)F)s2)c(COc2ccccc2)c1 ; CN(C)c1ccc(C(c2ccc(-c3cc4sc(/C=C/C5=CC(=C/C=C/C6=C(C#N)C(=C(C#N)C#N)OC6(c6ccccc6)C(F)(F)F)/CC(C)(C)C5)cc4s3)cc2)c2ccc(N(C)C)cc2)cc1 ; CCN(CC)c1ccc(/C=C/c2cc3c(s2)-c2sc(/C=C/C4=C(C#N)C(=C(C#N)C#N)OC4(c4ccccc4)C(F)(F)F)cc2C3(C)C)cc1]

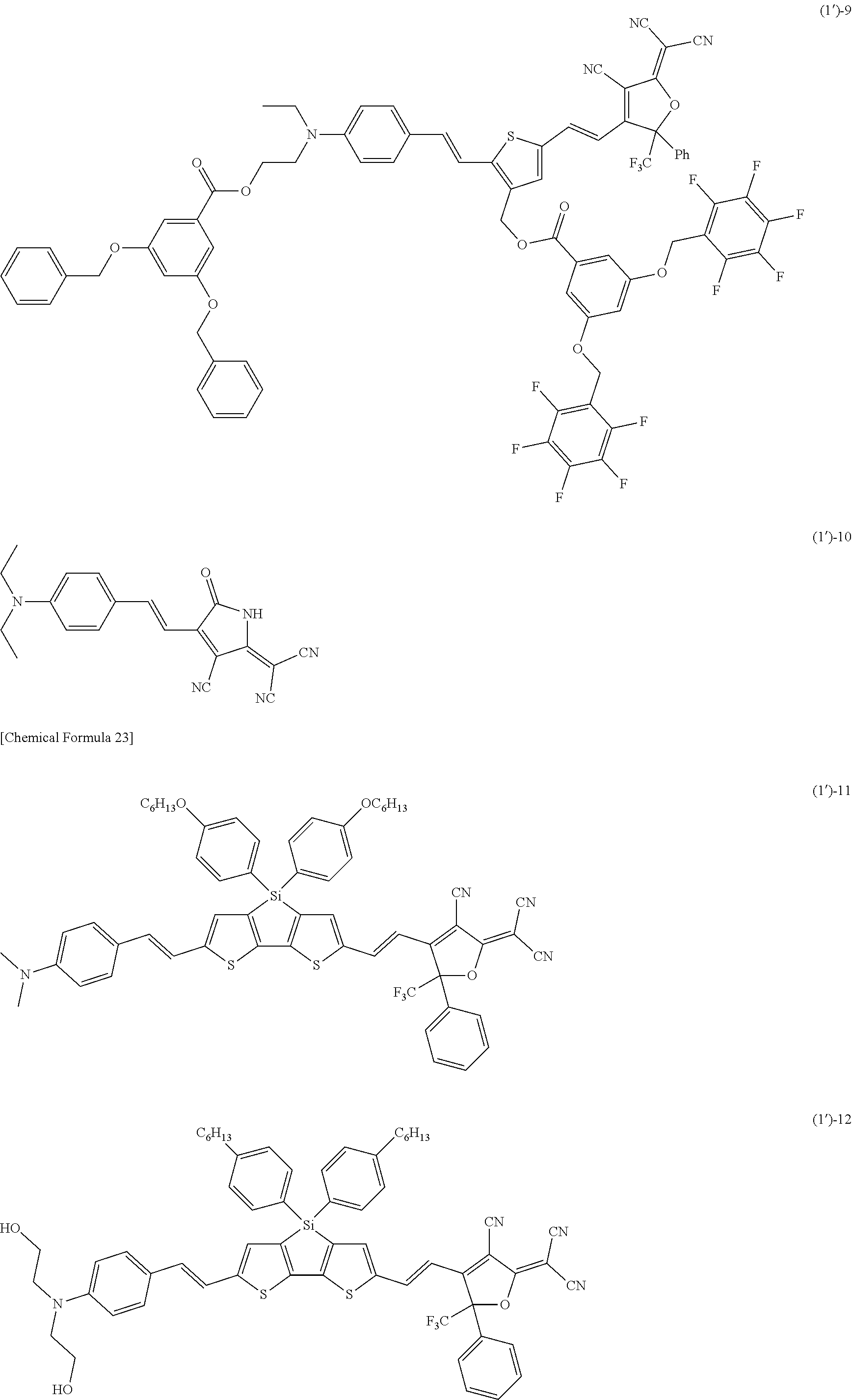

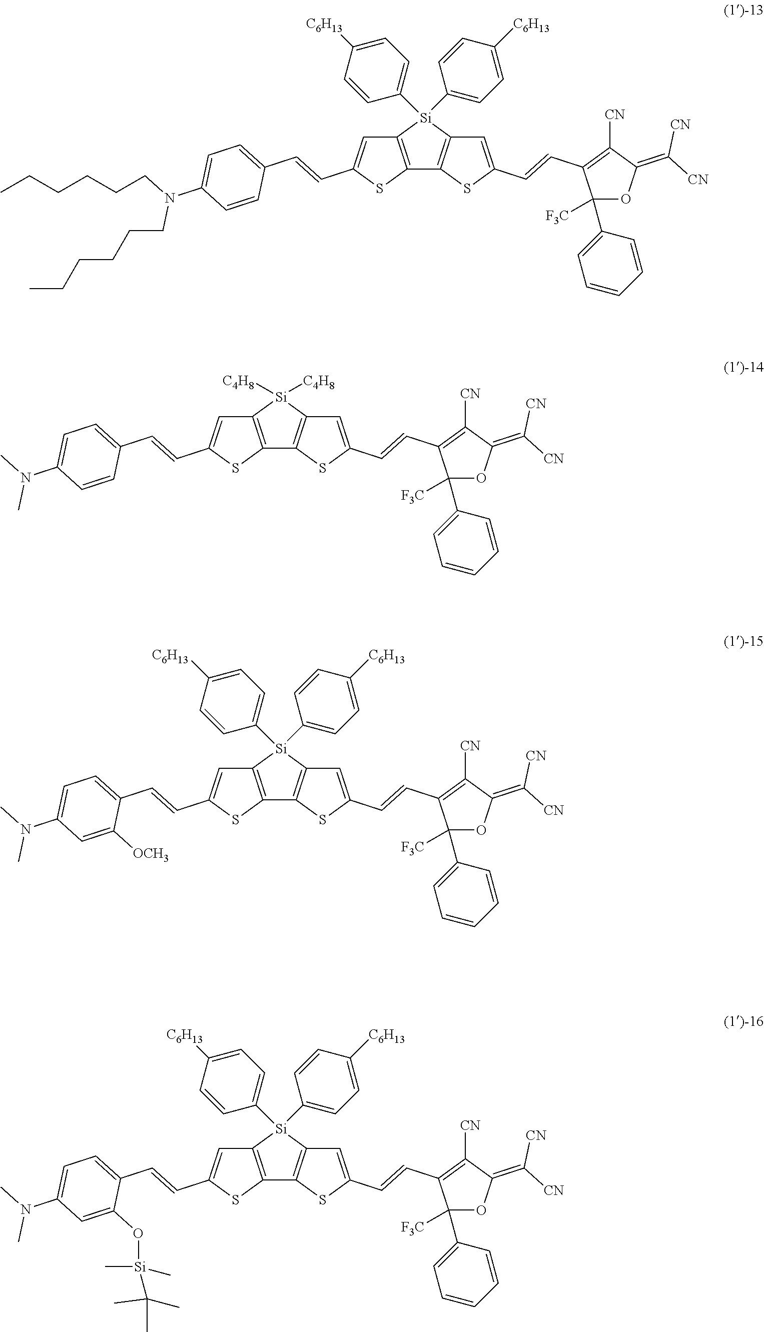

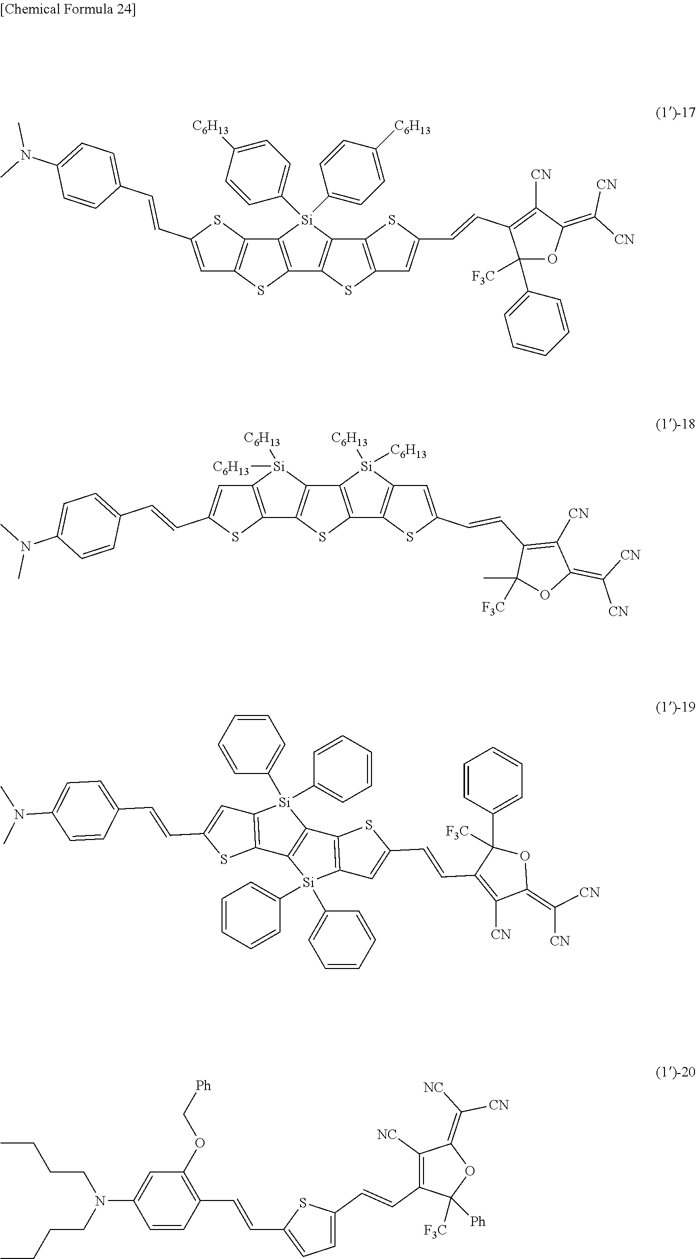

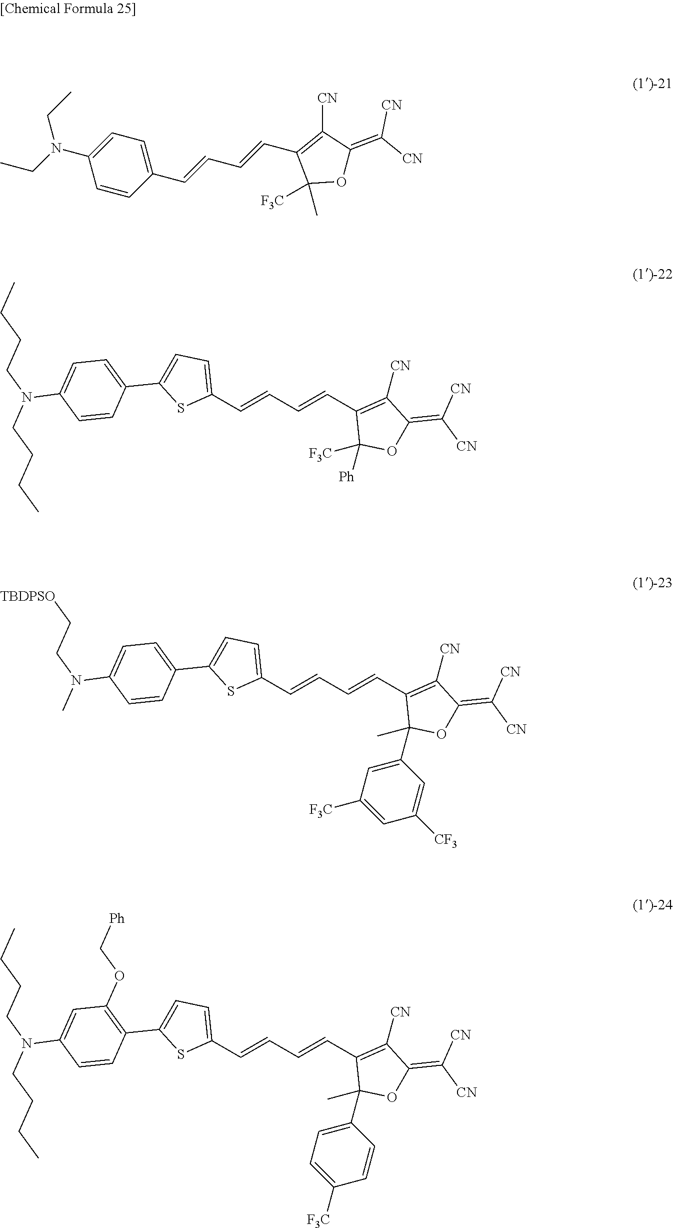

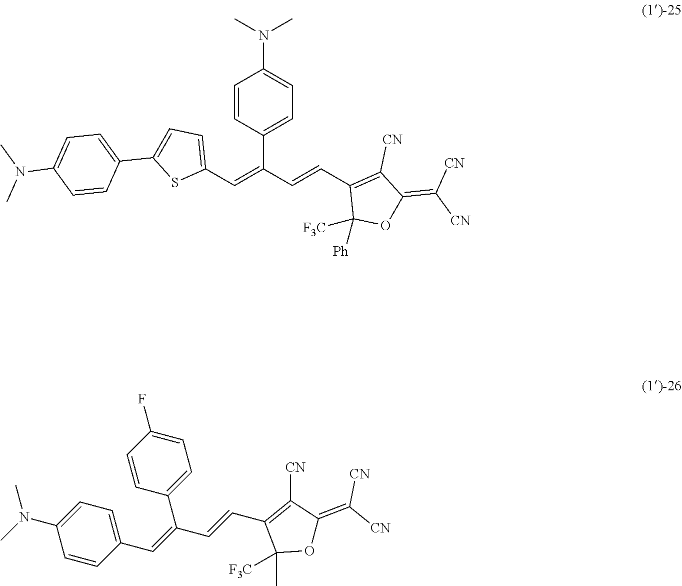 [SMILES: CN(C)c1ccc(C(=C\c2ccc(-c3ccc(N(C)C)cc3)s2)/C=C/C2=C(C#N)C(=C(C#N)C#N)OC2(c2ccccc2)C(F)(F)F)cc1 ; CN(C)c1ccc(/C=C(/C=C/C2=C(C#N)C(=C(C#N)C#N)OC2(C)C(F)(F)F)c2ccc(F)cc2)cc1]

The compound represented by formula (1′) may have a cis-trans isomer. In the compound of the present embodiment, generation of a trans isomer tends to be dominant, but any one of a cis isomer, a trans isomer, and a cis-trans isomer mixture can be used. Among these, the compound of the present embodiment is preferably a trans isomer from a viewpoint of easily ensuring a polarizability.

### <Compound Represented by Formula (1″)>

Similarly to the compound represented by formula (1′), the compound represented by formula (1″) has a structure in which an electron-donating group (group having a donor structure) and an electron-withdrawing group (group having an acceptor structure) are linked by a predetermined linking group, and is used as an organic EO material.

[Chemical Formula 26]

D²-X²-A² (1″)

### Electron-Withdrawing Group (Group Having an Acceptor Structure) A²

In formula (1″), A² is an electron-withdrawing group (group having an acceptor structure) and represents a group represented by the following formula (a2).

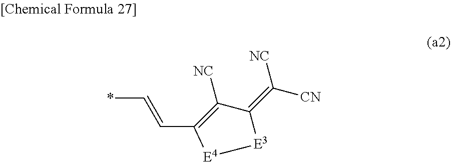

In formula (a2), E³ and E⁴ each independently represent —C(R¹¹)(R¹²)—, —C(O)—, —O—, or —NR¹³—. Note that at least one of E³ and E⁴ is —O— or —NR¹³—.

R¹¹ and R¹² each independently represent a hydrogen atom, an alkyl group, or an aryl group.

The alkyl group as R¹¹ and R¹² may be similar to the alkyl group exemplified for R¹ and R².

The aryl group as R¹¹ and R¹² may be similar to the aryl group exemplified for R¹ and R².

The alkyl group as R¹³ may be similar to the alkyl group exemplified for R¹¹ and R¹².

E³ is preferably —O— or —NR¹³— because desired electro-optic characteristics are easily obtained. E⁴ is —C(CH₃)₂— or —C(O)—, and more preferably —C(CH₃)₂— from a viewpoint of enhancing an electron withdrawing property and improving an EO coefficient. A combination of E³ and E⁴ is preferably a combination of —O— and —C(CH₃)₂— or a combination of —NR¹³— and —C(O)—, and more preferably a combination of —O— and —C(CH₃)₂— from a viewpoint of synthesis.

Examples of the group represented by formula (a2) include groups represented by formulas (a2)-1 to (a2)-19. These groups may each further have a substituent. * represents a bonding position.

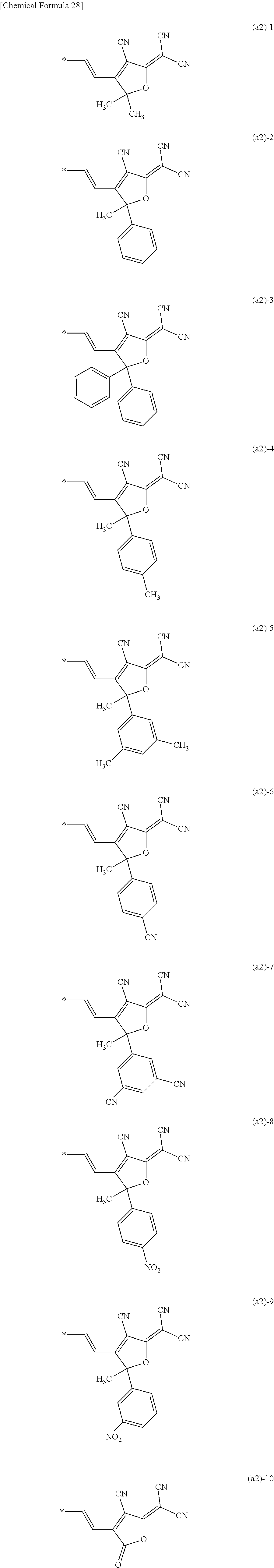

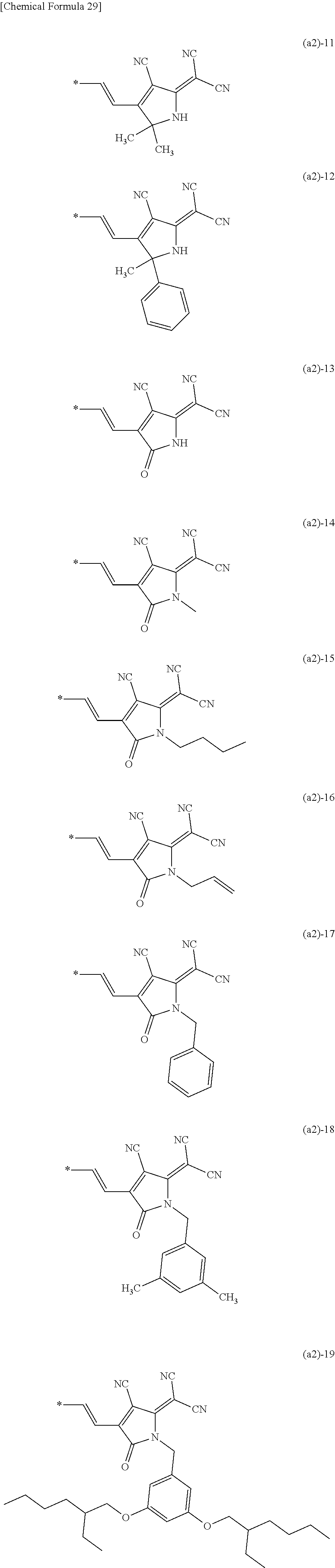

### Linking Group (Linking Bond) X²

In formula (1′), X² represents a divalent conjugated linking group containing a divalent polycyclic condensed ring group. Here, the divalent conjugated linking group means a divalent linking group in which a conjugated system is connected from one bonding position to the other bonding position.

The divalent polycyclic condensed ring group in X² is a divalent polycyclic condensed ring group having one or two thienothiophene rings, having at least one selected from the group consisting of an sp3 carbon atom and a silicon atom as a constituent element, and not containing a benzene ring, and the number of rings in the entire condensed ring of the divalent polycyclic condensed ring group is 4 to 10. Note that the thienothiophene ring means a ring structure in which two thiophene rings are condensed.

Examples of the divalent polycyclic condensed ring group in X² include groups represented by the above formulas (X-13) to (X-15), (X-19), (X-23), (X-25), (X-36), and (X-40).

The divalent conjugated linking group as X² may further include: an arylene group; a heteroarylene group; a divalent polycyclic condensed ring group; —CR^{X1}=CR^{X2}—; —C≡C—; —N═N—; -arylene group-Y—; heteroarylene group-Y—, and the like exemplified as X^{AA}.

### Electron-Donating Group (Group Having a Donor Structure) D²

In formula (1″), D² represents an electron-donating group. D² may be a group relatively exhibiting an electron donating property with respect to the group represented by formula (a2) as A².

As D², those similar to D¹ are exemplified. Therefore, redundant description will be omitted here.

Examples of the compound represented by formula (1″) include compounds represented by formulas (1″)-1 to (1″)-15. The compound represented by formula (1″) is preferably a compound represented by any one of formulas (1″)-1 to (1″)-8 and formulas (1″)-13 to (1″)-15. These compounds may each further have a substituent.

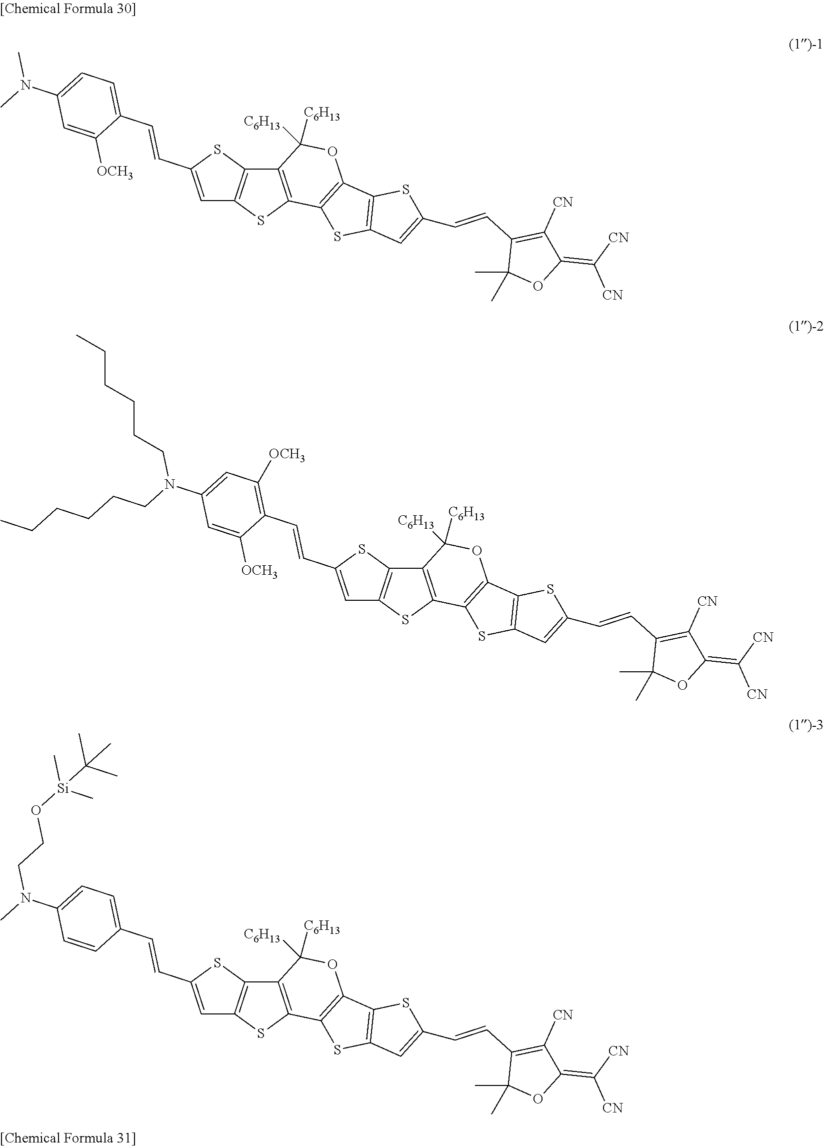

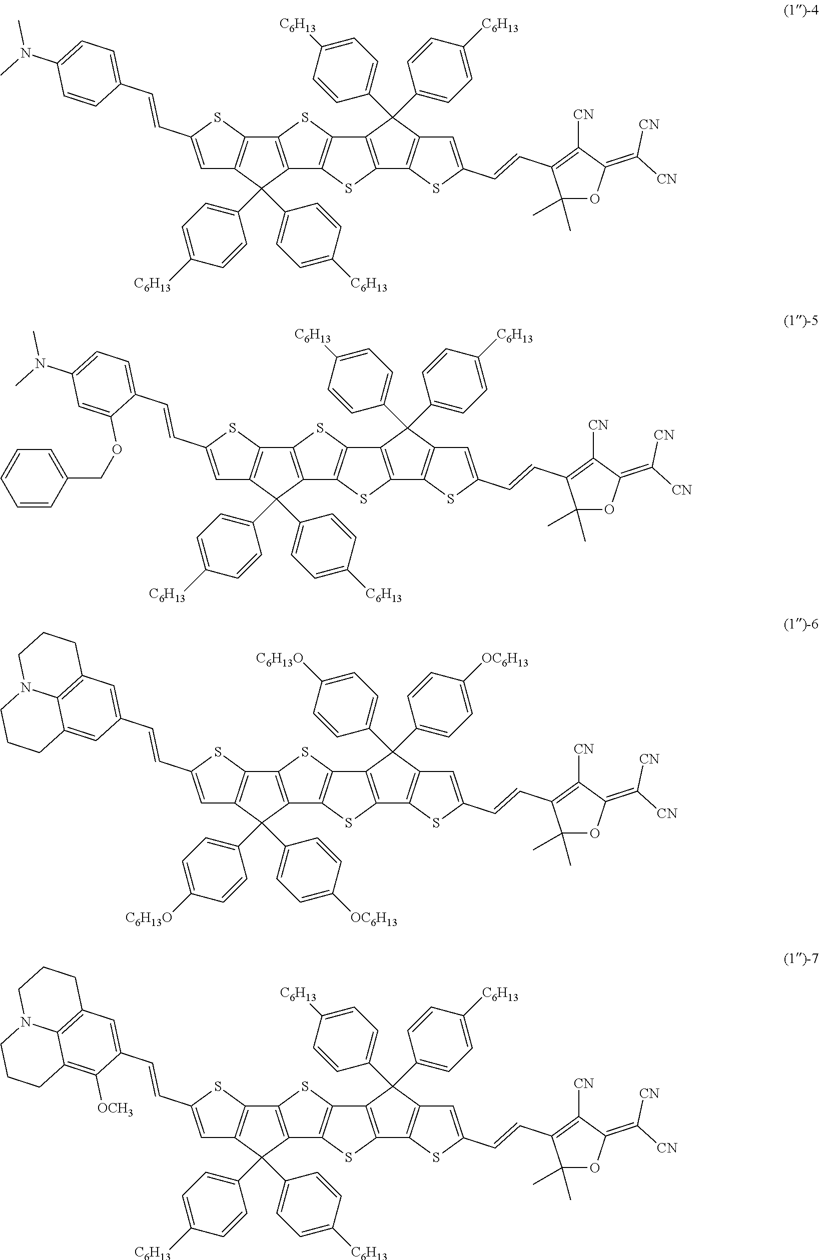

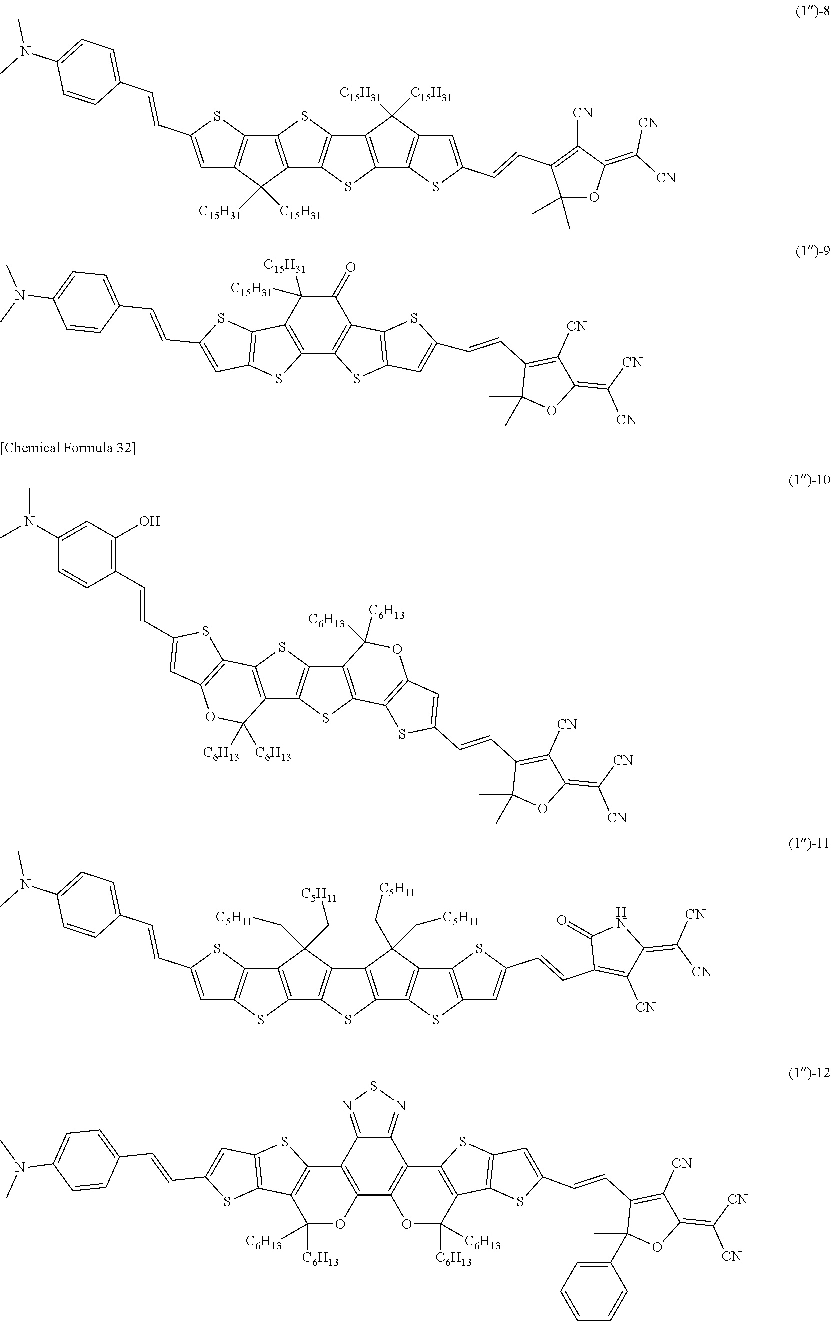

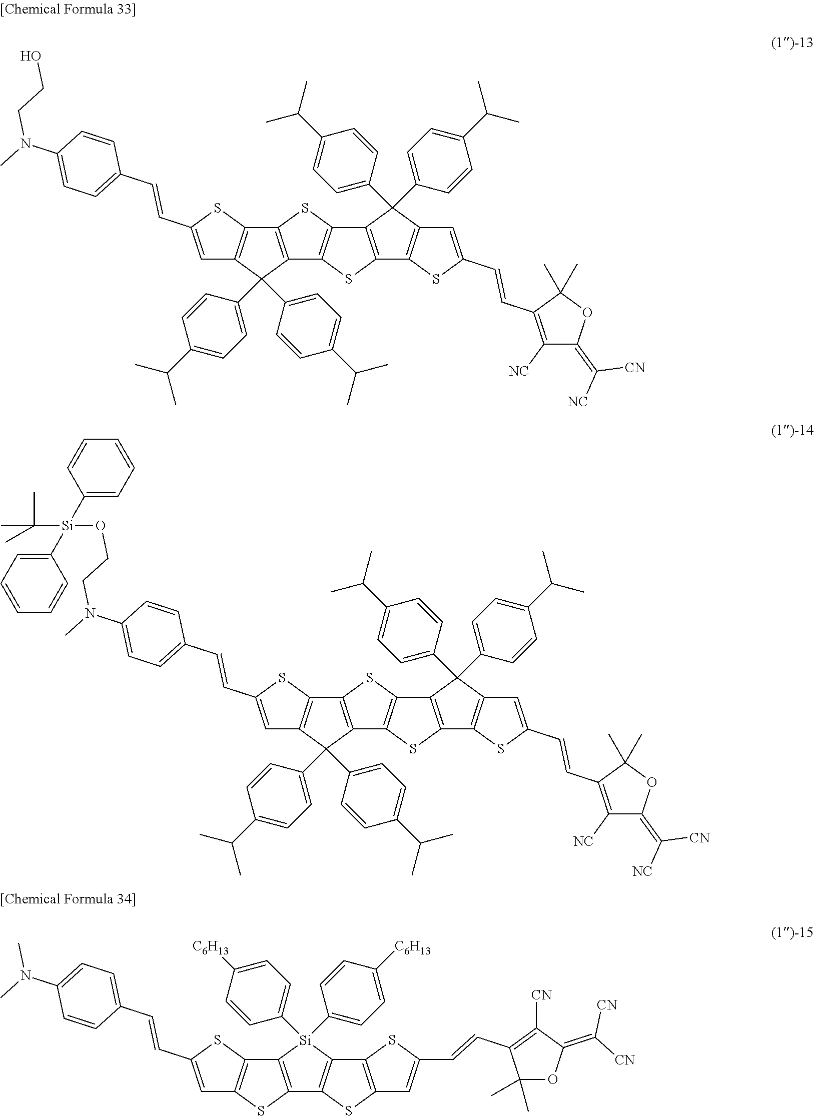

The compound represented by formula (1″) may have a cis-trans isomer. In the compound of the present embodiment, generation of a trans isomer tends to be dominant, but any one of a cis isomer, a trans isomer, and a cis-trans isomer mixture can be used. Among these, the compound of the present embodiment is preferably a trans isomer from a viewpoint of easily ensuring a polarizability.

### <Organic Solvent>

The organic solvent is an organic solvent having a boiling point of 120° C. or higher and a dipole moment of less than 3.0 debye. The organic solvent may be used singly or in combination of two or more types thereof as long as the organic solvent has a boiling point of 120° C. or higher and a dipole moment of less than 3.0 debye. By combining such an organic solvent with a predetermined compound, decomposition of the predetermined compound by the organic solvent tends to be suppressed. A reason why such an effect is exhibited is not necessarily clear, but the present applicant considers the reason as follows. When an organic solvent having a dipole moment of 3.0 or more is used, a polar group of the organic solvent is added to the predetermined compound. Subsequently, solvolysis in which a substituent originally included in the predetermined compound is eliminated and replaced with a substituent derived from the organic solvent proceeds. It is presumed that solvolysis can be avoided by using an organic solvent having a dipole moment of less than 3.0 debye, and as a result, it is considered that decomposition of the predetermined compound can be suppressed. The organic solvent is more preferably one capable of dissolving or uniformly dispersing the predetermined compound.

The organic solvent has a boiling point of 120° C. or higher. When the boiling point is 120° C. or higher, an EO element having a flat surface tends to be easily obtained. The boiling point is preferably 130° C. or higher, more preferably 140° C. or higher, still more preferably 150° C. or higher, and particularly preferably 160° C. or higher. An upper limit of the boiling point is not particularly limited, but may be 280° C. or lower, 260° C. or lower, or 240° C. or lower. Note that the boiling point means a boiling point at 1 atm (1.0×10⁵ Pa).

The organic solvent has a dipole moment of less than 3.0 debye. When the dipole moment is less than 3.0 debye, solvolysis of the predetermined compound tends to hardly proceed. The dipole moment is preferably 2.8 debye or less, more preferably 2.6 debye or less, and still more preferably 2.5 debye or less. A lower limit of the dipole moment is not particularly limited, but may be 0.1 debye or more or 0.3 debye or more.

The dipole moment p of the organic solvent can be calculated, for example, by Gaussian 09 which is a quantum chemical calculation program manufactured by Gaussian. More specifically, the dipole moment p of the organic solvent can be calculated by performing structure optimization calculation by pcm calculation (designating chloroform as a solvent) under an M062X/6-31+g(d) condition.

Specific examples of the organic solvent include o-dichlorobenzene (ortho-dichlorobenzene) (boiling point: 180° C., dipole moment: 2.3 debye), chlorobenzene (boiling point: 131° C., dipole moment: 1.6 debye), xylene (boiling point: 139° C., dipole moment: 0.4 debye), propylene glycol monomethyl ether acetate (PGMEA) (boiling point: 146° C., dipole moment: 1.8 debye), tetralin (boiling point: 208° C., dipole moment: 0.4 debye), 2-heptanone (boiling point: 151° C., dipole moment: 2.6 debye), butyl acetate (boiling point: 126° C., dipole moment: 1.8 debye), ethylcyclohexane (boiling point: 101° C., dipole moment: 0.0 debye), and 1,3,5-trimethylbenzene (boiling point: 165° C., dipole moment: 0.1 debye).

The content of the organic solvent is not particularly limited, but is preferably 200 to 200,000 parts by mass, more preferably 300 to 20,000 parts by mass, and still more preferably 400 to 10,000 parts by mass with respect to 100 parts by mass of the total amount of the predetermined compounds (the compound represented by formula (1′) and the compound represented by formula (1″)) from a viewpoint of coatability. When the electro-optic ink composition further contains an amorphous resin described later, the content of the organic solvent is preferably 100 to 100,000 parts by mass, more preferably 150 to 10,000 parts by mass, and still more preferably 200 to 5000 parts by mass with respect to 100 parts by mass of the total solid content (the predetermined compound and the amorphous resin) from a viewpoint of coatability.

### <Amorphous Resin>

The EO ink composition of the present embodiment preferably further contains an amorphous resin. The amorphous resin is a component that acts as a host material capable of dispersing at least one compound selected from the group consisting of the compound represented by formula (1′) and the compound represented by formula (1″), and the amorphous resin preferably exhibits high compatibility with the compound. The amorphous resin may form a covalent bond with the compound, or may react with a crosslinkable group of the compound to form a crosslinked structure.

Determination of “amorphous” in the amorphous resin can be made by presence or absence of a melting point (Tm) (an endothermic peak associated with melting observed in differential scanning calorimetry (DSC)), and “amorphous” means having no melting point (Tm). That is, the amorphous resin means a resin having no melting point (Tm).

Examples of the amorphous resin include a resin having no melting point (Tm), such as a poly(meth)acrylate including polymethyl methacrylate (PMMA), polyimide, polycarbonate, polystyrene, polysulfone, polyether sulfone, a silicon-based resin, or an epoxy-based resin. These resins have excellent compatibility with an EO compound, and tend to have excellent transparency and moldability when being used as an EO element.

Examples of a method for dispersing the predetermined compound in the amorphous resin include a method for dispersing the predetermined compound and the amorphous resin in an organic solvent at an appropriate mixing ratio.

The amorphous resin may contain a resin having a reactive functional group capable of forming a covalent bond with an EO compound. Furthermore, at least a part of the EO compound is preferably bonded to the resin having the reactive functional group. By inclusion of such an amorphous resin, the EO compound can be dispersed at a high density in the amorphous resin, and high EO characteristics can be achieved.

Examples of the reactive functional group include a haloalkyl group, an acyl halide group, an alkoxycarbonyl group, an aryloxycarbonyl group, a hydroxy group, an amino group, an isocyanate group, an epoxy group, and a carboxy group. The reactive functional group can form a covalent bond by reacting with, for example, a hydroxy group, an amino group, or an alkoxycarbonyl group in the EO compound.

The amorphous resin may contain a resin having a crosslinkable functional group that reacts with a crosslinkable group in the EO compound to form a crosslinked structure. Furthermore, at least a part of the EO compound preferably forms a crosslinked structure with the resin having the crosslinkable functional group. By inclusion of such an amorphous resin, the EO compound can be dispersed at a high density in the amorphous resin, and high EO characteristics can be achieved.

Examples of the crosslinkable functional group include a radically polymerizable group such as a (meth)acryloyloxy group or a styryl group (vinylphenyl group), and a dienophile group such as an anthracenyl group or a benzocyclobutenyl group. The crosslinkable functional group can react with a crosslinkable group in the EO compound to form a crosslinked structure.

The content of the amorphous resin is preferably 100 to 100,000 parts by mass, more preferably 150 to 10,000 parts by mass, and still more preferably 200 to 5,000 parts by mass with respect to 100 parts by mass of the total amount of the predetermined compounds (the compound represented by formula (1′) and the compound represented by formula (1″)) from a viewpoint of coatability.

### [Electro-Optic Film and Electro-Optic Element]

An EO film and an EO element of the present embodiment can be manufactured by a known method (methods described in, for example, Oh et al., IEEE Journal of Selected Topics in Quantum Electronics, Vol. 7, No. 5, pp. 826-835, September/October 2001; Dalton et al., Journal of Materials Chemistry, 1999, 9, pp. 1905-1920; Toshikuni Kaino, Journal of the Institute of Electronics, Information and Communication Engineers, CVol. J84-C, No. 9, pp. 744-755, September 2001; and Ma et al., Advanced Materials, Vol. 14, No. 19, 2002, pp. 1339-1365).

The EO film is formed using, for example, the above-described EO ink composition as a forming material, and can be formed using such an EO ink composition. The EO film can be obtained, for example, by a method including a step of applying the EO ink composition onto a substrate by spin coating, and a step of heating and drying the obtained coating film. The EO film may have a thickness of, for example, 0.01 to 100 μm.

The EO film has an EO coefficient of preferably 30 to 1000 pm/V, more preferably 40 to 800 pm/V, still more preferably 50 to 500 pm/V. Note that an EO coefficient r33 can be measured in a similar manner to a method described in a reference paper (“Transmission ellipsometric method without an aperture for simple and reliable evaluation of electro-optic properties”, Toshiki Yamada and Akira Otomo, Optics Express, voI. 21, pages 29240-48 (2013)).

By using the EO ink composition in manufacturing an EO element, heat resistance required for a high-temperature process at the time of poling, a thermal curing process for fixing film orientation, a high-temperature process at the time of mounting, and the like can be improved, and the degree of freedom in an element manufacturing process can be increased.

The EO element of the present embodiment includes an EO film formed using the above EO ink composition. An application of the EO element of the present embodiment is not limited to an optical modulator as long as the EO element has the above EO film. The EO element of the present embodiment can be used for, in addition to the optical modulator (application for ultra-high-speed, application for optical interconnect, application for optical signal processing, and the like), for example, an optical switch, an optical memory, a wavelength converter, an electric field sensor using a microwave, a millimeter wave, a terahertz wave, or the like, a biological potential sensor using a myoelectric potential, an electroencephalogram, or the like, an optical spatial modulator, an optical scanner, and the like, and can be further used for signal transmission by light between electronic circuits by combination with an electronic circuit, and the like.

### [Compound]

<Compound represented by Formula (1A)>

A compound represented by formula (1A) has a structure in which an electron-donating group (group having a donor structure) and an electron-withdrawing group (group having an acceptor structure) are linked by a predetermined linking group, and is used as an organic EO material.

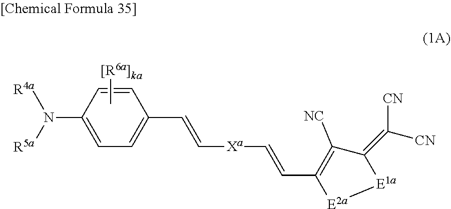

In formula (1A), X^{a} represents a divalent polycyclic condensed ring group having two or more thiophene rings, having at least one selected from the group consisting of an sp3 carbon atom and a nitrogen atom as a constituent element, and not containing a benzene ring, and the divalent polycyclic condensed ring group may have a substituent. The divalent polycyclic condensed ring group as X^{a} is similar to the divalent polycyclic condensed ring group in X¹(X^{A}) except that the divalent polycyclic condensed ring group as X^{a} has two or more thiophene rings, has at least one selected from the group consisting of an sp3 carbon atom and a nitrogen atom as a constituent element, and does not contain a benzene ring. Therefore, redundant description will be omitted here.

Examples of the divalent polycyclic condensed ring group as X^{a} include a condensed ring group having two or more thiophene rings, having at least one selected from the group consisting of an sp3 carbon atom and a nitrogen atom as a constituent element, and not containing a benzene ring in the divalent polycyclic condensed ring group in X¹(X^{AA}). Specific examples thereof include groups represented by the above formulas (X-1) to (X-8), (X-12) to (X-15), (X-19) to (X-31), (X-33), and (X-34).

E^{1a} and E^{2a} each independently represent —C(R^{1a})(R^{2a}), —C(O)—, —O—, or —NR^{3a}—. Note that at least one of E^{1a} and E^{2a} is —O— or —NR^{3a}.

R^{1a} and R^{2a} each independently represent a hydrogen atom, an alkyl group, a haloalkyl group, an aryl group, or a haloaryl group. Note that at least one of R^{1a} and R^{2a} is a group containing a halogen atom.

R^{3a} represents a hydrogen atom or an alkyl group.

R^{4a} and R^{5a} each independently represent an alkyl group, a haloalkyl group, an acyloxyalkyl group, a trialkylsilyloxyalkyl group, an aryldialkylsilyloxyalkyl group, an alkyldiarylsilyloxyalkyl group, an aryl group, —R^{41a}—OH (R^{41a} represents a divalent hydrocarbon group), —R^{42a}—NH₂ (R^{42a} represents a divalent hydrocarbon group), —R^{43a}—SH (R^{43a} represents a divalent hydrocarbon group), or —R^{44a}—NCO (R^{44a} represents a divalent hydrocarbon group). These groups may each have a crosslinkable group. R^{4a} and R^{5a} may be bonded to each other to form a ring together with atoms to which R^{4a} and R^{5a} are bonded.

R^{6a} represents an alkyl group, an alkyloxy group, an aryl group, an aryloxy group, an aralkyloxy group, a trialkylsilyloxyalkyl group, an aryldialkylsilyloxyalkyl group, an alkyldiarylsilyloxyalkyl group, an alkenyloxy group, an alkynyloxy group, a hydroxy group, an amino group, a sulfanyl group, an isocyanate group, —R^{61a}—OH (R^{61a} represents a divalent hydrocarbon group), —O—R^{62a}—OH (R^{62a} represents a divalent hydrocarbon group), —R^{63a}—NH₂ (R^{63a} represents a divalent hydrocarbon group), —R^{64a}—SH (R^{64a} represents a divalent hydrocarbon group), —R^{65a}—NCO (R^{65a} represents a divalent hydrocarbon group), or —OC(═O)R^{66a}(R^{66a} represents a monovalent hydrocarbon group). These groups may each have a crosslinkable group. When there are a plurality of R^{6a}s, R^{6a}s may be the same as or different from each other. R^{6a} may be bonded to R^{4a} or R^{5a} to form a ring together with atoms to which R^{6a} and R^{4a} or R^{5a} are bonded.

ka represents an integer of 0 to 4.

E^{1a}, E^{2a}, R^{1a}, R^{2a}, R^{3a}, R^{4a}, R^{5a}, R^{4a}, R^{42a}, R^{43a}, R^{44a}, R^{6a}, R^{61a}, R^{62a}, R^{63a}, R^{64a}, R^{65a}, R^{66a}, and ka in formula (1A) have the same meaning as E¹, E², R¹, R², R³, R⁴, R⁵, R⁴¹, R⁴², R⁴³, R⁴⁴, R⁶, R⁶¹, R⁶², R⁶³, R⁶⁴, R⁶⁵, R⁶⁶, and k in formula (a1) and formula (d1), respectively. Therefore, redundant description will be omitted here.

The compound represented by formula (1A) is preferably a compound represented by formula (2) or a compound represented by formula (3), and more preferably a compound represented by formula (2).

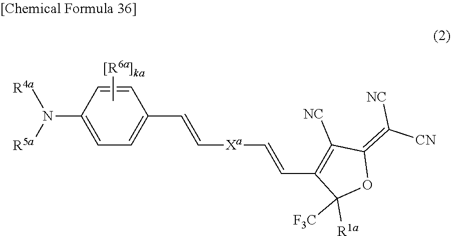

In formula (2), X^{a}, R^{1a}, R^{4a}, R^{5a}, R^{6a}, and ka have the same meanings as those described above.

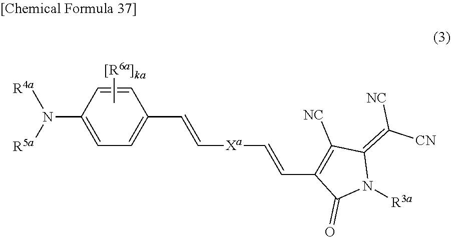

In formula (3), X^{a}, R^{3a}, R^{4a}, R^{5a}, R^{6a}, and ka have the same meanings as those described above.

Examples of the compound represented by formula (1A) include compounds represented by formulas (1A)-1 to (1A)-61. These groups may each further have a substituent.

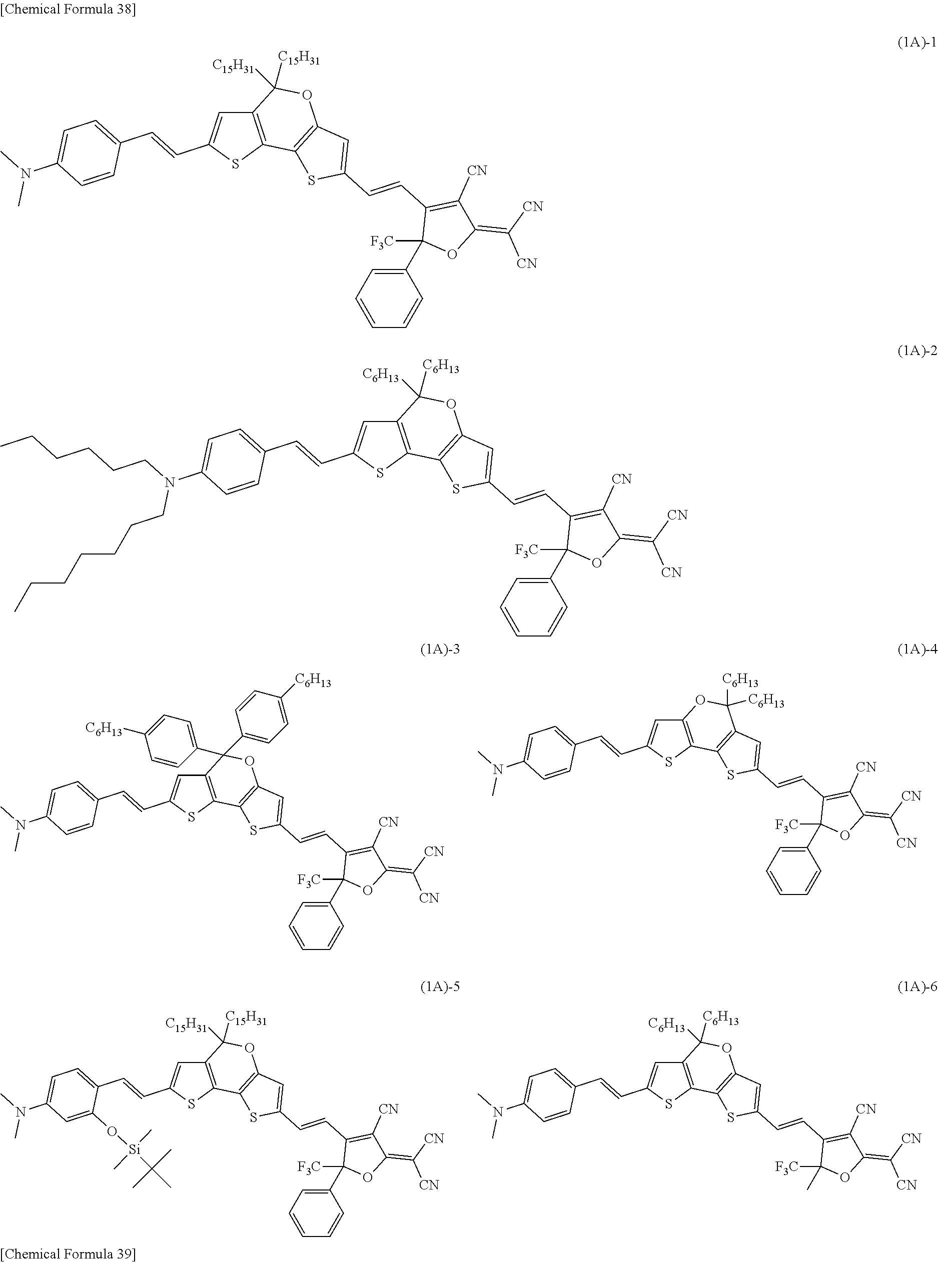

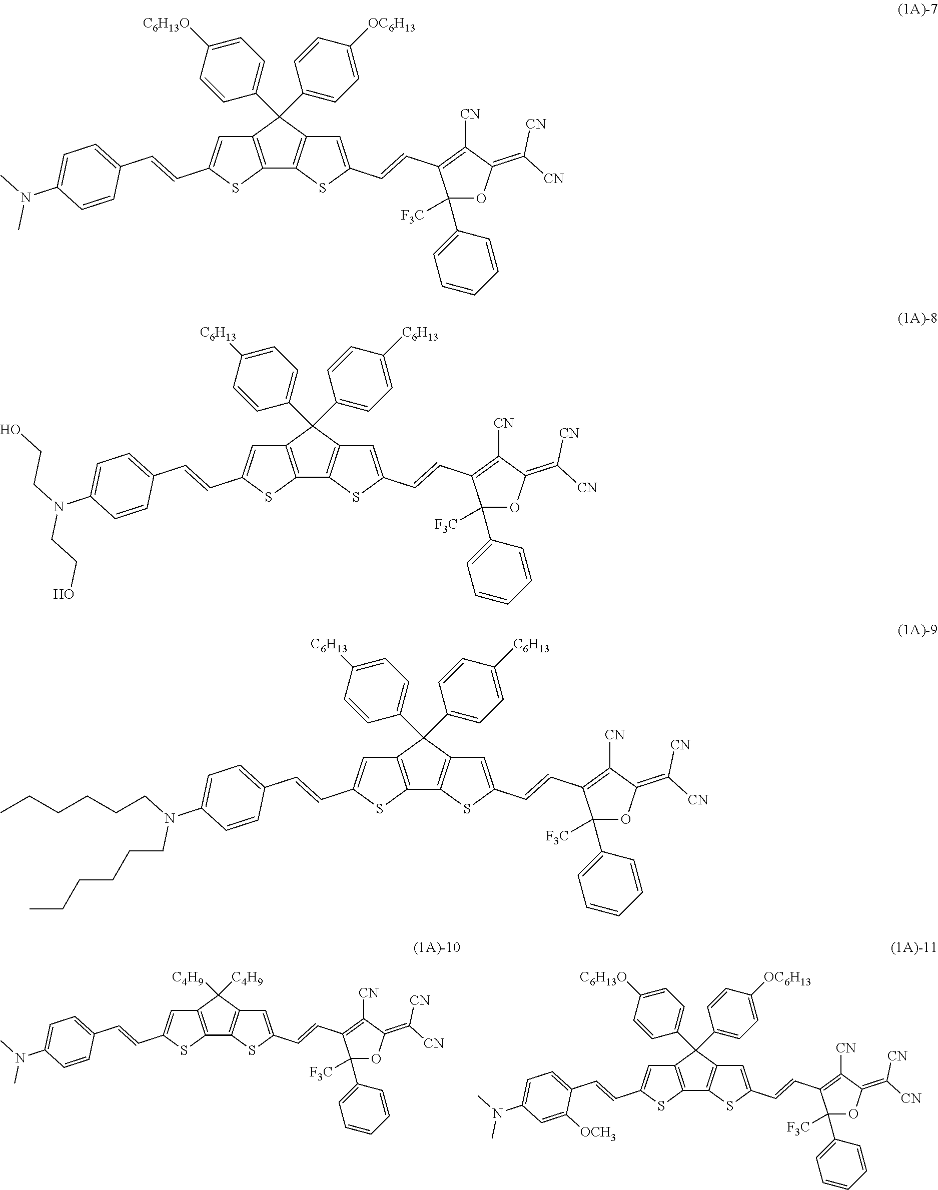

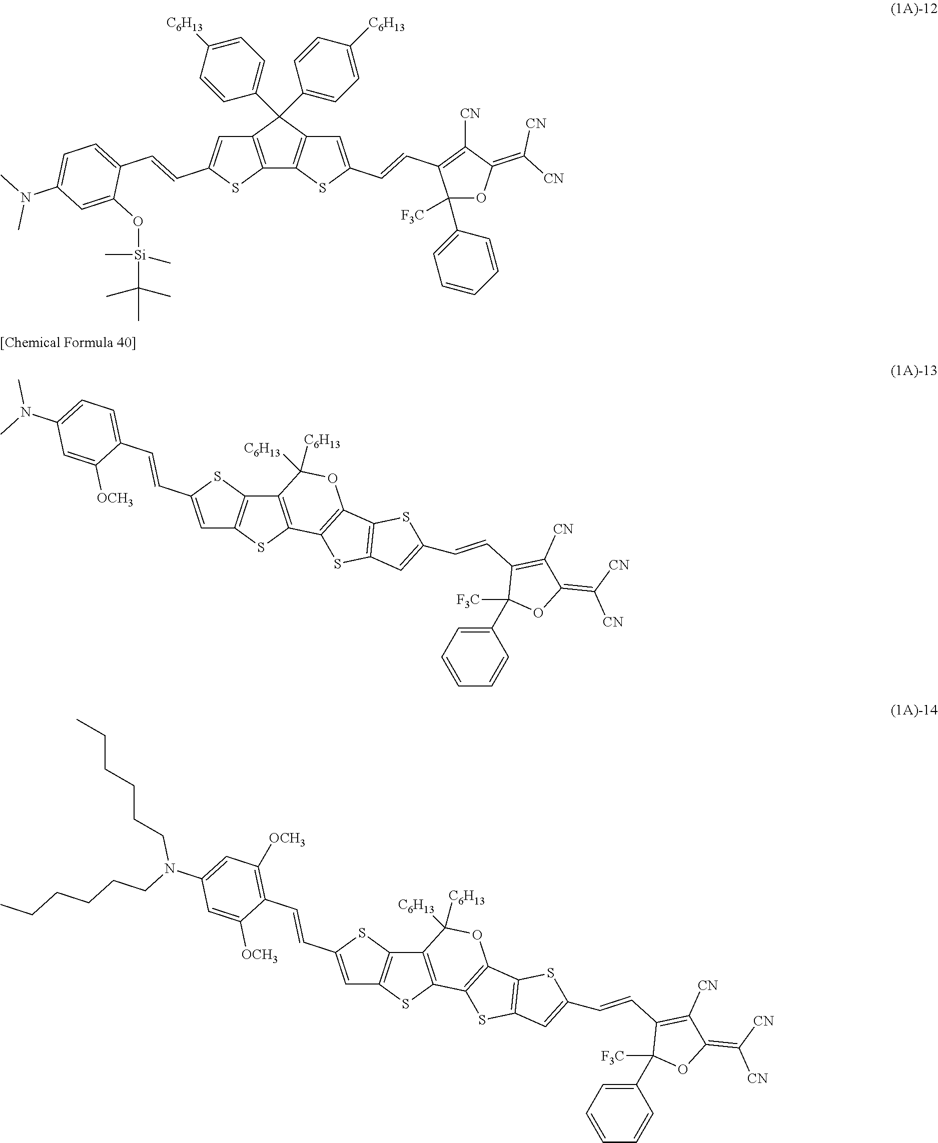

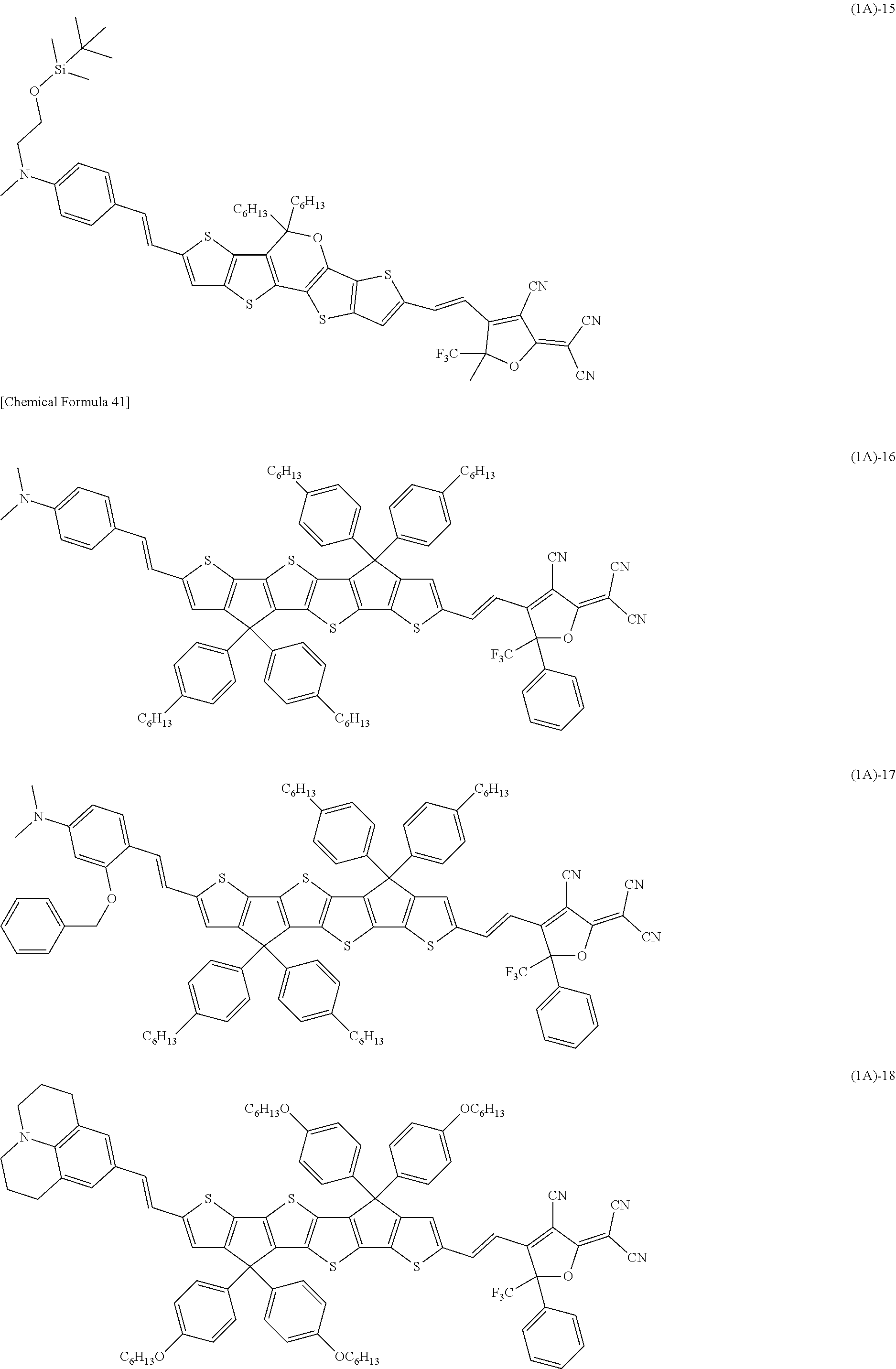

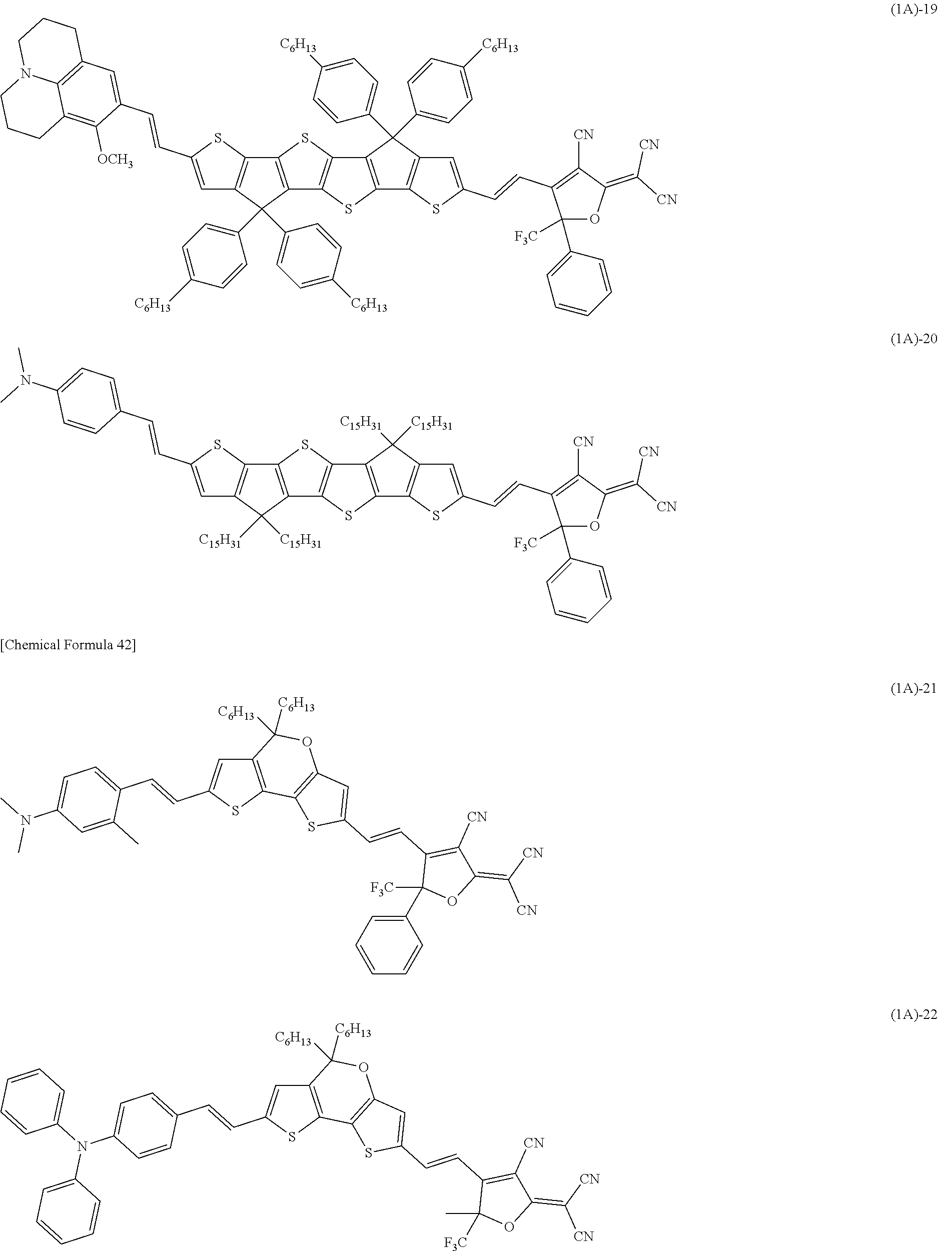

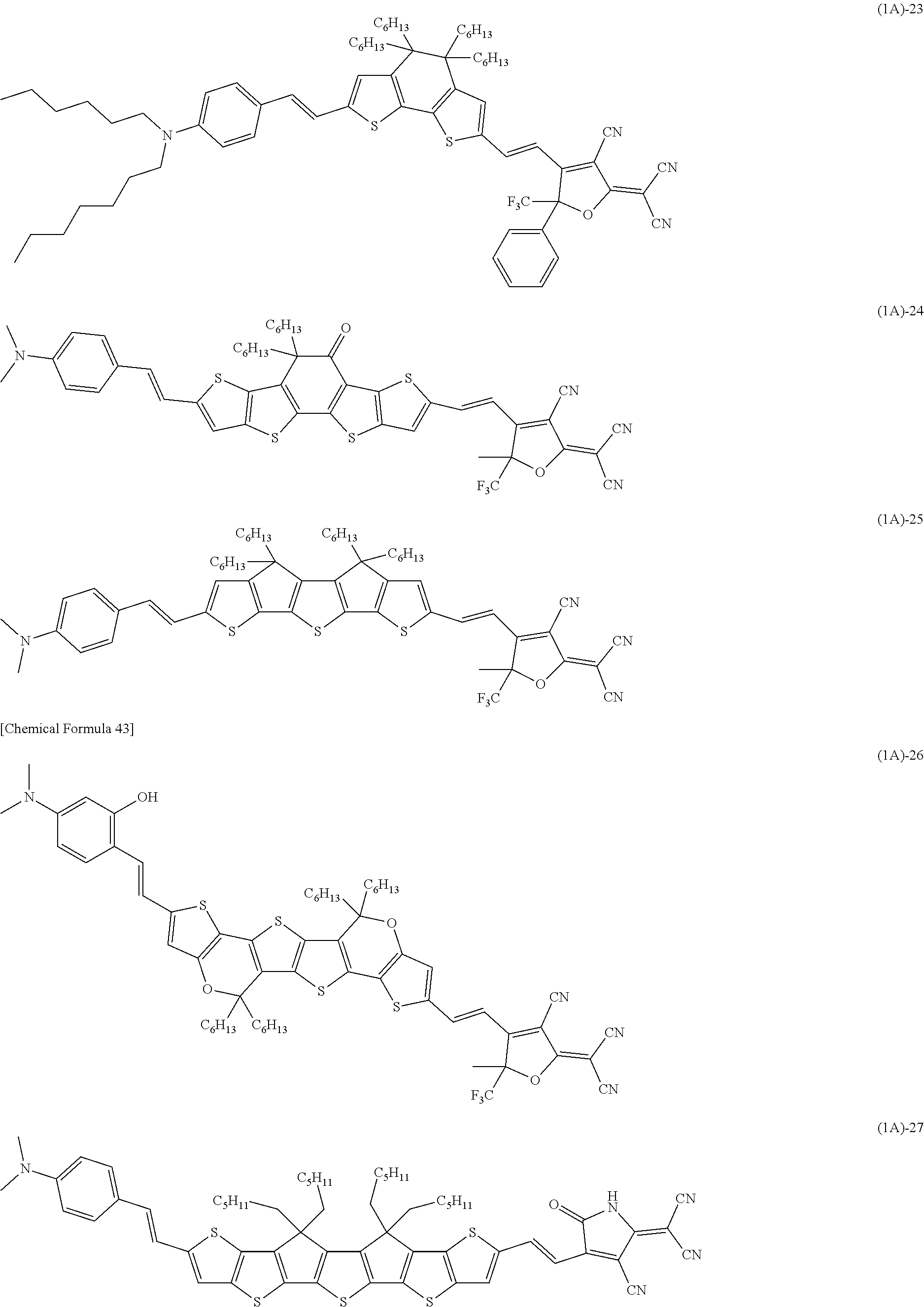

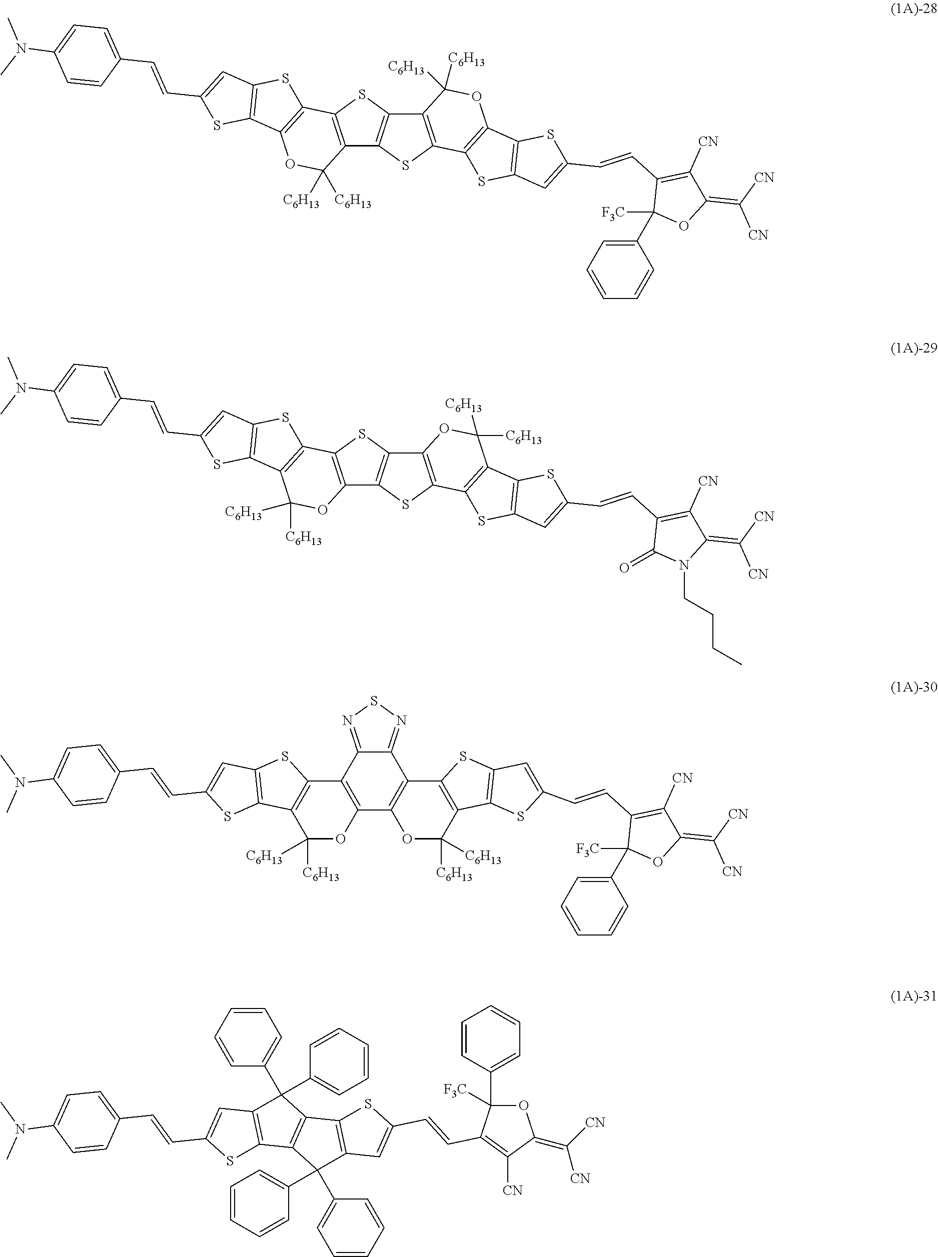

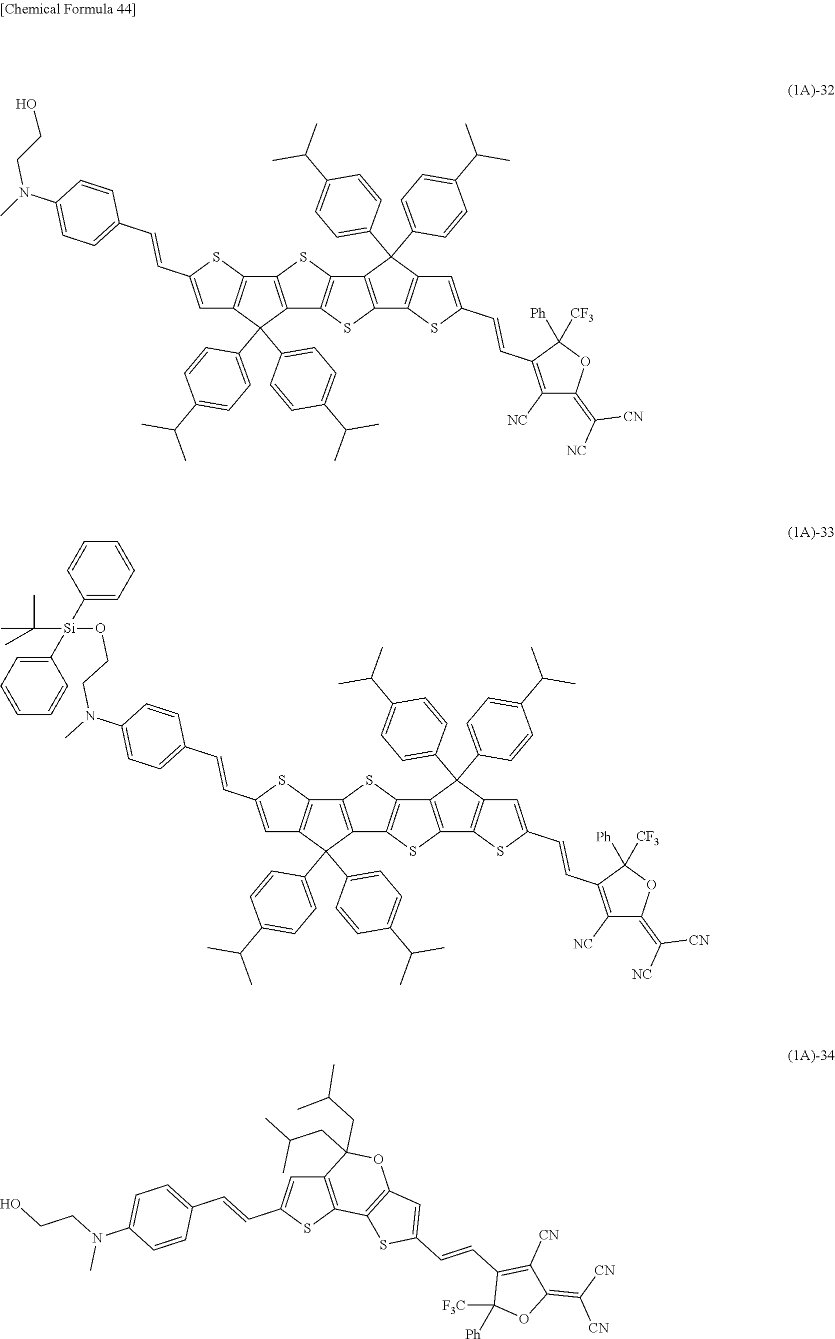

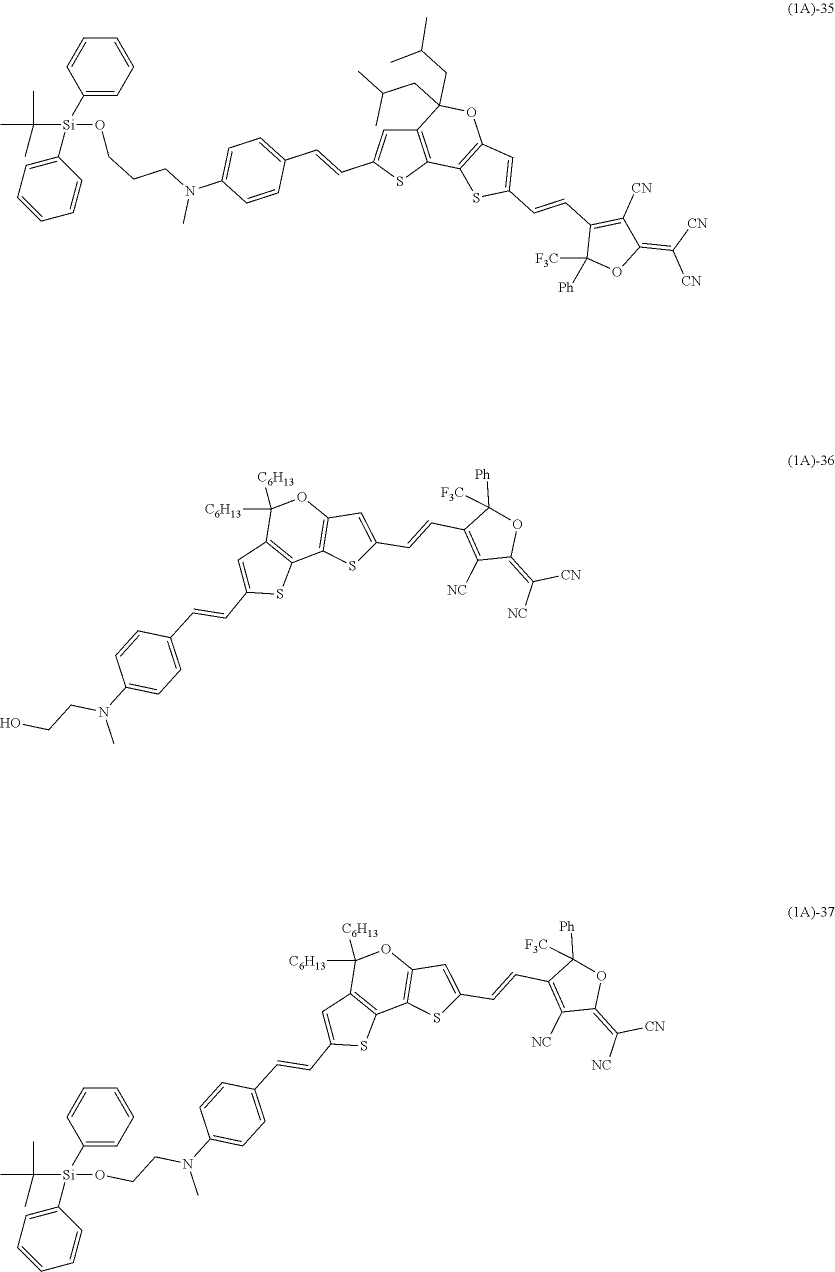

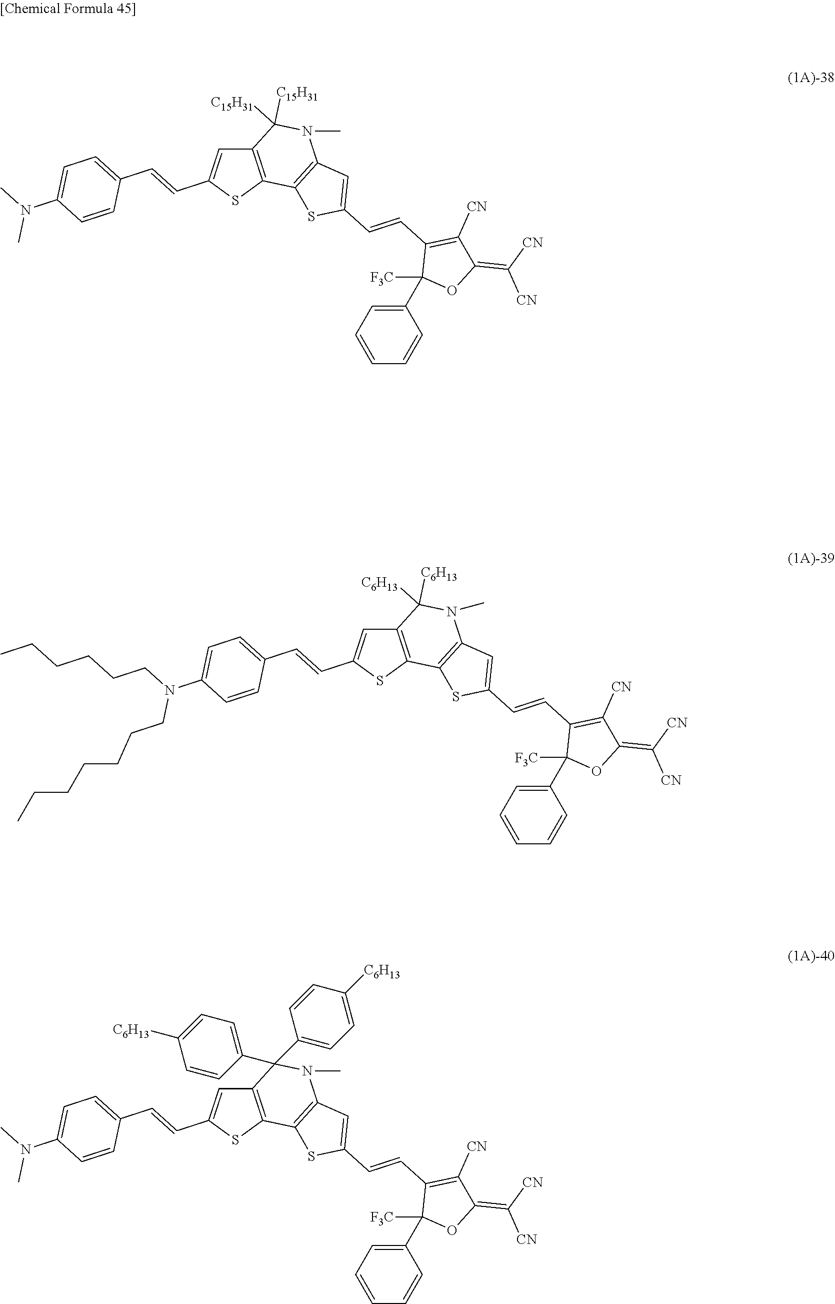

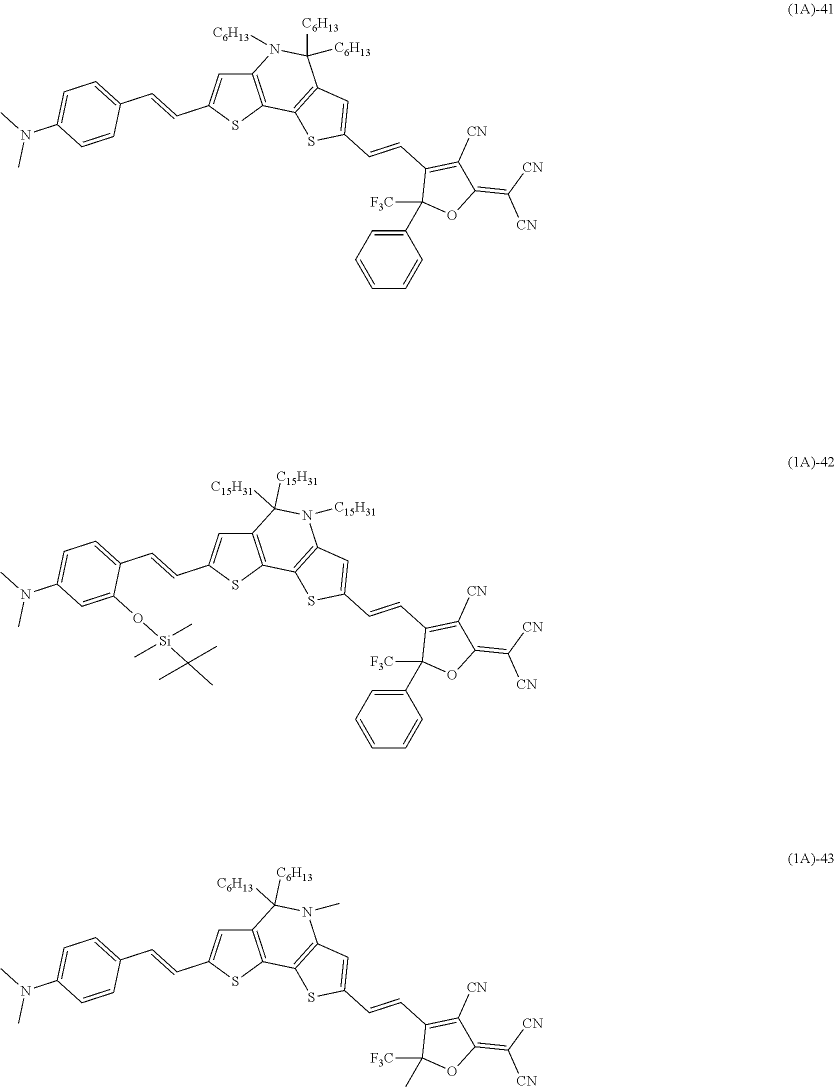

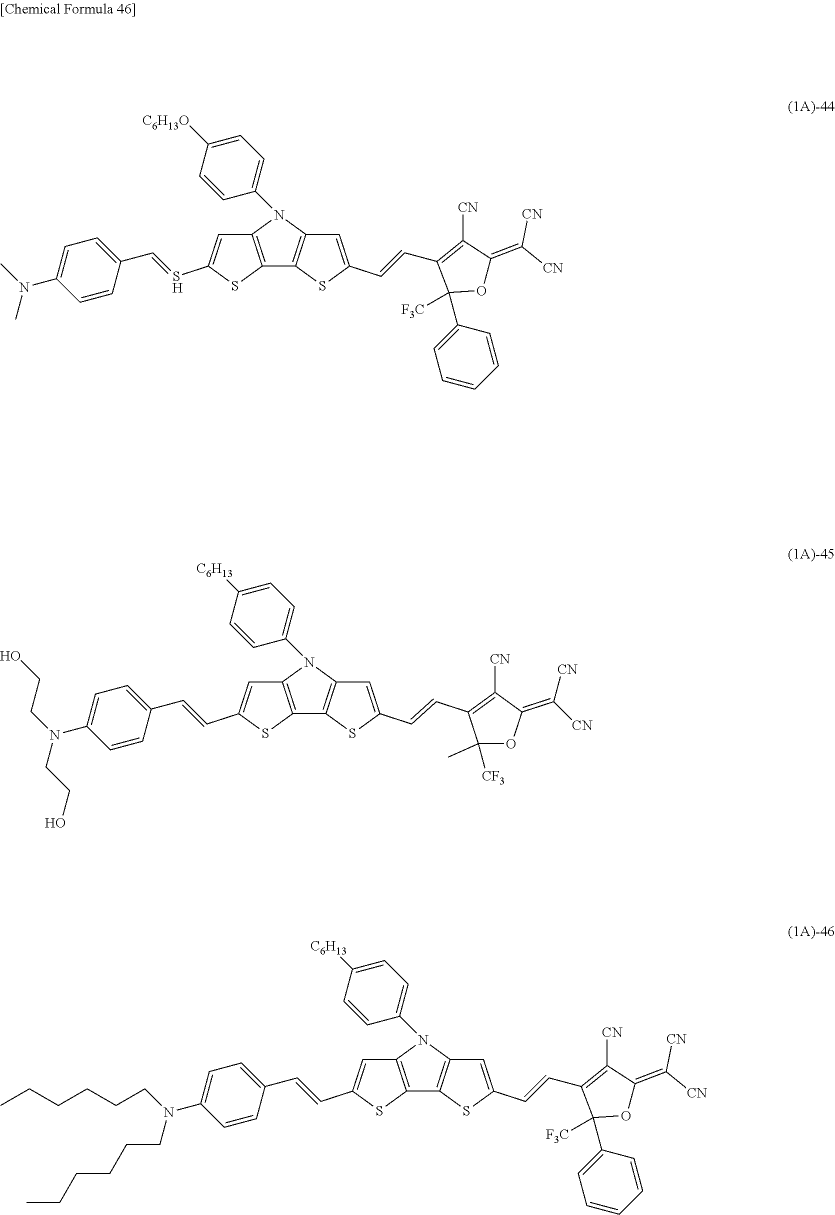

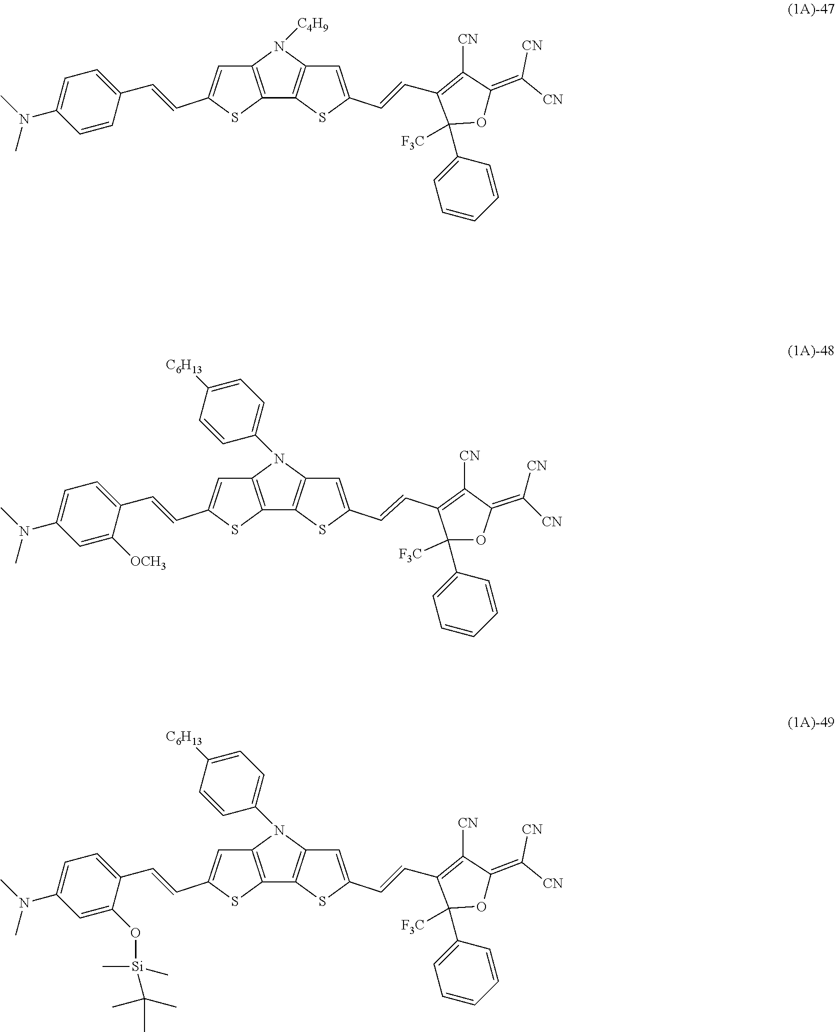

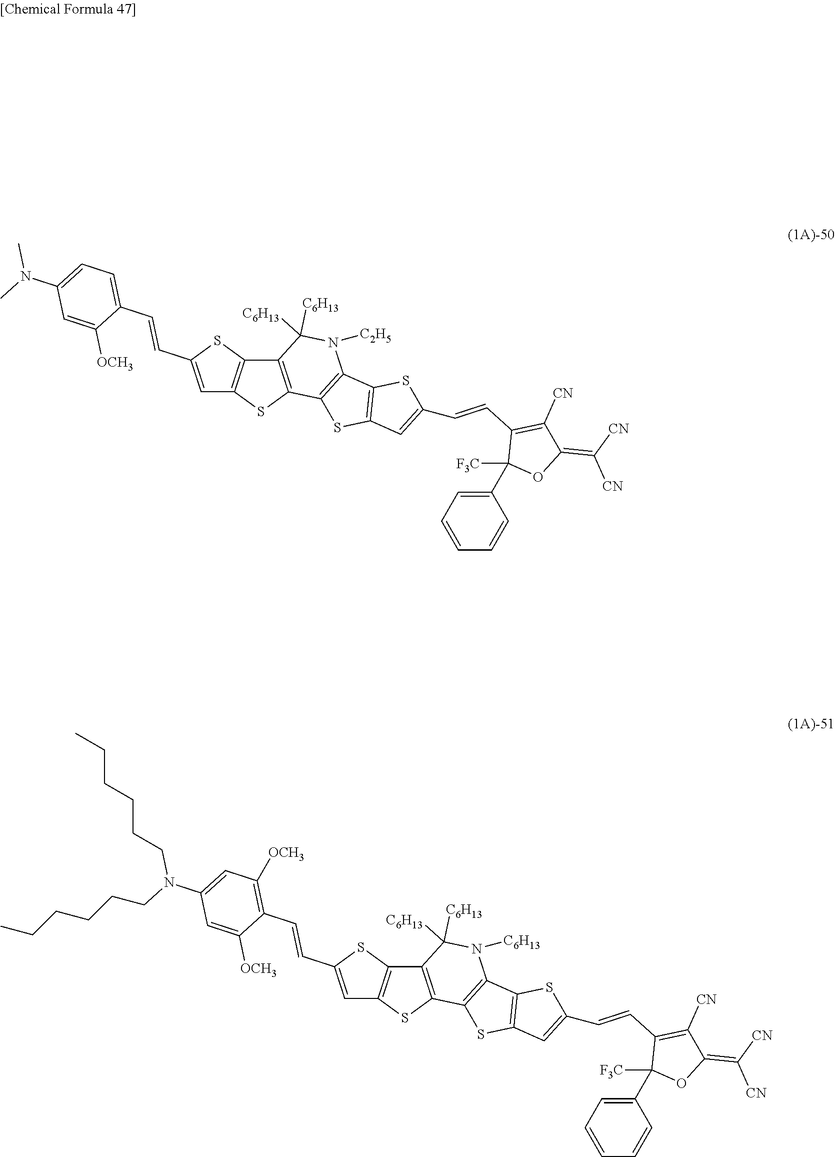

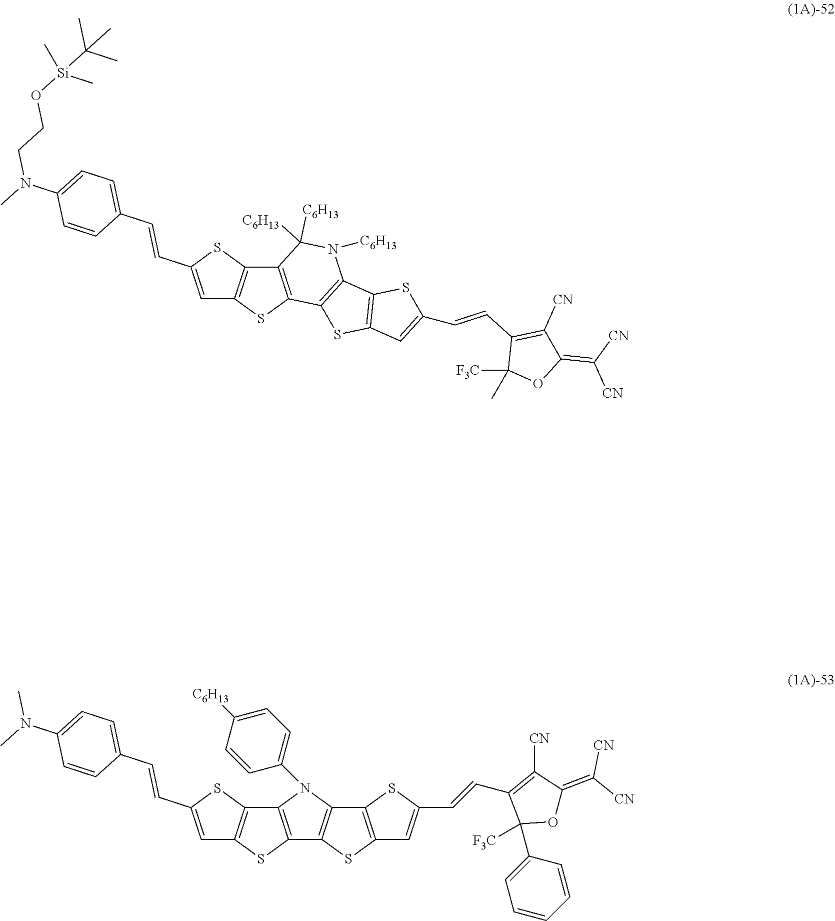

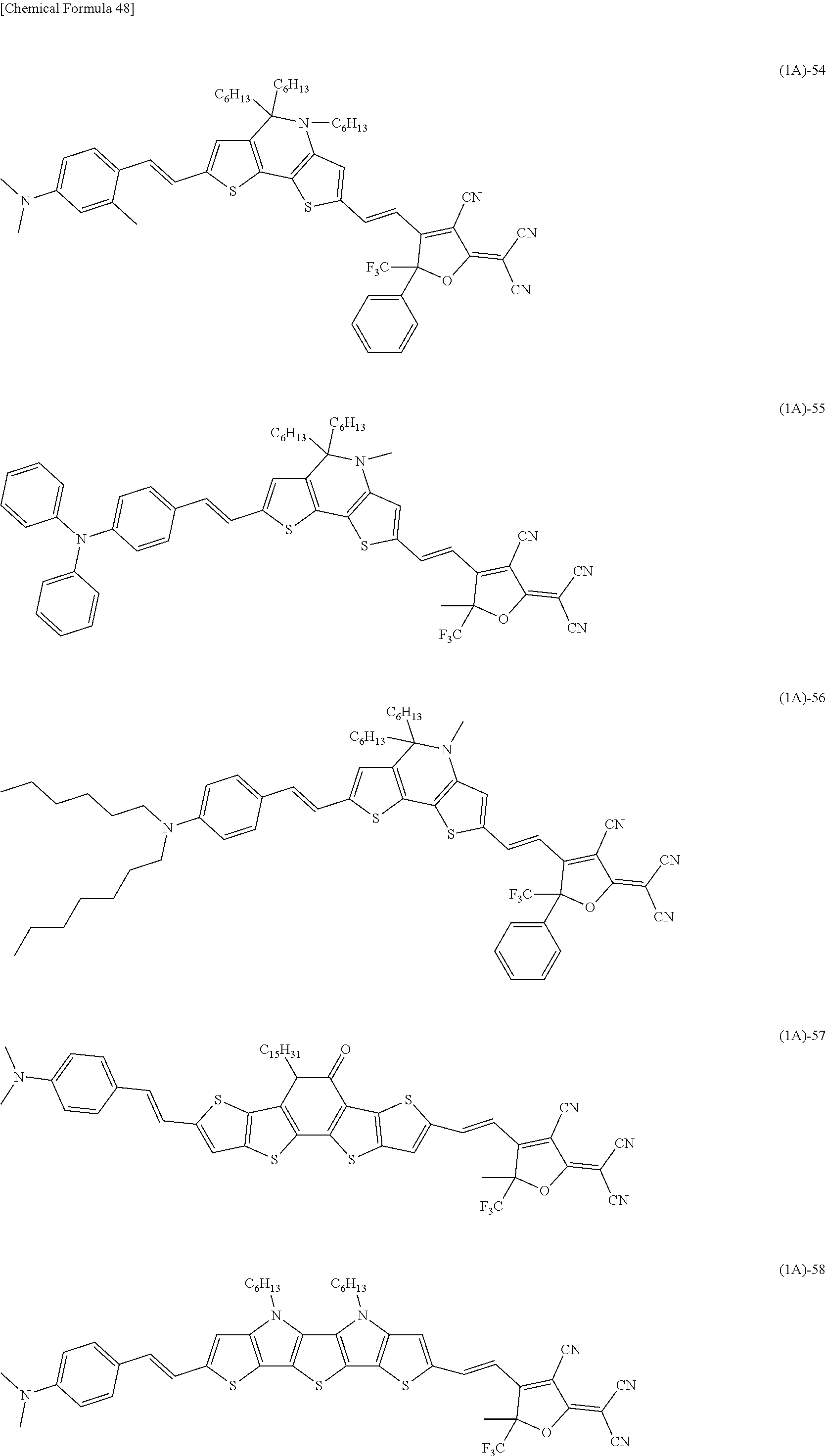

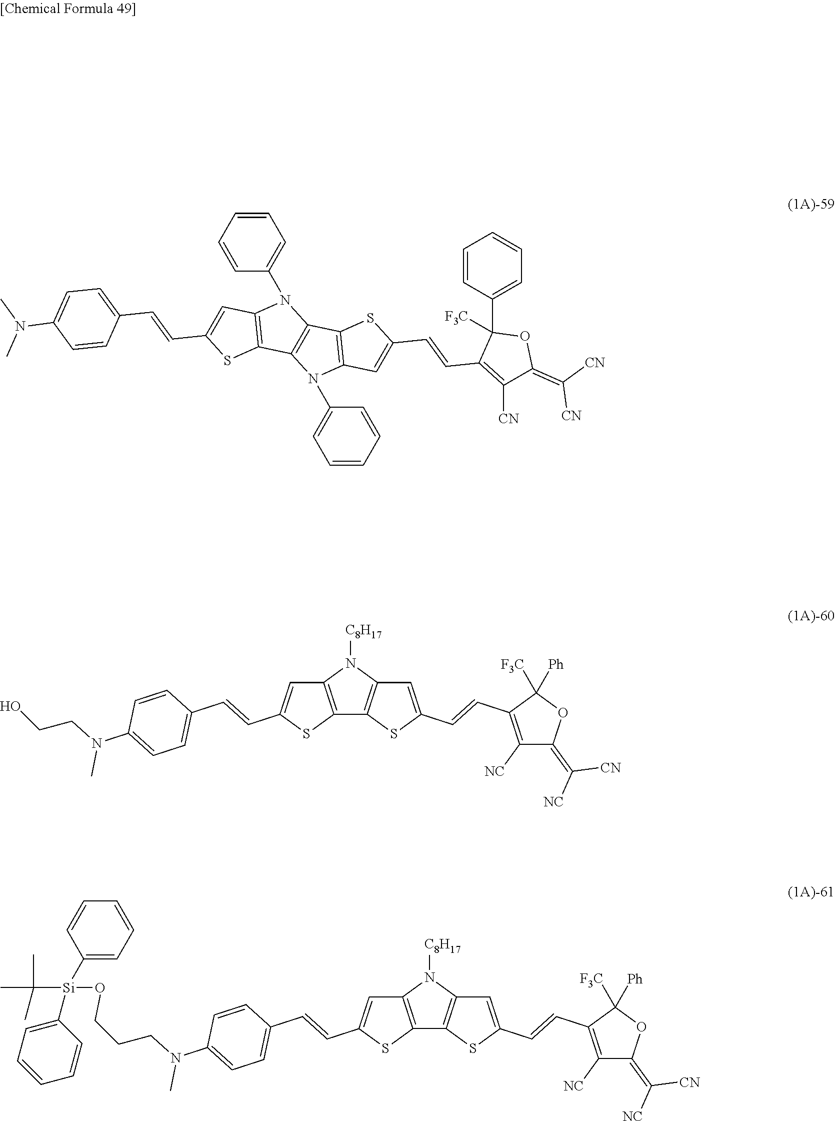

The compound represented by formula (1A) is preferably a compound represented by any one of formulas (1A)-1 to (1A)-22, (1A)-31 to (1A)-49, (1A)-54 to (1A)-56, and (1A)-59 to (1A)-61 from a viewpoint of easily obtaining desired EO characteristics.

The compound of the present embodiment (for example, the compound represented by formula (1A), a compound represented by formula (1B) described later, or a compound represented by formula (1C) described later) may have a cis-trans isomer. In the compound of the present embodiment, generation of a trans isomer tends to be dominant, but any one of a cis isomer, a trans isomer, and a cis-trans isomer mixture can be used. Among these, the compound of the present embodiment is preferably a trans isomer from a viewpoint of easily ensuring a polarizability.

### <Compound Represented by Formula (1B)>

Similarly to the compound represented by formula (1A), the compound represented by formula (1B) has a structure in which an electron-donating group (group having a donor structure) and an electron-withdrawing group (group having an acceptor structure) are linked by a predetermined linking group, and is used as an organic EO material.

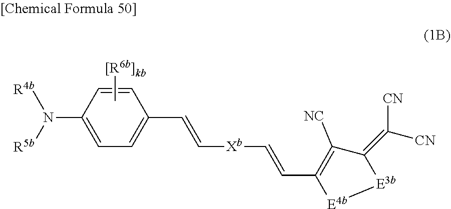

In formula (1B), X^{b} represents a divalent polycyclic condensed ring group having one or two thienothiophene rings, having at least one selected from the group consisting of an sp3 carbon atom and a silicon atom as a constituent element, and not containing a benzene ring, and the number of rings in the entire condensed ring of the divalent polycyclic condensed ring group is 4 to 10. The divalent polycyclic condensed ring group may have a substituent. The divalent polycyclic condensed ring group as X^{b} is similar to the divalent polycyclic condensed ring group in X¹(X^{AA}) except that the divalent polycyclic condensed ring group as X^{b} has one or two thienothiophene rings, has at least one selected from the group consisting of an sp3 carbon atom and a silicon atom as a constituent element, does not contain a benzene ring, and the number of rings in the entire condensed rings is 4 to 10. Therefore, redundant description will be omitted here.

Examples of the divalent polycyclic condensed ring group as X^{b} include a condensed ring group having one or two thienothiophene rings, having at least one selected from the group consisting of an sp3 carbon atom and a silicon atom as a constituent element, not containing a benzene ring, and having 4 to 10 rings in the entire condensed ring in the divalent polycyclic condensed ring group in X¹(X^{AA})). Specific examples thereof include groups represented by the above formulas (X-13) to (X-15), (X-19), (X-23), (X-25), (X-36), and (X-40).

E^{3b} and E^{4b} each independently represent —C(R^{11b})(R^{12b})—, —C(O)—, —O—, or —NR^{13b}—. Note that at least one of E^{3b} and E^{4b} is —O— or —NR^{13b}—.

R^{11b} and R^{12b} each independently represent a hydrogen atom, an alkyl group, or an aryl group.

R^{13b} represents a hydrogen atom or an alkyl group.

R^{4b} and R^{5b} each independently represent an alkyl group, a haloalkyl group, an acyloxyalkyl group, a trialkylsilyloxyalkyl group, an aryldialkylsilyloxyalkyl group, an alkyldiarylsilyloxyalkyl group, an aryl group, —R^{41b}—OH (R^{41b} represents a divalent hydrocarbon group), —R^{42b}—NH₂ (R^{42b} represents a divalent hydrocarbon group), —R^{43b}—SH (R^{43b} represents a divalent hydrocarbon group), or —R^{44b}—NCO (R^{44b} represents a divalent hydrocarbon group). These groups may each have a crosslinkable group. R^{4b} and R^{5b} may be bonded to each other to form a ring together with atoms to which R^{4b} and R^{5b} are bonded.

R^{6b} represents an alkyl group, an alkyloxy group, an aryl group, an aryloxy group, an aralkyloxy group, a trialkylsilyloxyalkyl group, an aryldialkylsilyloxyalkyl group, an alkyldiarylsilyloxyalkyl group, an alkenyloxy group, an alkynyloxy group, a hydroxy group, an amino group, a sulfanyl group, an isocyanate group, —R^{61b}—OH (R^{61b} represents a divalent hydrocarbon group), —O—R^{62b}—OH (R^{62b} represents a divalent hydrocarbon group), —R^{63b}—NH₂ (R^{63b} represents a divalent hydrocarbon group), —R^{64b}—SH (R^{64b} represents a divalent hydrocarbon group), —R^{65b}—NCO (R^{65b} represents a divalent hydrocarbon group), or —OC(═O)R^{66b}(R^{66b} represents a monovalent hydrocarbon group). These groups may each have a crosslinkable group. When there are a plurality of R^{6b}s, R^{6b}s may be the same as or different from each other. R^{6b} may be bonded to R^{4b} or R^{5b} to form a ring together with atoms to which R^{6b} and R^{4b} or R^{5b} are bonded.

kb represents an integer of 0 to 4.

E^{3b}, E^{4b}, R^{11b}, R^{12b}, R^{13b}, R^{4b}, R^{5b}, R^{41b}, R^{42b}, R^{43b}, R^{44b}, R^{6b}, R^{61b}, R^{62b}, R^{63b}, R^{64b}, R^{65b}, R^{66b}, and kb in formula (1B) have the same meaning as E¹, E², R¹, R², R³, R⁴, R⁵, R⁴¹, R⁴², R⁴³, R⁴⁴, R⁶, R⁶¹, R⁶², R⁶³, R⁶⁴, R⁶⁵, R⁶⁶, and k in formula (a1) and formula (d1), respectively. Therefore, redundant description will be omitted here.

### <Compound Represented by Formula (1C)>

Similarly to the compound represented by formula (1A), the compound represented by formula (1C) has a structure in which an electron-donating group (group having a donor structure) and an electron-withdrawing group (group having an acceptor structure) are linked by a predetermined linking group, and is used as an organic EO material.

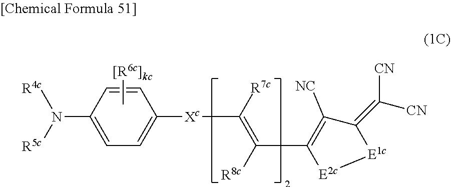

In formula (1C), X^{c} represents a divalent polycyclic condensed ring group having two or more thiophene rings or a heteroarylene group having two or more thiophene rings, and the divalent polycyclic condensed ring group and the heteroarylene group may each have a substituent.

Examples of the heteroarylene group as X^{c} include a group obtained by removing two hydrogen atoms directly bonded to carbon atoms constituting a ring from thienothiophene (a group represented by the following formula, * represents a bonding position.).

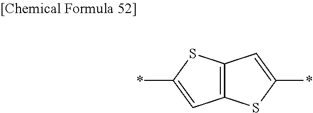 [SMILES: *c1cc2sc(*)cc2s1]

Examples of the divalent polycyclic condensed ring group as X^{c} include groups represented by formulas (X-1) to (X-40) in X¹(X^{AA}).

E^{1C} and E^{2C} each independently represent —C(R^{1C})(R^{2C})—, —C(O)—, —O—, or —NR^{3C}—. Note that at least one of E^{1C} and E^{2C} is —O— or —NR^{a}—.

R^{1C} and R^{2C} each independently represent a hydrogen atom, an alkyl group, a haloalkyl group, an aryl group, or a haloaryl group. Note that at least one of R^{1C} and R^{2C} is a group containing a halogen atom.

R^{3C} represents a hydrogen atom or an alkyl group.

R^{4C} and R^{5C} each independently represent an alkyl group, a haloalkyl group, an acyloxyalkyl group, a trialkylsilyloxyalkyl group, an aryldialkylsilyloxyalkyl group, an alkyldiarylsilyloxyalkyl group, an aryl group, —R^{41C}—OH (R^{41C} represents a divalent hydrocarbon group), —R^{42C}—NH₂ (R^{42C} represents a divalent hydrocarbon group), —R^{43C}—SH (R^{43C} represents a divalent hydrocarbon group), or —R^{44C}—NCO (R^{44C} represents a divalent hydrocarbon group). These groups may each have a crosslinkable group. R^{4C} and R^{5C} may be bonded to each other to form a ring together with atoms to which R^{4C} and R^{5C} are bonded.

R^{6C} represents an alkyl group, an alkyloxy group, an aryl group, an aryloxy group, an aralkyloxy group, a trialkylsilyloxyalkyl group, an aryldialkylsilyloxyalkyl group, an alkyldiarylsilyloxyalkyl group, an alkenyloxy group, an alkynyloxy group, a hydroxy group, an amino group, a sulfanyl group, an isocyanate group, —R^{61C}—OH (R^{61C} represents a divalent hydrocarbon group), —O—R^{62C}—OH (R^{62C} represents a divalent hydrocarbon group), —R^{63C}—NH₂ (R^{63C} represents a divalent hydrocarbon group), —R^{64C}—SH (R^{64C} represents a divalent hydrocarbon group), —R^{65C}—NCO (R^{65C} represents a divalent hydrocarbon group), or —OC(═O)R^{66C} (R^{66C} represents a monovalent hydrocarbon group). These groups may each have a crosslinkable group. When there are a plurality of R^{6C}s, R^{6C}s may be the same as or different from each other. R^{6C} may be bonded to R^{4C} or R^{5C} to form a ring together with atoms to which R^{6C} and R^{4C} or R^{5C} are bonded.

kc represents an integer of 0 to 4.

R^{7c} and R^{8c} each independently represent a hydrogen atom, an alkyl group, or an aryl group. The alkyl group and the aryl group as each of R^{7c} and R^{8c} may be similar to the alkyl group and the aryl group exemplified for R¹ and R². R^{7c} and R^{8c} are preferably aryl groups because desired electro-optic characteristics are easily obtained. R^{7c} and R^{8c} are preferably hydrogen atoms from a viewpoint of synthesis.

E^{1C}, E^{2C}, R^{1C}, R^{2C}, R^{3C}, R^{4C}, R^{5C}, R^{41C}, R^{42C}, R^{43C}, R^{44C}, R^{6C}, R^{61C}, R^{62C}, R^{63C}, R^{64C}, R^{65C}, R^{66C}, and kc in formula (1C) have the same meaning as E¹, E², R¹, R², R³, R⁴, R⁵, R⁴¹, R⁴², R⁴³, R⁴⁴, R⁶, R⁶¹, R⁶², R⁶³, R⁶⁴, R⁶⁵, R⁶⁶, and k in formula (a1) and formula (d1), respectively. Therefore, redundant description will be omitted here.

Examples of the compound represented by formula (1C) include compounds represented by formulas (1C)-1 to (1C)-27. These groups may each further have a substituent.

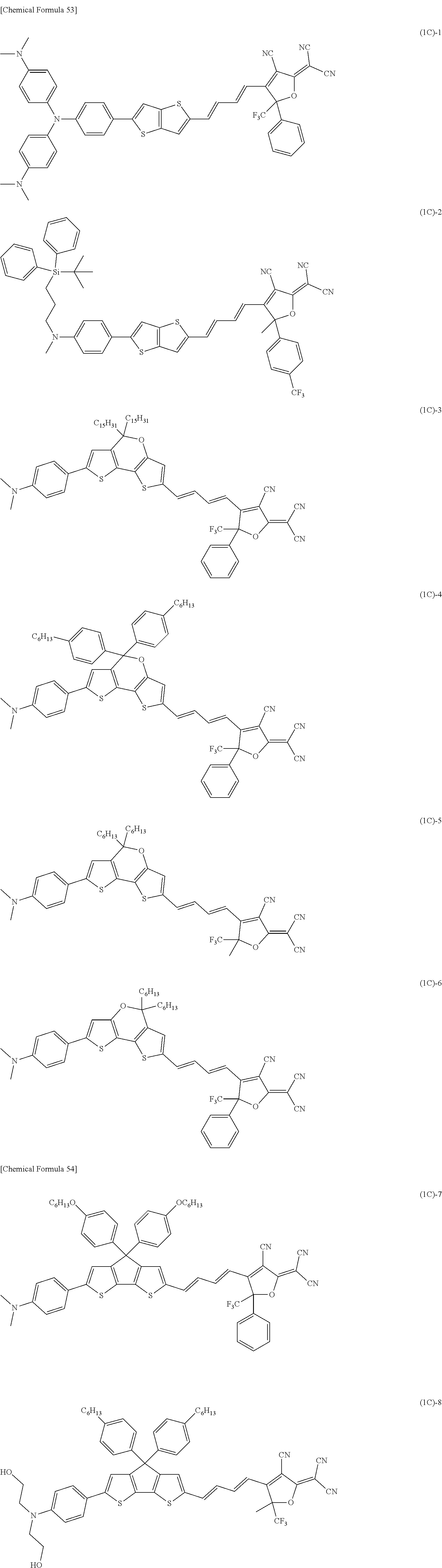

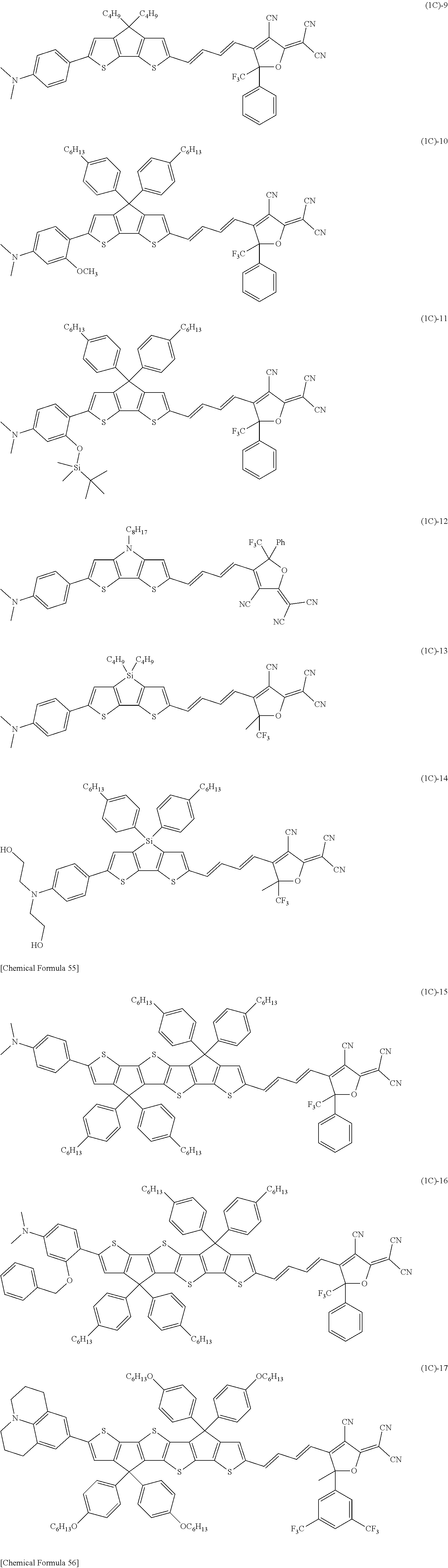

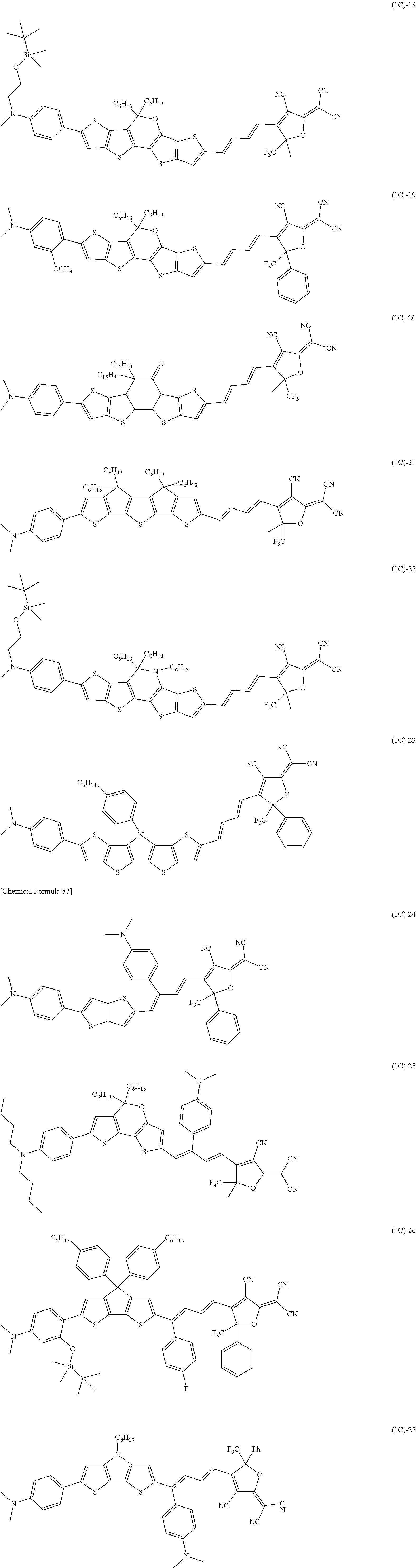

The compound represented by formula (1C) is preferably a compound represented by any one of formulas (1C)-1 to (1C)-19, (1C)-24, (1C)-25, and (1C)-27 from a viewpoint of easily obtaining desired EO characteristics.

### [Electro-Optic Ink Composition]

In another aspect, the EO ink composition of the present embodiment contains at least one selected from the group consisting of a compound represented by formula (1A) and a compound represented by formula (1B). The EO ink composition may further contain an organic solvent. The organic solvent is preferably one that can dissolve or uniformly disperse at least one selected from the group consisting of the compound represented by formula (1A) and the compound represented by formula (1B). Examples of the organic solvent include monoalcohols; glycols; cyclic ethers; glycol monoethers; glycol ethers; esters of a glycol monoether (for example, propylene glycol monomethyl ether acetate); alkyl esters; ketones; aromatic hydrocarbons; halogenated aromatic hydrocarbons; aliphatic hydrocarbons; and amides. The organic solvent may be an organic solvent having a boiling point of 120° C. or higher and a dipole moment of less than 3.0 debye.

The content of the organic solvent is not particularly limited, but is preferably 200 to 200,000 parts by mass, more preferably 300 to 20,000 parts by mass, and still more preferably 400 to 10,000 parts by mass with respect to 100 parts by mass of the total amount of the compound represented by formula (1A) and the compound represented by formula (1B) from a viewpoint of coatability.

The EO ink composition may further contain an amorphous resin. As the amorphous resin, those similar to the above amorphous resin are exemplified.

The content of the amorphous resin is preferably 100 to 50,000 parts by mass, more preferably 150 to 10,000 parts by mass, and still more preferably 200 to 5,000 parts by mass with respect to 100 parts by mass of the total amount of the compound represented by formula (1A) and the compound represented by formula (1B) from a viewpoint of easily dispersing the compound represented by formula (1A) and the compound represented by formula (1B) in the amorphous resin and easily obtaining a homogeneous film.

### EXAMPLES

Hereinafter, the present invention will be described in more detail with reference to Examples, but the present invention is not limited to these Examples.

### 1. Synthesis of Compound

### (Example 1-1) Synthesis of compound (1)

In order to synthesize a compound (1), a compound (1-a) was formylated to synthesize a compound (1-b). Subsequently, a compound (1-c) was synthesized from the compound (1-b) by Wittig reaction. Subsequently, the compound (1) was synthesized from the compound (1-c) by aldol condensation.

### Synthesis of Compound (1-b)

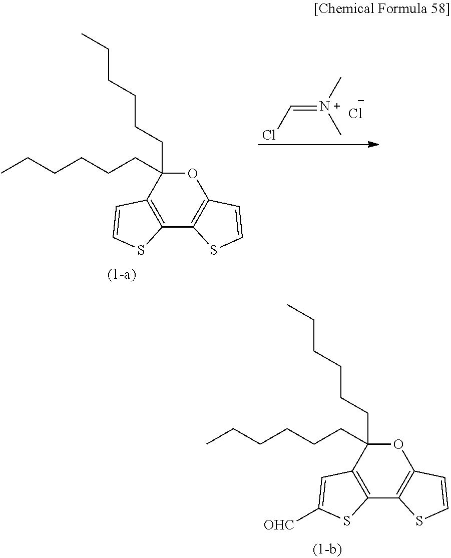

The compound (1-a) was synthesized by a method described in WO-A-2013/047858. Into a 100 mL three-necked flask equipped with a three-way cock, 4.00 g (11.0 mmol) of the compound (1-a) and 40 mL of chloroform (manufactured by FUJIFILM Wako Pure Chemical Corporation) were put. A stirrer was further put thereinto, and the inside was replaced with nitrogen. At room temperature (25° C., the same hereinafter), 1.69 g (13.2 mmol) of a Vilsmeir reagent (manufactured by Tokyo Chemical Industry Co., Ltd.) was added thereto in three portions while the reaction mixture was stirred with a magnetic stirrer. After completion of the addition, the resulting mixture was further stirred for one hour to be caused to react. After completion of the reaction, 40 mL of brine was added thereto to quench the reaction. The organic layer was separated, then further washed with 40 mL of brine, and then dried over anhydrous magnesium sulfate. The insoluble matter was separated by filtration. The filtrate was concentrated by a rotary evaporator. The obtained concentrate was purified with a silica gel column to obtain the compound (1-b). The obtained amount was 3.34 g (yield: 82%). A measurement result of an ¹H-NMR spectrum of the compound (1-b) is as follows.

¹H-NMR (400 MHz, CDCl₃): δ (ppm)=9.78 (s, 1H), 7.65-7.58 (m, 4H), 7.17 (d, 1H), 6.67 (d, 1H), 1.95-1.80 (m, 4H), 1.42-1.18 (m, 16H), 0.86-0.81 (m, 6H).

### Synthesis of Compound (1A-b)

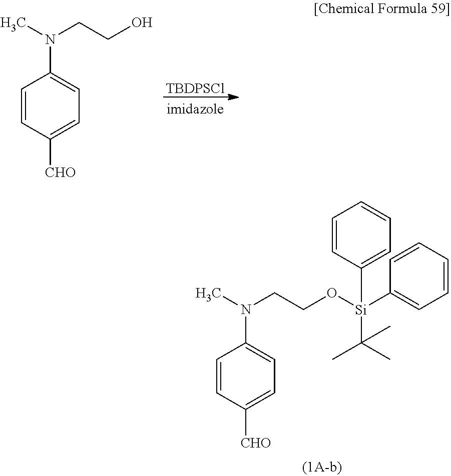

Into a 1 L three-necked flask equipped with a Dimroth with a three-way cock at a top, a 300 mL equilibrium type dropping funnel, and an induction stirrer, 20.00 g (111.6 mmol) of N-methyl-N-(2-hydroxyethyl)-4-aminobenzaldehyde (manufactured by Aldrich), 15.19 g (117.2 mmol) of imidazole (manufactured by Tokyo Chemical Industry Co., Ltd.), and 350 mL of dehydrated tetrahydrofuran (manufactured by FUJIFILM Wako Pure Chemical Corporation) (THF) were put, and the inside was replaced with nitrogen. A solution prepared by dissolving 17.66 g of t-butyldiphenylchlorosilane (TBDPSCl, manufactured by Tokyo Chemical Industry Co., Ltd., hereinafter, a tert-butyldiphenylsilyl group is also referred to as “TBDPS”.) in 150 mL of dehydrated THF was added to the dropping funnel. The flask was immersed in an ice bath and cooled while the reaction mixture was stirred with a mechanical stirrer. The THF solution of TBDPSCl was slowly added from the dropping funnel over 30 minutes. After completion of the dropwise addition, the mixture was caused to react in the ice bath for 30 minutes, then the ice bath was removed. The mixture was further caused to react at room temperature for one hour, then the flask was immersed in an oil bath at 65° C., and the mixture was further caused to react for four hours. After completion of the reaction, the temperature of the reaction mixture was returned to room temperature, and then the reaction mixture was transferred to a 1 L eggplant flask, and concentrated and dried by a rotary evaporator. To the obtained solid, 200 mL of hexane and 200 mL of deionized water were added, and a product was extracted. The organic layer was separated and further washed three times with 100 mL of deionized water. After washing, the organic layer was dried over anhydrous magnesium sulfate. Thereafter, the insoluble matter was separated by filtration, and the filtrate was concentrated and dried by a rotary evaporator to obtain a compound (1A-b) as a viscous liquid. The obtained amount was 45.20 g (yield: 99%). A measurement result of an ¹H-NMR spectrum of the compound (1A-b) is as follows.

¹H-NMR (400 MHz, CDCl₃): δ (ppm)=9.71 (s, 1H), 7.66-7.62 (m, 2H), 7.61-7.58 (m, 4H), 7.44-7.38 (m, 2H), 7.36-7.31 (m, H), 6.58-6.54 (m, 2H), 3.81 (t, 2H), 3.55 (t, 2H), 3.03 (s, 3H), 1.01 (s, 9H).

### Synthesis of Compound (1A-c)

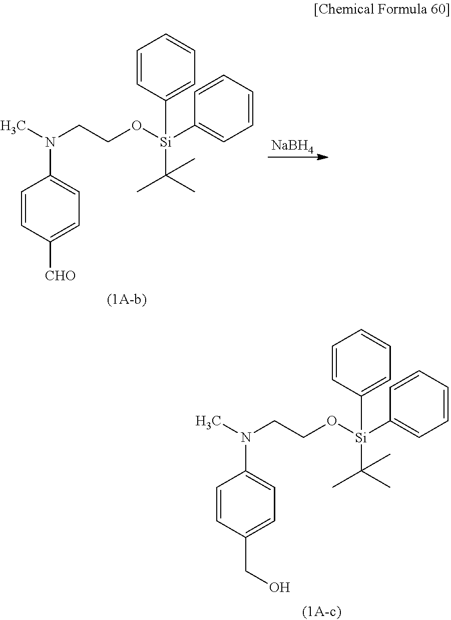

Into a 500 mL three-necked flask equipped with a three-way cock, 10.00 g (24.42 mmol) of the compound (1A-b) and 150 mL of dehydrated methanol (manufactured by FUJIFILM Wako Pure Chemical Corporation) were put. A stirrer was further put thereinto, and the inside was replaced with nitrogen. The flask was immersed in an ice bath, and 1.11 g (29.30 mmol) of sodium borohydride (manufactured by Tokyo Chemical Industry Co., Ltd.) was added thereto in three portions while the reaction mixture was stirred with a magnetic stirrer. After completion of the addition, the mixture was stirred in the ice bath for 30 minutes to be caused to react. Thereafter, the ice bath was removed, and the mixture was further stirred at room temperature for six hours to be caused to react. After completion of the reaction, 1 N hydrochloric acid was added thereto to make the mixture acidic, and the mixture was stirred at room temperature for two hours. After neutralization with a saturated sodium bicarbonate aqueous solution, the reaction mixture was transferred to a 1 L eggplant flask, and concentrated by a rotary evaporator. To the obtained slurry, 300 mL of ethyl acetate and 200 mL of deionized water were added, and a product was extracted. The contents of the eggplant flask were transferred to a 1 L separating funnel to separate the organic layer, and the organic layer was further washed three times with 100 mL of deionized water. After washing, the organic layer was dried over anhydrous magnesium sulfate. Thereafter, the insoluble matter was separated by filtration, and the filtrate was concentrated and dried by a rotary evaporator to obtain a compound (1A-c) as a solid. The obtained amount was 8.54 g (yield: 85%). A measurement result of an ¹H-NMR spectrum of the compound (1A-c) is as follows.

¹H-NMR (400 MHz, CDCl₃): δ (ppm)=7.65-7.62 (m, 4H), 7.44-7.37 (m, 2H), 7.37-7.32 (m, 4H), 7.14 (d, 2H), 6.53 (d, 2H), 4.53 (d, 2H), 3.78 (t, 2H), 3.46 (t, 2H), 2.93 (s, 3H), 1.34 (m, 1H), 1.03 (s, 9H).

### Synthesis of Compound (1A-d)

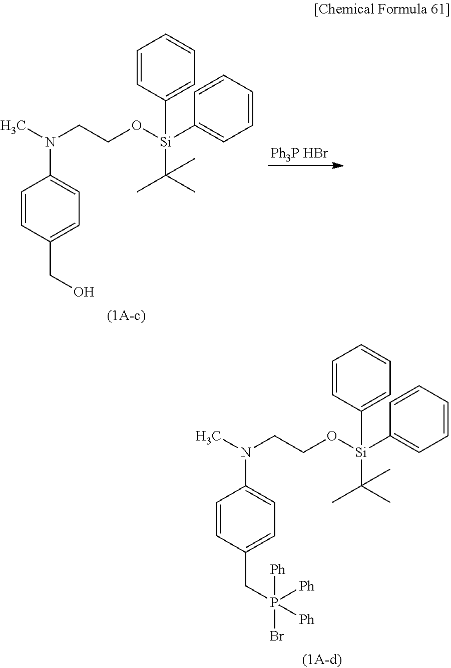

Into a 1 L three-necked flask equipped with a Dimroth with a three-way cock at a top, 25.00 g (59.57 mmol) of the compound (1A-c), 24.54 g (71.49 mmol) of triphenylphophine hydrobromide (manufactured by Tokyo Chemical Industry Co., Ltd.), and 500 mL of dehydrated chloroform (manufactured by KANTO CHEMICAL CO., INC.) were put. A stirrer was further put thereinto, and the inside was replaced with nitrogen. The flask was immersed in an oil bath at 70° C., and reaction was caused for three hours under reflux. After completion of the reaction, the reaction mixture was cooled to room temperature, then transferred to a 1 L eggplant flask, and concentrated and dried by a rotary evaporator. The obtained dried product was washed with diethyl ether, and then vacuum-dried to obtain a desired compound (1A-d) as a solid. The obtained amount was 43.93 g (yield: 99%). A measurement result of an ¹H-NMR spectrum of the compound (1A-d) is as follows.

¹H-NMR (400 MHz, CDCl₃): δ (ppm)=7.76-7.67 (m, 9H), 7.63-7.55 (m, 10H), 7.42-7.36 (m, 2H), 7.35-7.29 (m, 4H), 6.78 (d, 2H), 6.29 (br, 2H), 5.14 (d, 2H), 3.71 (br, 2H), 3.38 (t, 2H), 2.85 (brs, 3H), 1.01 (s, 9H).

### Synthesis of Compound (1-c)

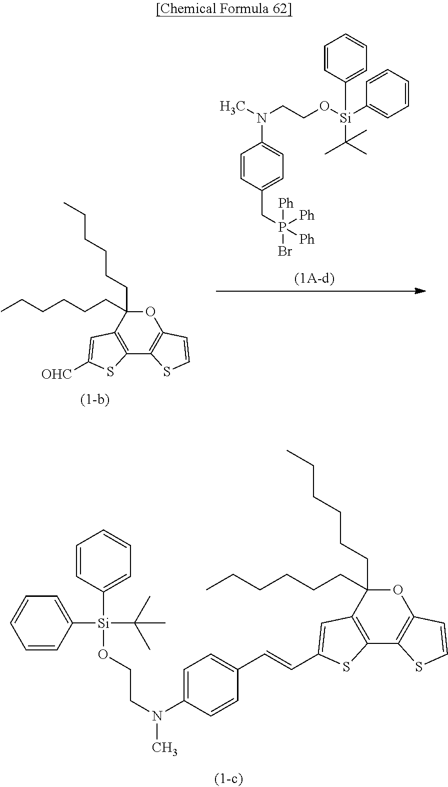 [SMILES: CCCCCCC1(CCCCCC)Oc2ccsc2-c2sc(C=O)cc21 ; CN(CCO[Si](c1ccccc1)(c1ccccc1)C(C)(C)C)c1ccc(CP(Br)(c2ccccc2)(c2ccccc2)c2ccccc2)cc1 ; CCCCCCC1(CCCCCC)Oc2ccsc2-c2sc(/C=C/c3ccc(N(C)CCO[Si](c4ccccc4)(c4ccccc4)C(C)(C)C)cc3)cc21]

Into a 500 mL three-necked flask equipped with a three-way cock, 3.13 g (8.01 mmol) of the compound (1-b), 6.67 g (8.81 mmol) of the compound (1A-d), and 200 mL of dehydrated tetrahydrofuran (manufactured by FUJIFILM Wako Pure Chemical Corporation) (THF) were put. A stirrer was further put thereinto, and the inside was replaced with nitrogen. The flask was immersed in an ice bath and cooled while the reaction mixture was stirred with a mechanical stirrer. Thereafter, 1.17 g (10.42 mmol) of potassium t-butoxide (manufactured by Tokyo Chemical Industry Co., Ltd.) was added thereto, and the mixture was caused to react for five minutes. The ice bath was removed, and the reaction mixture was heated to room temperature and further caused to react for two hours. After completion of the reaction, 480 mL of toluene was added thereto, the mixture was washed with deionized water, and then the organic layer was dried over magnesium sulfate. The insoluble matter was separated by filtration. Thereafter, the filtrate was transferred to an eggplant flask and concentrated by a rotary evaporator to obtain a compound (1-c) as a viscous liquid. The obtained amount was 9.91 g (yield: 159%).

### Synthesis of Compound (1-d)

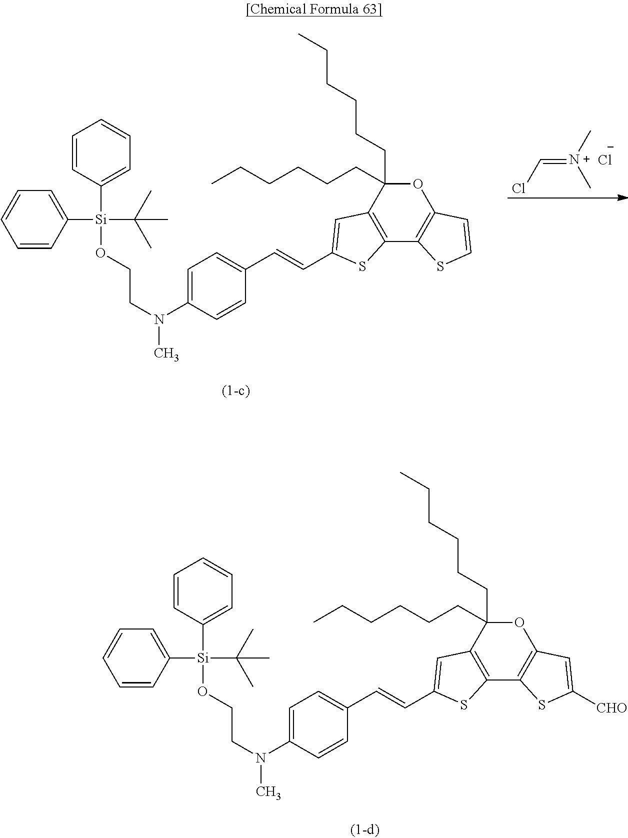

Into a 500 mL three-necked flask equipped with a Dimroth with a three-way cock at a top, 9.81 g (20.03 mmol) of the compound (1-c) and 98 mL of chloroform (manufactured by FUJIFILM Wako Pure Chemical Corporation) were put. A stirrer was further put thereinto, and the inside was replaced with nitrogen. The flask was immersed in an ice bath and cooled while the reaction mixture was stirred with a magnetic stirrer. 3.88 g (30.34 mmol) of a Vilsmeir reagent (manufactured by Tokyo Chemical Industry Co., Ltd.) was added thereto in two portions. After completion of the addition, the resulting mixture was further stirred for one hour to be caused to react. After completion of the reaction, 40 mL of brine was added thereto to quench the reaction. The organic layer was separated, then further washed with 40 mL of brine, and then dried over anhydrous magnesium sulfate. The insoluble matter was separated by filtration. The filtrate was concentrated by a rotary evaporator. The obtained concentrate was purified with a reverse phase silica gel column (mobile phase, methanol:ethyl acetate=80:20) to obtain a compound (1-d). The obtained amount was 3.30 g (yield: 32%). A measurement result of an ¹H-NMR spectrum of the compound (1-d) is as follows.

¹H-NMR (400 MHz, CDCl₃): δ (ppm)=9.73 (s, 1H), 7.66-7.59 (m, 4H), 7.45-7.38 (m, 2H), 7.37-7.31 (m, 4H), 7.26 (d, 2H), 7.24 (s, 1H), 6.93 (d, 1H, J=1.6 Hz), 6.82 (d, 1H, J=1.6 Hz), 6.59 (s, 1H), 6.53 (d, 2H), 3.80 (t, 2H), 3.50 (t, 2H), 2.97 (s, 3H),), 1.96-1.78 (m, 2H), 1.42-1.18 (m, 18H), 1.03 (s, 9H), 0.86-0.81 (m, 6H).

### Synthesis of Compound (1)

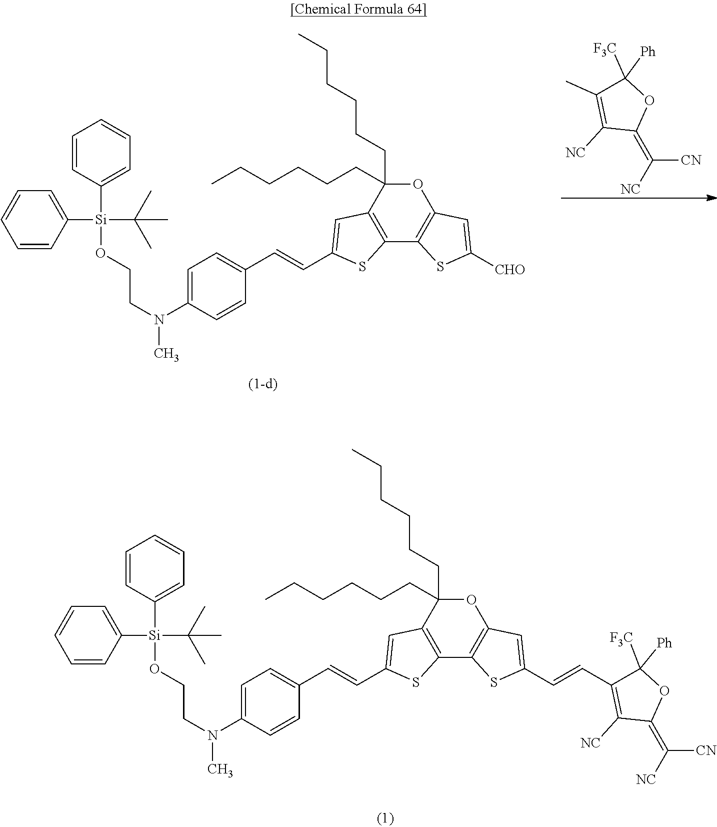 [SMILES: CCCCCCC1(CCCCCC)Oc2cc(C=O)sc2-c2sc(/C=C/c3ccc(N(C)CCO[Si](c4ccccc4)(c4ccccc4)C(C)(C)C)cc3)cc21 ; CC1=C(C#N)C(=C(C#N)C#N)OC1(c1ccccc1)C(F)(F)F ; CCCCCCC1(CCCCCC)Oc2cc(/C=C/C3=C(C#N)C(=C(C#N)C#N)OC3(c3ccccc3)C(F)(F)F)sc2-c2sc(/C=C/c3ccc(N(C)CCO[Si](c4ccccc4)(c4ccccc4)C(C)(C)C)cc3)cc21]

Into a 500 mL eggplant flask equipped with a three-way cock at a top, 2.70 g (3.36 mmol) of the compound (1-d), 1.91 g (6.04 mmol) of 2-(3-cyano-4-methyl-5-phenyl-5-(trifluoromethyl)-2 (5H)-furanylidene) -propanedinitrile (manufactured by iChemical), 41 mL of dehydrated ethanol, and 41 mL of dehydrated chloroform were put. A stirrer was further put thereinto, and the inside was replaced with nitrogen. Reaction was caused at room temperature for 24 hours while the reaction mixture was stirred with a magnetic stirrer. After completion of the reaction, the reaction mixture was concentrated by a rotary evaporator. To the concentrate, 150 mL of methanol was added, and the precipitate was separated by filtration. The obtained product was washed with 17 mL of ethyl acetate and 75 mL of ethanol to obtain the compound (1) as a red-brown solid. The obtained amount was 3.75 g (yield: 101%). A measurement result of an ¹H-NMR spectrum of the compound (1) is as follows.

¹H-NMR (400 MHz, CDCl₃): δ (ppm)=7.68 (d, 1H, J=15.2 Hz), 7.65-7.59 (m, 4H), 7.54-7.47 (m, 5H), 7.45-7.38 (m, 2H), 7.37-7.31 (m, 4H), 7.26 (d, 2H), 6.92 (s, 1H), 6.91 (s, 2H), 6.62 (s, 1H), 6.57 (d, 1H, J=1.5.2 Hz), 6.54 (d, 2H), 3.80 (t, 2H), 3.51 (t, 2H), 2.98 (s, 3H),), 1.96-1.78 (m, 4H), 1.42-1.18 (m, 16H), 1.02 (s, 9H), 0.86-0.81 (m, 6H).

### (Synthesis Example 1): Synthesis of Compound (2)

In order to synthesize a compound (2), the compound (1-a) was brominated to synthesize a compound (2-b). Subsequently, the compound (2-b) was formylated to synthesize a compound (2-c). Subsequently, a compound (2-d) was synthesized from the compound (2-c) by Suzuki coupling, and the compound (2) was synthesized from the compound (2-d) by aldol condensation.

### Synthesis of Compound (2-b)

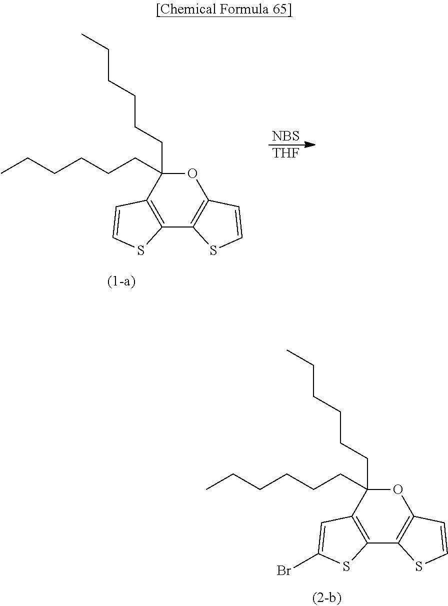 [SMILES: CCCCCCC1(CCCCCC)Oc2ccsc2-c2sccc21 ; "NBS" ; CCCCCCC1(CCCCCC)Oc2ccsc2-c2sc(Br)cc21 ; "THF"]

The compound (2-b) was synthesized by bromination of the compound (1-a). Into a 500 mL three-necked flask equipped with a Dimroth with a three-way cock at a top and a 100 mL equilibrium type dropping funnel, 10.00 g (27.6 mmol) of the compound (1-a) and 100 mL of dehydrated tetrahydrofuran (THF, manufactured by FUJIFILM Wako Pure Chemical Corporation) were put. A stirrer was further put thereinto, and the inside was replaced with nitrogen. Thereafter, the flask containing the reaction mixture was immersed in a dry ice acetone bath, and the reaction mixture was cooled to −40° C. A solution adjusted by dissolving 5.16 g (29.0 mmol) of N-bromosuccinimide (NBS, manufactured by Tokyo Chemical Industry Co., Ltd.) in 50 mL of dehydrated THF was put into the dropping funnel. A THF solution of NBS was slowly added dropwise from the dropping funnel such that the temperature of the reaction mixture did not exceed −40° C. After completion of the dropwise addition, stirring was continued at −40° C. for three hours. Thereafter, the flask was taken out of the dry ice acetone bath and further stirred at room temperature for 16 hours for reaction. After completion of the reaction, the reaction mixture was transferred to a 500 mL eggplant flask and concentrated by a rotary evaporator. 200 mL of chloroform and 200 mL of deionized water were added to the obtained concentrate, the product was extracted, and the organic layer was separated. The obtained organic layer was further washed with 100 mL of deionized water three times, and the separated organic layer was dried over anhydrous magnesium sulfate. Thereafter, the insoluble matter was separated by filtration, and the filtrate was concentrated and dried by a rotary evaporator to obtain the compound (2-b). The obtained amount was 10.93 g (yield: 90%). A measurement result of an ¹H-NMR spectrum of the compound (2-b) is as follows.

¹H-NMR (400 MHz, CD₃COCD₃): δ (ppm)=7.26 (d, 1H), 7.04 (s, 1H), 6.72 (d, 1H), 1.98-1.85 (m, 4H), 1.50-1.17 (m, 16H), 0.94-0.77 (m, 6H).

### Synthesis of Compound (2-c)

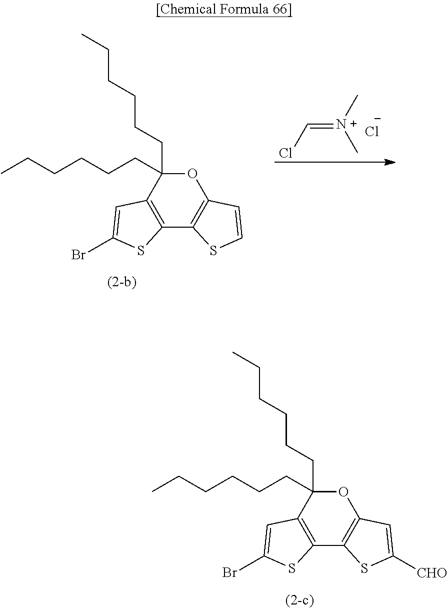

The compound (2-c) was synthesized by formylation of the compound (2-b). Into a 500 mL three-necked flask equipped with a three-way cock, 8.00 g (18.1 mmol) of the compound (2-b) and 150 mL of dehydrated chloroform (manufactured by FUJIFILM Wako Pure Chemical Corporation) were put. A stirrer was further put thereinto, and the inside was replaced with nitrogen. At room temperature, 4.64 g (36.2 mmol) of a Vilsmeir reagent (manufactured by Tokyo Chemical Industry Co., Ltd.) was added thereto in three portions while the reaction mixture was stirred with a magnetic stirrer. After completion of the addition, the resulting mixture was further stirred for 24 hours to be caused to react. After completion of the reaction, 50 mL of deionized water was added thereto to quench the reaction. The organic layer was separated, then further washed with 50 mL of deionized water, and then dried over anhydrous magnesium sulfate. The insoluble matter was separated by filtration. The filtrate was transferred to a 500 mL eggplant flask and concentrated by a rotary evaporator. 200 mL of ethyl acetate and 200 mL of deionized water were added to the obtained concentrate, and the product was extracted. The contents of the eggplant flask were transferred to a 500 mL separating funnel to separate the organic layer, and the organic layer was further washed three times with 100 mL of deionized water. After washing, the organic layer was dried over anhydrous magnesium sulfate. Thereafter, the insoluble matter was separated by filtration, and the filtrate was concentrated and dried by a rotary evaporator to obtain a compound (2-c). The obtained amount was 6.40 g (yield: 75%). A measurement result of an ¹H-NMR spectrum of the compound (2-c) is as follows.

¹H-NMR (400 MHz, CD₃COCD₃): δ (ppm)=9.85 (s, 1H), 7.81, 7.55 (ss, 1H), 7.17, 6.95 (ss, 1H), 2.03-1.87 (m, 4H), 1.50-1.17 (m, 16H), 0.94-0.77 (m, 6H).

### Synthesis of Compound (2A-b)

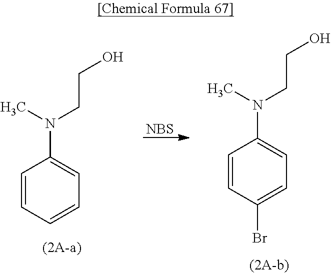

Into a 1 L eggplant flask equipped with a gas introduction tube and an induction stirring type stirrer, 55.47 g (366.8 mmol) of 2-(methylphenylamino) ethanol (compound (4A-a), manufactured by Tokyo Chemical Industry Co., Ltd.) and 832 mL of dehydrated dimethylformamide (manufactured by FUJIFILM Wako Pure Chemical Corporation) were put. The inside was replaced with nitrogen, and the solution was cooled to −40° C. 65.29 g (366.8 mmol) of N-bromosuccinimide (manufactured by Tokyo Chemical Industry Co., Ltd.) was added thereto. Thereafter, the temperature was raised to −15° C., and reaction was caused for two hours. The temperature of the reaction mixture was raised to room temperature, then 455 g of a 10% sodium sulfite aqueous solution and 1110 mL of toluene were added thereto, and the organic layer was washed with deionized water. After washing, the organic layer was dried over anhydrous magnesium sulfate. Thereafter, the insoluble matter was separated by filtration, and the filtrate was concentrated and dried by a rotary evaporator to obtain a compound (2A-b) as a colorless oil. The obtained amount was 72.05 g (yield: 85%). A measurement result of an ¹H-NMR spectrum of the compound (2A-b) is as follows.

¹H-NMR (400 MHz, CDCl₃): δ (ppm)=7.27 (d, 2H), 6.63 (d, 2H), 3.80-3.74 (m, 2H), 3.42 (t, 2H), 2.92 (3H), 1.90 (t, 1H).

### Synthesis of Compound (2A-c)

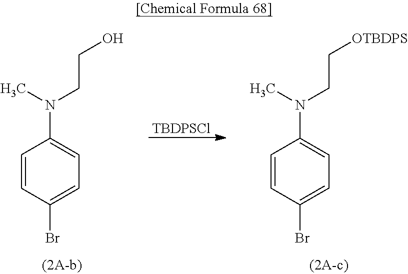

Into a 1 L eggplant flask equipped with a gas introduction tube and an induction stirring type stirrer, 71.93 g (312.6 mmol) of the compound (2A-b), 42.56 g (625.2 mmol) of imidazole (manufactured by Tokyo Chemical Industry Co., Ltd.), and 832 mL of dehydrated tetrahydrofuran (manufactured by FUJIFILM Wako Pure Chemical Corporation) were put. The inside was replaced with nitrogen, and the solution was cooled to 0° C. 88.51 g (322.0 mmol) of tert-butyldiphenylchlorosilane (TBDPSCl, manufactured by Tokyo Chemical Industry Co., Ltd.) was added thereto. Thereafter, the temperature was raised to room temperature, and reaction was caused for three hours. To the reaction mixture, 2929 mL of hexane was added, and the organic layer was washed with deionized water. After washing, the organic layer was dried over anhydrous magnesium sulfate. Thereafter, the insoluble matter was separated by filtration, and the filtrate was concentrated and dried by a rotary evaporator to obtain a compound (2A-c) as a colorless oil. The obtained amount was 145.5 g (yield: 99%).

### Synthesis of Compound (2A-d)

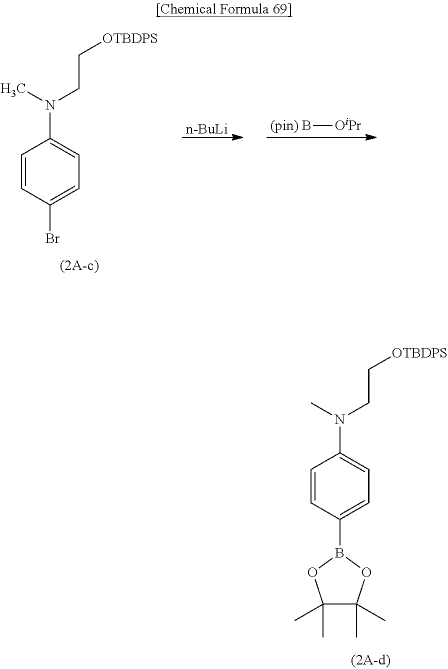

Into a 3 L eggplant flask equipped with a three-way cock at a top and a gas introduction tube, 145.6 g (310.8 mmol) of the compound (2A-c) and 1456 mL of dehydrated tetrahydrofuran (manufactured by FUJIFILM Wako Pure Chemical Corporation) were put. The inside was replaced with nitrogen, and the solution was cooled to −65° C. 239 mL (372.9 mmol) of a 1.6 M n-butyllithium tetrahydrofuran solution (manufactured by KANTO CHEMICAL CO., INC.) was added dropwise thereto, and then the resulting mixture was stirred for one hour to be caused to react. 75.17 g (404.0 mmol) of 2-isopropoxy-4,4,5,5-tetramethyl-1,3,2-dioxaborolane (manufactured by Tokyo Chemical Industry Co., Ltd.) was added thereto, and the temperature was raised to room temperature over two hours. 2884 mL of hexane was added to the reaction mixture, and the organic layer was washed with deionized water. After washing, the organic layer was dried over anhydrous magnesium sulfate. Thereafter, the insoluble matter was separated by filtration, and the filtrate was concentrated by a rotary evaporator to obtain a crude product. The crude product was crystallized twice using acetonitrile, and then the solid was dried under reduced pressure to obtain a compound (2A-d) as a white solid. The obtained amount was 124.1 g (yield: 77%). A measurement result of an ¹H-NMR spectrum of the compound (2A-d) is as follows.

¹H-NMR (400 MHz, CDCl₃): δ (ppm)=7.64-7.57 (m, 6H), 7.42-7.31 (m, 6H), 6.54 (d, 2H), 3.79 (t, 2H), 3.49 (t, 2H), 2.95 (s, 3H), 1.31 (s, 12H), 1.02 (s, 9H).

### Synthesis of Compound (2-d)

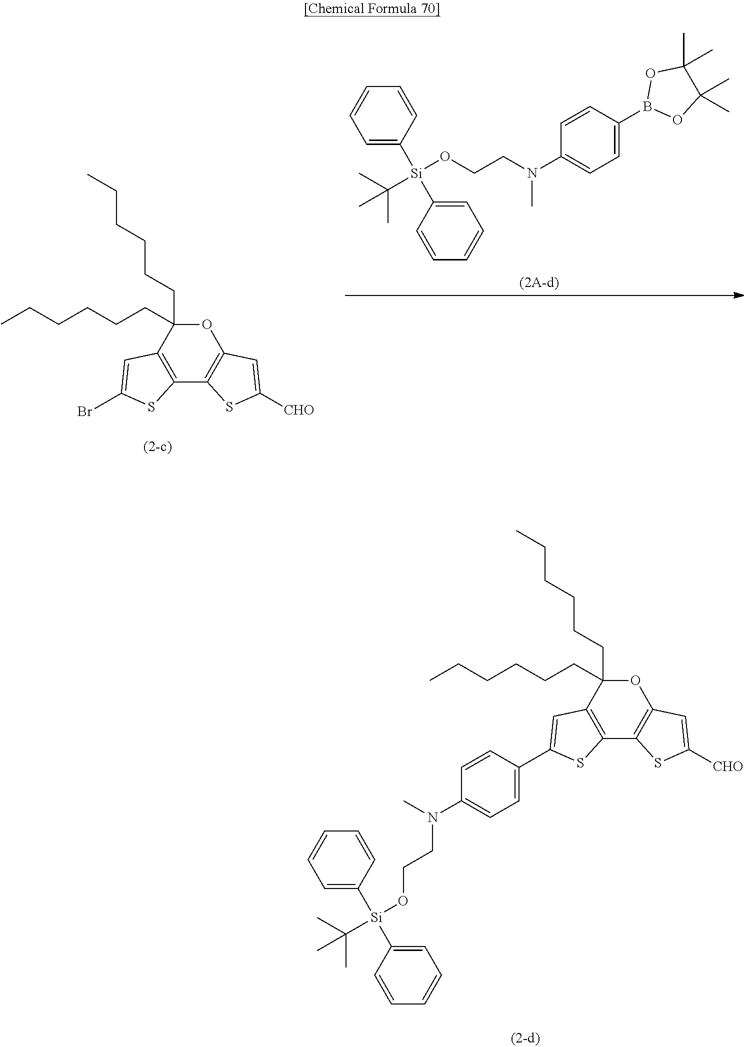 [SMILES: CCCCCCC1(CCCCCC)Oc2cc(C=O)sc2-c2sc(Br)cc21 ; CN(CCO[Si](c1ccccc1)(c1ccccc1)C(C)(C)C)c1ccc(B2OC(C)(C)C(C)(C)O2)cc1 ; CCCCCCC1(CCCCCC)Oc2cc(C=O)sc2-c2sc(-c3ccc(N(C)CCO[Si](c4ccccc4)(c4ccccc4)C(C)(C)C)cc3)cc21]

The compound (2-d) was synthesized from the compound (2-c) by Suzuki coupling. Into a 500 mL three-necked flask equipped with a Dimroth with a three-way cock at a top and an induction type stirring blade, 3.00 g (6.39 mmol) of the compound (2-c), 4.94 g (9.58 mmol) of the compound (2A-d), and 200 mL of dehydrated THF were put, and the inside was replaced with argon. 0.18 g (0.13 mmol) of (tris(dibenzylideneacetone) dipalladium (0) (manufactured by Strem Chemicals) and 0.22 g (0.51 mmol) of tri-tert-butylphosphonium tetrafluoroborate (manufactured by Tokyo Chemical Industry Co., Ltd.) were added thereto while the reaction mixture was stirred, and 48 mL (144 mmol) of a 3 M potassium phosphate aqueous solution was further added thereto. The flask was immersed in an oil bath at 80° C., and reaction was caused for nine hours under reflux while the reaction mixture was vigorously stirred. After completion of the reaction, the reaction mixture was cooled to room temperature, stirring was stopped, and the reaction mixture was allowed to stand still. The aqueous layer of the reaction mixture separated into two layers was removed, and the organic layer was dried over anhydrous magnesium sulfate. The insoluble matter was filtered. The filtrate was transferred to a 500 mL eggplant flask and concentrated by a rotary evaporator. The obtained concentrate was purified by column chromatography using toluene as an eluent to obtain the target compound (2-d). The obtained amount was 3.85 g (yield: 77%). A measurement result of an ¹H-NMR spectrum of the compound (2-d) is as follows.

¹H-NMR (400 MHz, CD₃COCD₃): δ (ppm)=9.82 (s, 1H), 7.73-7.64 (m, 4H), 7.55-7.35 (m, 8H), 6.75-6.68 (m, 2H), 3.86 (t, 2H), 3.65 (t, 2H), 2.81 (s, 3H), 2.03-1.87 (m, 4H), 1.50-1.17 (m, 16H), 1.03 (s, 9H), 0.94-0.77 (m, 6H).

### Synthesis of Compound (2)

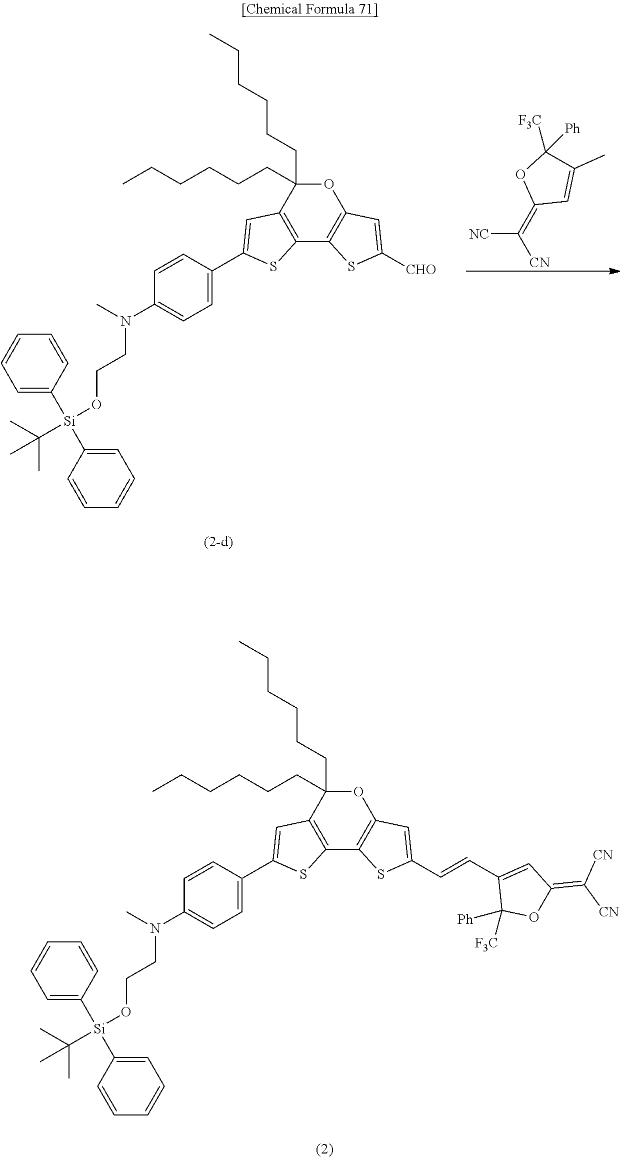 [SMILES: CCCCCCC1(CCCCCC)Oc2cc(C=O)sc2-c2sc(-c3ccc(N(C)CCO[Si](c4ccccc4)(c4ccccc4)C(C)(C)C)cc3)cc21 ; CC1=CC(=C(C#N)C#N)OC1(c1ccccc1)C(F)(F)F ; CCCCCCC1(CCCCCC)Oc2cc(/C=C/C3=CC(=C(C#N)C#N)OC3(c3ccccc3)C(F)(F)F)sc2-c2sc(-c3ccc(N(C)CCO[Si](c4ccccc4)(c4ccccc4)C(C)(C)C)cc3)cc21]

The compound (2) was synthesized from the compound (2-d) by aldol condensation. Into a 500 mL eggplant flask equipped with a three-way cock at a top, 3.85 g (4.95 mmol) of the compound (2-d), 1.87 g (5.94 mmol) of 2-(3-cyano-4-methyl-5-phenyl-5-(trifluoromethyl)-2(5H)-furanylidene)-propanedinitrile (manufactured by iChemical), 100 mL of dehydrated ethanol, and 100 mL of dehydrated chloroform were put. A stirrer was further put thereinto, and the inside was replaced with nitrogen. Reaction was caused at room temperature for 24 hours while the reaction mixture was stirred with a magnetic stirrer. After completion of the reaction, the reaction mixture was concentrated by a rotary evaporator. Ethanol was added to the concentrate, the precipitate was separated by filtration, and the precipitate was further washed with methanol to obtain the compound (2) as a blue solid. The obtained amount was 4.55 g (yield: 86%). The compound (2) has a divalent polycyclic condensed ring group having two or more thiophene rings and having an sp3 carbon atom as a constituent element, and further has a group represented by formula (b1). Measurement results of an ¹H-NMR spectrum and a UV visible light spectrum of the compound (2) are as follows.

¹H-NMR (400 MHz, CD₃COCD₃): δ (ppm)=7.86-7.34 (m, 18H), 6.85-6.69 (m, 3H), 3.86 (t, 2H), 3.65 (t, 2H), 2.81 (s, 3H), 2.03-1.87 (m, 4H), 1.50-1.17 (m, 16H), 1.03 (s, 9H), 0.94-0.77 (m, 6H).

UV visible light spectrum: λmax=835 nm (in chloroform)

### (Example 1-2) Synthesis of Compound (3)

In order to synthesize a compound (3), a compound (3-a) was formylated to synthesize a compound (3-b). Subsequently, a compound (3-c) was synthesized from the compound (3-b) by Wittig reaction. Subsequently, the compound (3-c) was formylated to synthesize a compound (3-d). Subsequently, the compound (3) was synthesized from the compound (3-d) by aldol condensation.

### Synthesis of Compound (3-b)

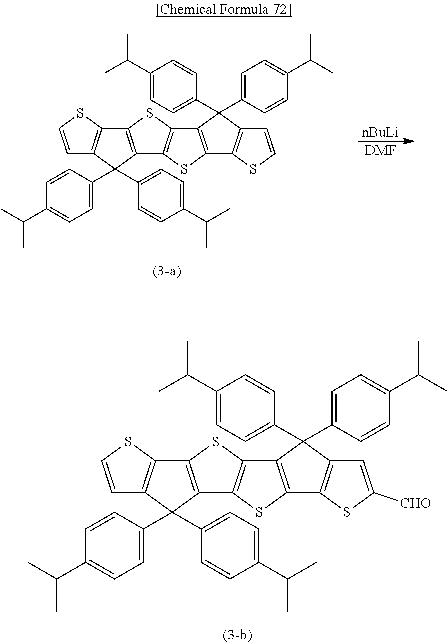

The compound (3-a) was synthesized with reference to a method described in Chem. Mater. 2011, 23, 2289-2291. Into a 1000 mL three-necked flask equipped with a three-way cock and a septum, 20.00 g (24.96 mmol) of the compound (3-a) and 500 mL of super dehydrated tetrahydrofuran (manufactured by FUJIFILM Wako Pure Chemical Corporation) were put. A stirrer was further put thereinto, and the inside was replaced with nitrogen. 17.16 mL (27.46 mmol) of a 1.6 M n-butyllithium hexane solution (manufactured by KANTO CHEMICAL CO., INC.) was added thereto over five minutes in an ice bath (0° C.) using a gas-tight syringe while the reaction mixture was stirred using a magnetic stirrer. After completion of the addition, the mixture was further stirred for two hours under ice cooling to be caused to react. Thereafter, 3.65 g of super dehydrated N,N-dimethylformamide was added thereto, and the mixture was stirred for 15 minutes. The ice bath was removed, and the mixture was further stirred at room temperature for one hour. Thereafter, deionized water was added thereto to quench the reaction. The reaction mixture was transferred to a 1 L eggplant flask and concentrated by a rotary evaporator. The obtained viscous concentrate was washed with deionized water, and the precipitated solid was separated by filtration. The obtained solid was washed with methanol and dried under reduced pressure to obtain the compound (3-b). The obtained amount was 22.07 g (yield: 107%). A measurement result of an ¹H-NMR spectrum of the compound (3-b) is as follows.

¹H-NMR (400 MHz, CDCl₃): δ (ppm)=9.77 (s, 1H), 7.66 (s, 1H), 7.22 (d, 1H), 7.20-7.05 (m, 9H), 2.93-2.76 (m, 4H), 1.20 (t, 24H).

### Synthesis of Compound (3-c)

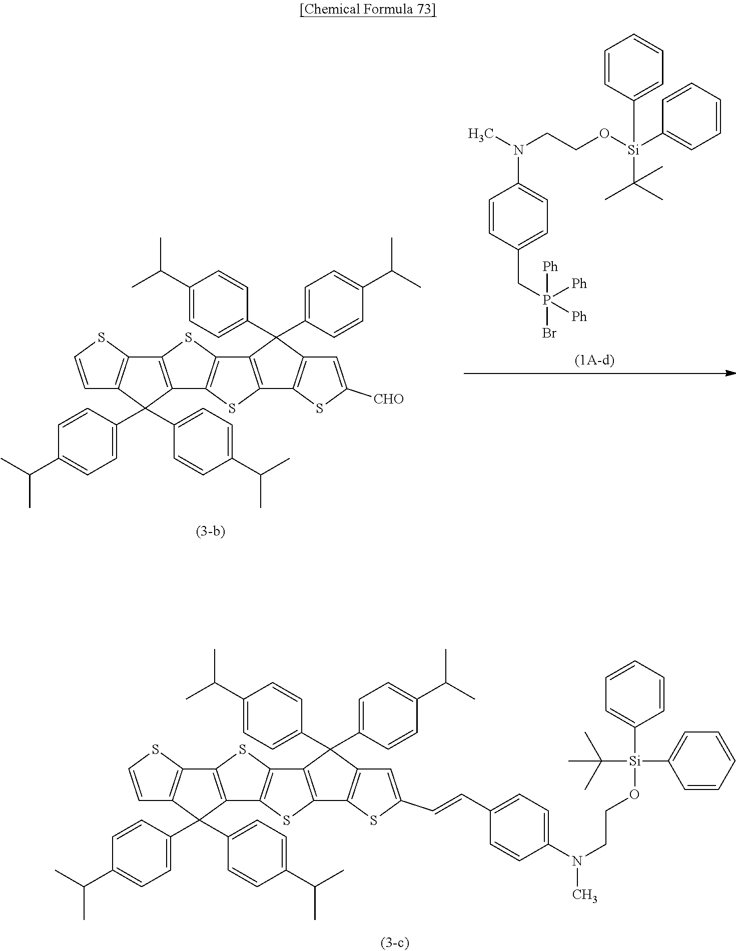 [SMILES: CC(C)c1ccc(C2(c3ccc(C(C)C)cc3)c3ccsc3-c3sc4c5c(sc4c32)-c2sc(C=O)cc2C5(c2ccc(C(C)C)cc2)c2ccc(C(C)C)cc2)cc1 ; CN(CCO[Si](c1ccccc1)(c1ccccc1)C(C)(C)C)c1ccc(CP(Br)(c2ccccc2)(c2ccccc2)c2ccccc2)cc1 ; CC(C)c1ccc(C2(c3ccc(C(C)C)cc3)c3ccsc3-c3sc4c5c(sc4c32)-c2sc(/C=C/c3ccc(N(C)CCO[Si](c4ccccc4)(c4ccccc4)C(C)(C)C)cc3)cc2C5(c2ccc(C(C)C)cc2)c2ccc(C(C)C)cc2)cc1]

Into a 300 mL three-necked flask equipped with a three-way cock, 2.50 g (3.01 mmol) of the compound (3-b), 2.69 g (3.62 mmol) of the compound (1A-d), and 100 mL of dehydrated tetrahydrofuran (manufactured by FUJIFILM Wako Pure Chemical Corporation) (THF) were put. A stirrer was further put thereinto, and the inside was replaced with nitrogen. The flask was immersed in an ice bath and cooled while the reaction mixture was stirred with a magnetic stirrer. Thereafter, 2.25 g (56.38 mmol) of a 60% liquid paraffin dispersion of sodium hydride (manufactured by Tokyo Chemical Industry Co., Ltd.) was added thereto, and the mixture was caused to react for one hour. The ice bath was removed, and the reaction mixture was heated to room temperature and further caused to react for two hours. After completion of the reaction, the reaction mixture was placed on ice to quench remaining sodium hydride, 200 mL of ethyl acetate was added thereto, and a product was extracted and further washed with deionized water. Thereafter, the organic layer was dried over magnesium sulfate. The insoluble matter was separated by filtration. Thereafter, the filtrate was transferred to an eggplant flask and concentrated by a rotary evaporator to obtain the compound (3-c) as a solid. The obtained amount was 3.60 g (yield: 98%).

### Synthesis of Compound (3-d)

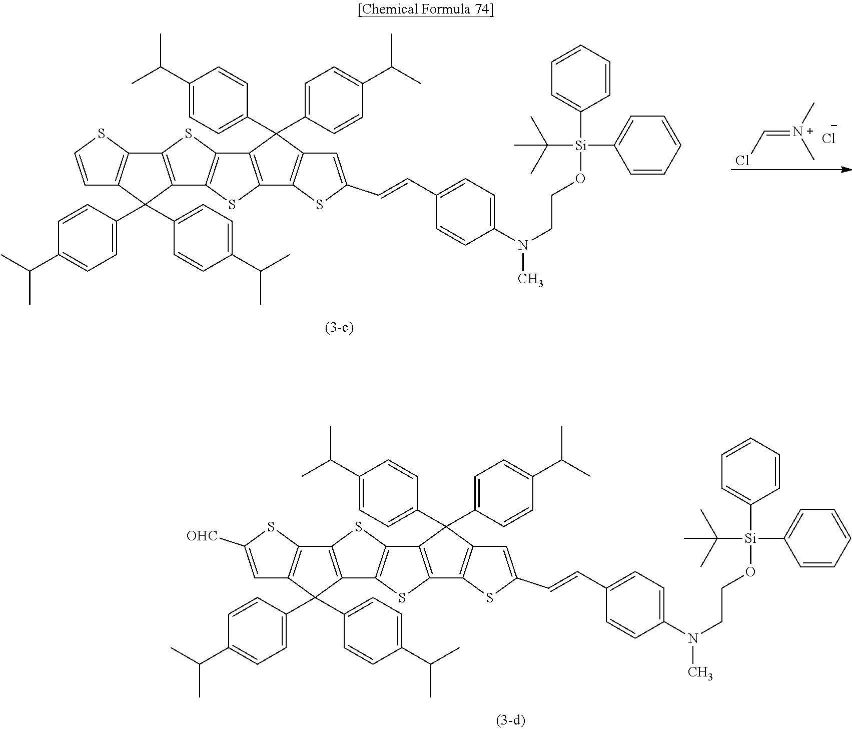

Into a 500 mL three-necked flask equipped with a three-way cock and a septum, 3.60 g (2.96 mmol) of the compound (3-c) and 100 mL of dehydrated chloroform (manufactured by FUJIFILM Wako Pure Chemical Corporation) were put. A stirrer was further put thereinto, and the inside was replaced with nitrogen. At room temperature, 0.57 g (4.44 mmol) of a Vilsmeir reagent (manufactured by Tokyo Chemical Industry Co., Ltd.) was added thereto in three portions while the reaction mixture was stirred with a magnetic stirrer. After completion of the addition, the resulting mixture was further stirred for 24 hours to be caused to react. After completion of the reaction, 50 mL of deionized water was added thereto to quench the reaction. The organic layer was separated, then further washed with 50 mL of deionized water, and then dried over anhydrous magnesium sulfate. The insoluble matter was separated by filtration. The filtrate was transferred to a 500 mL eggplant flask and concentrated by a rotary evaporator. The obtained concentrate was washed with methanol, and then dried under reducer pressure to obtain the compound (3-d). The obtained amount was 3.78 g (yield: 103%). A measurement result of an ¹H-NMR spectrum of the compound (3-d) is as follows.

¹H-NMR (400 MHz, CDCl₃): δ (ppm)=9.78 (s, 1H), 7.70-7.62 (m, 3H), 7.50-7.07 (m, 26H), 6.53 (d, 1H), 3.82 (t, 2H), 3.51 (t, 2H), 2.98 (s, 3H), 2.96-2.83 (m, 4H), 1.24 (t, 24H), 1.05 (t, 9H).

### Synthesis of Compound (3)

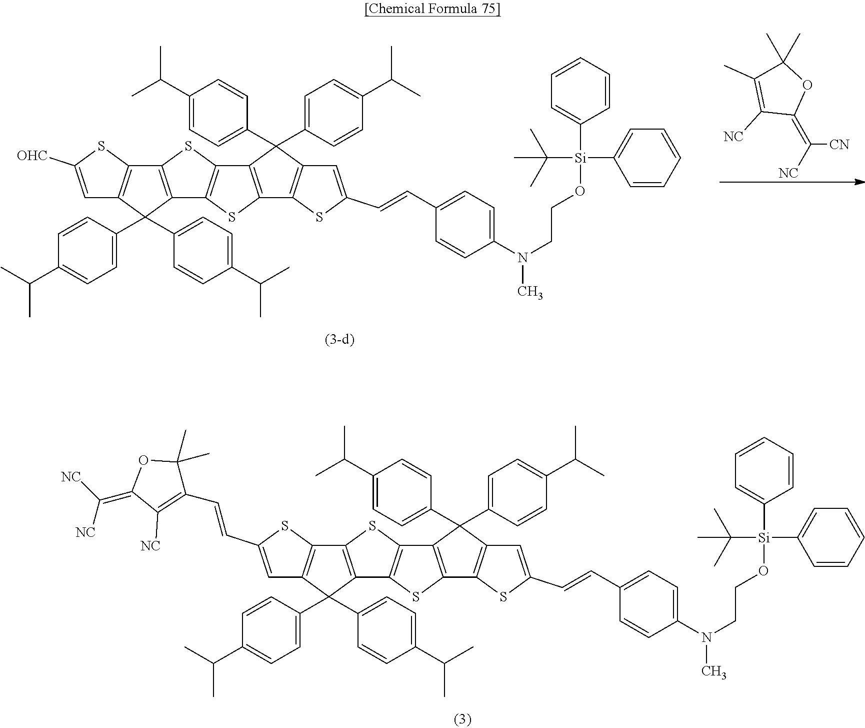

Into a 300 mL eggplant flask equipped with a three-way cock at a top, 3.78 g (3.04 mmol) of the compound (3-d) and 0.91 g (4.56 mmol) of 2-(3-cyano-4-methyl-5,5-dimethyl-2 (5H)-furanylidene) -propanedinitrile (synthesized by a known method. Proceedings of SPIE, 8113, pp 811315), 1.5 mL of triethylamine, and 100 mL of dehydrated chloroform were put. A stirrer was further put thereinto, and the inside was replaced with nitrogen. The flask was immersed in an oil bath, and reaction was caused at 60° C. for 48 hours while the reaction mixture was stirred with a magnetic stirrer. After completion of the reaction, the reaction mixture was concentrated by a rotary evaporator. To the concentrate, 150 mL of methanol was added, and the precipitate was separated by filtration. The obtained product was washed with 17 mL of ethyl acetate and 75 mL of ethanol to obtain the compound (3) as a red-brown solid. The obtained amount was 3.98 g (yield: 92%). A measurement result of an ¹H-NMR spectrum of the compound (3) is as follows.

¹H-NMR (400 MHz, CD₂Cl₂): δ 0.78 (d, 1H, J=15.8 Hz), 7.62-7.58 (m, 4H), 7.44-7.28 (m, 7H), 7.23 (d, 2H), 7.17-7.10 (m, 16H), 6.95 (d, 2H), 6.83 (d, 1H, 15.8 Hz), 6.59-6.51 (m, 3H), 3.78 (t, 2H), 3.50 (t, 2H), 2.96 (s, 3H), 2.90-2.80 (m, 4H), 1.69 (s, 6H), 1.18 (d, 24H), 1.00 (s, 9H).

UV visible light spectrum: λmax=793 nm (in chloroform)

### (Example 1-3) Synthesis of Compound (4)

In order to synthesize a compound (4), a compound (4-b) was synthesized from a compound (4-a) by Wittig reaction. Subsequently, a compound (4-c) was synthesized from the compound (4-b) by Vilsmeier reaction, and the compound (4) was synthesized from the compound (4-c) by Knoevenagel condensation.

### Synthesis of Compound (4-b)

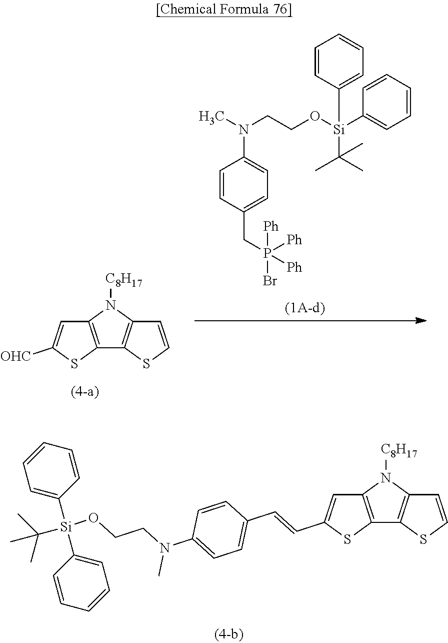

The compound (4-a) was synthesized by a method described in WO-A-2022/131236. Into a 500 mL three-necked flask equipped with a three-way cock, 3.20 g (8.20 mmol) of the compound (4-a), 6.41 g (8.60 mmol) of the compound (1A-d), and 160 mL of dehydrated tetrahydrofuran (manufactured by FUJIFILM Wako Pure Chemical Corporation) (THF) were put. A stirrer was further put thereinto, and the inside was replaced with nitrogen. The flask was immersed in an ice bath and cooled while the reaction mixture was stirred with a mechanical stirrer. Thereafter, 3.45 g (30.72 mmol) of potassium t-butoxide (manufactured by Tokyo Chemical Industry Co., Ltd.) was added thereto, and the mixture was caused to react for five minutes. The ice bath was removed, and the reaction mixture was heated to room temperature and further caused to react for one hour. After completion of the reaction, 128 mL of toluene was added thereto, the mixture was washed with deionized water, and then the organic layer was dried over magnesium sulfate. The insoluble matter was separated by filtration. Thereafter, the filtrate was transferred to an eggplant flask and concentrated by a rotary evaporator to obtain a compound (4-b) as a viscous liquid. The obtained amount was 7.38 g (yield: 116%).

### Synthesis of Compound (4-c)

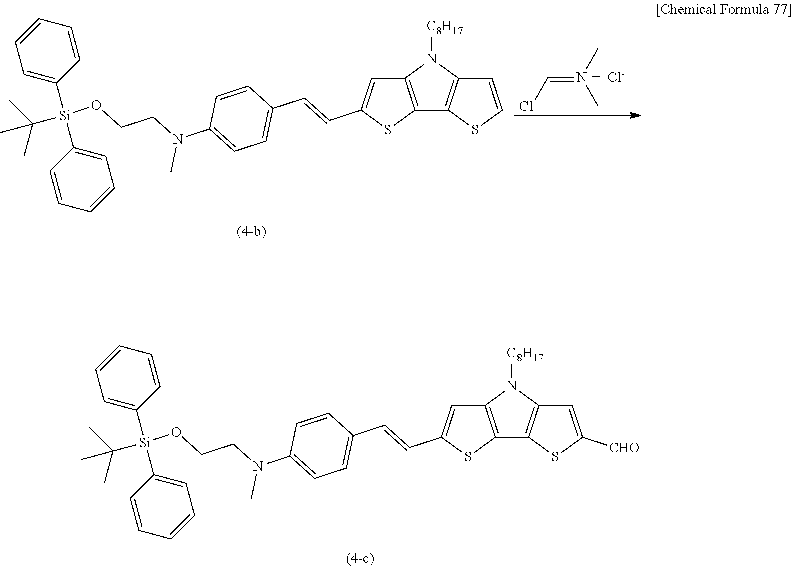

Into a 200 mL three-necked flask equipped with a Dimroth with a three-way cock at a top, 6.36 g (20.03 mmol) of the compound (4-b) and 127 mL of chloroform (manufactured by FUJIFILM Wako Pure Chemical Corporation) were put. A stirrer was further put thereinto, and the inside was replaced with nitrogen. The flask was immersed in an ice bath and cooled while the reaction mixture was stirred with a stirrer. 3.48 g (27.08 mmol) of a Vilsmeier reagent (manufactured by Tokyo Chemical Industry Co., Ltd.) was added thereto in two portions. After completion of the addition, the resulting mixture was further stirred for one hour to be caused to react. After completion of the reaction, 40 mL of brine was added thereto to quench the reaction. The organic layer was washed with 40 mL of brine, then dried over anhydrous magnesium sulfate. The insoluble matter was separated by filtration. The filtrate was concentrated by a rotary evaporator. The obtained concentrate was purified with a reverse phase silica gel column (mobile phase, methanol:ethyl acetate=90:10) to obtain the compound (4-c) as a red solid. The obtained amount was 0.49 g (yield: 7%). A measurement result of an ¹H-NMR spectrum of the compound (4-c) is as follows.

¹H-NMR (400 MHz, CDCl₃): δ (ppm)=9.83 (s, 1H), 7.66-7.59 (m, 4H), 7.57 (s, 1H), 7.45-7.39 (m, 2H), 7.38-7.31 (m, 4H), 7.29 (d, 2H), 7.01 (d, 1H, J=1.6 Hz), 6.91 (d, 1H, J=1.6 Hz), 6.85 (s, 1H), 6.54 (d, 2H), 4.16 (t, 2H), 3.81 (t, 2H), 3.51 (t, 2H), 2.98 (s, 3H),), 1.91-1.80 (m, 2H), 1.38-1.19 (m, 12H), 1.04 (s, 9H), 0.86 (t, 3H).

### Synthesis of Compound (4)

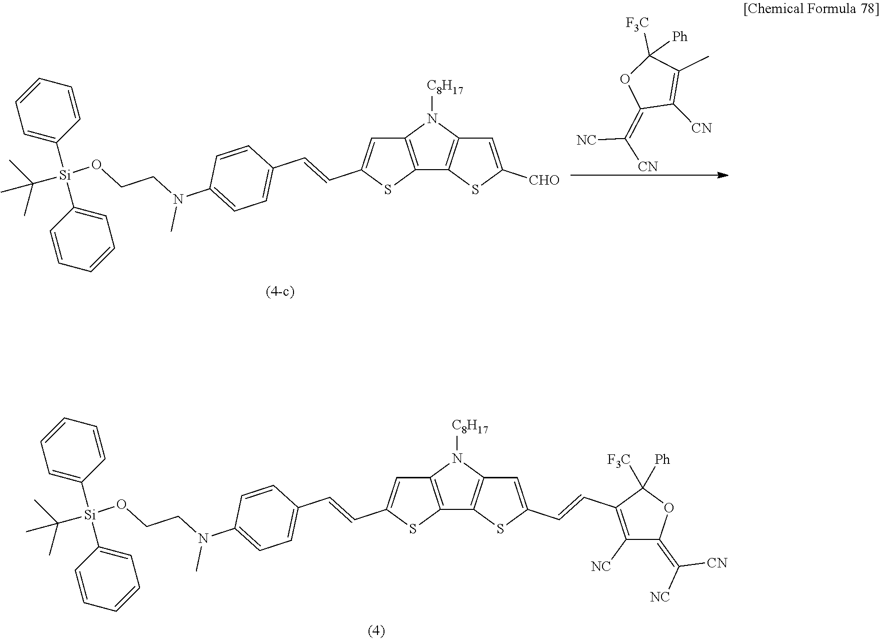

Into a 100 mL eggplant flask equipped with a three-way cock, 0.48 g (0.67 mmol) of the compound (4-c), 0.38 g (1.20 mmol) of 2-(3-cyano-4-methyl-5-phenyl-5-(trifluoromethyl)-2(5H)-furanylidene)-propanedinitrile (manufactured by IChemical), 2 mL of dehydrated ethanol, and 8 mL of dehydrated chloroform were put. A stirrer was further put thereinto, and the inside was replaced with nitrogen. The mixture was caused to react at room temperature for 27 hours while the reaction mixture was stirred with a stirrer. After completion of the reaction, 24 mL of methanol was added thereto. A precipitate was separated by filtration and then washed with methanol to obtain the compound (4) as a black solid. The obtained amount was 0.63 g (yield: 91%). A measurement result of an ¹H-NMR spectrum of the compound (4) is as follows.

¹H-NMR (400 MHz, CDCl₃): δ (ppm)=8.05-7.90 (br, 1H), 7.62-7.59 (m, 4H), 7.54-7.51 (m, 5H), 7.43-7.37 (m, 2H), 7.36-7.29 (m, 6H), 7.26 (s, 1H), 7.05 (d, 1H, J=16.0 Hz), 6.99 (d, 1H, J=16.0H z), 6.82 (s, 1H), 6.58 (d, 2H, J=14.8 Hz), 6.53 (d, 1H, 14.8 Hz), 4.09 (t, 2H), 3.80 (t, 2H), 3.53 (t, 2H), 2.99 (s, 3H), 1.87-1.77 (m, 2H), 1.32-1.13 (m, 10H), 1.00 (s, 9H), 0.84 (t, 3H).

### (Example 1-4) Synthesis of Compound (5)

In order to synthesize a compound (5), a compound (5-a) was synthesized by Suzuki coupling. Subsequently, the compound (5-a) was formylated to synthesize a compound (5-b). Subsequently, the compound (5) was synthesized from the compound (5-b) by Knoevenagel condensation.

### Synthesis of Compound (5-a)

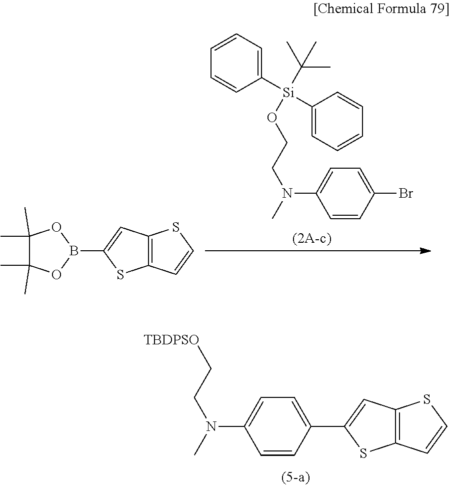

Into a 500 mL four-necked flask equipped with a Dimroth with a three-way cock at a top, a gas introduction tube, and an induction type stirrer, 5.00 g of the compound (2A-c), 4.26 g of 4,4,5,5-tetramethyl-2-(thieno [3,2-b]thiophene-2-yl)-1,3,2-dioxaborolane, and 200 mL of dehydrated toluene (manufactured by KANTO CHEMICAL CO., INC.) were put. The inside of the flask was replaced with nitrogen while the reaction mixture was purged with argon. To the reaction mixture, 0.29 g of tris(dibenzylideneacetone) dipalladium (0) (manufactured by Strem Chemicals), 0.37 g of tri-tert-butylphosphonium tetrafluoroborate (manufactured by Tokyo Chemical Industry Co., Ltd.), and 80 mL of a 3 M potassium phosphate aqueous solution were added. Thereafter, the flask was immersed in an oil bath at 80° C., and the mixture was caused to react for ten hours while being vigorously stirred with a mechanical stirrer. After completion of the reaction, the reaction mixture was cooled to room temperature. Thereafter, the separated aqueous layer was separated and removed, and the organic layer was dried over anhydrous magnesium sulfate. The solid content was separated by filtration, and the filtrate was concentrated and dried by a rotary evaporator. The obtained crude product was washed with methanol (manufactured by FUJIFILM Wako Pure Chemical Corporation), separated by filtration, and dried under reduced pressure to obtain the compound (5-a). The obtained amount was 4.37 g.

### Synthesis of Compound (5-b)

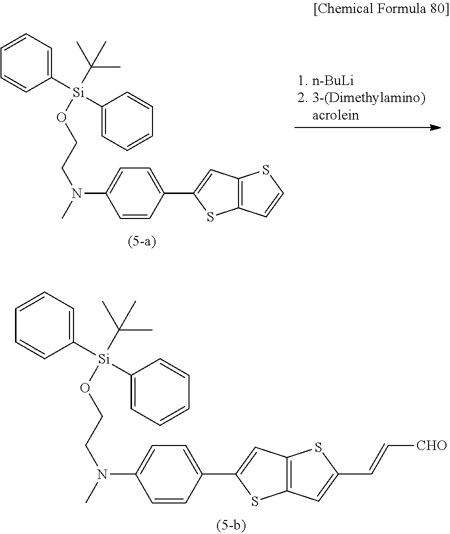 [SMILES: CN(CCO[Si](c1ccccc1)(c1ccccc1)C(C)(C)C)c1ccc(-c2cc3sccc3s2)cc1 ; CN(CCO[Si](c1ccccc1)(c1ccccc1)C(C)(C)C)c1ccc(-c2cc3sc(/C=C/C=O)cc3s2)cc1]

Into a 200 mL three-necked flask equipped with a Dimroth with a three-way cock at a top, 1.00 g of the compound (5-a) and 50 mL of dehydrated tetrahydrofuran (manufactured by FUJIFILM Wako Pure Chemical Corporation) were put. A stirrer was further put thereinto, and the inside was replaced with nitrogen. 1.54 mL of a 1.6 M butyllithium hexane solution (manufactured by KANTO CHEMICAL CO., INC.) was added thereto at room temperature while the reaction mixture was stirred with a stirrer. After completion of the addition, the mixture was further stirred at room temperature for one hour, and then 0.28 g of dimethylaminoacrolein (manufactured by Tokyo Chemical Industry Co., Ltd.) was added to the reaction mixture. After completion of the addition, the resulting mixture was further stirred for one hour to be caused to react. After completion of the reaction, deionized water was added thereto, the separated aqueous layer was separated and removed, and the organic layer was dried over anhydrous magnesium sulfate. The solid content was separated by filtration, and the filtrate was concentrated and dried by a rotary evaporator. The obtained viscous substance was washed with methanol (manufactured by FUJIFILM Wako Pure Chemical Corporation), the supernatant was removed, and the remaining viscous substance was dried under reduced pressure to obtain the compound (5-b). The obtained amount was 1.21 g.

### Synthesis of Compound (5)

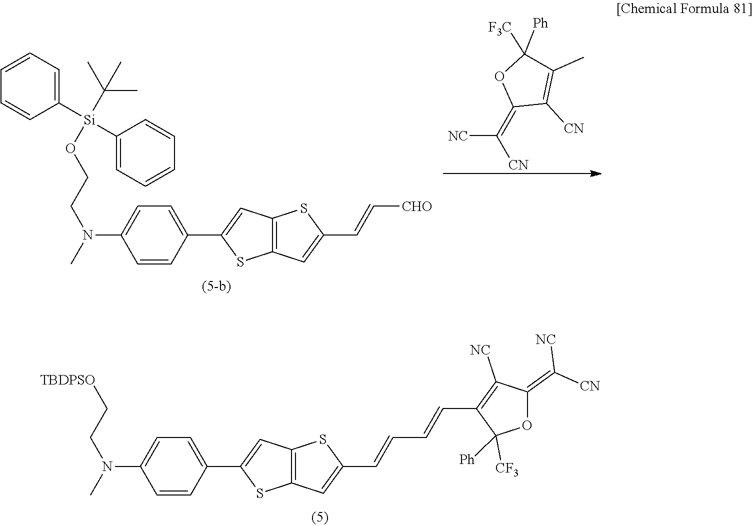

Into a 200 mL eggplant flask equipped with a Dimroth with a three-way cock at a top, 1.21 g of the compound (5-b), 0.98 g of 2-(3-cyano-4-methyl-5-phenyl-5-(trifluoromethyl) furan-2(5H)-ylidene) malononitrile (manufactured by ICHEMICAL), 30 mL of dehydrated chloroform (manufactured by KANTO CHEMICAL CO., INC.), and 30 mL of dehydrated ethanol (manufactured by FUJIFILM Wako Pure Chemical Corporation) were put. A stirrer was further put thereinto, and the inside was replaced with nitrogen. The mixture was caused to react while being stirred with a stirrer at room temperature for nine hours. After completion of the reaction, the reaction mixture was concentrated and dried by a rotary evaporator, and the obtained viscous substance was washed with methanol (manufactured by FUJIFILM Wako Pure Chemical Corporation). The precipitated solid was separated by filtration and dried under reduced pressure to obtain the compound (5). The obtained amount was 1.10 g. A measurement result of an ¹H-NMR spectrum of the compound (5) is as follows.

¹H-NMR (400 MHz, CDCl₃): δ (ppm)=8.11-7.89 (br, 1H), 7.64-7.58 (m, 4H), 7.52-7.48 (m, 5H), 7.44-7.38 (m, 2H), 7.37-7.27 (m, 6H), 7.21 (brs, 1H), 7.01-6.96 (m, 2H), 6.88-6.86 (m, 1H), 6.67-6.45 (m, 3H), 3.80 (t, 2H), 3.53 (t, 2H), 2.99 (s, 3H), 1.99-1.83 (m, 4H), 1.06-0.83 (m, 25H), 0.76-0.53 (m, 14H).

### (Example 1-5) Synthesis of Compound (6)

In order to synthesize a compound (6), the compound (4-a) was brominated to synthesize a compound (6-b). Subsequently, a compound (6-c) was synthesized from the compound (6-b) by Suzuki coupling. Subsequently, a compound (6-d) was synthesized from the compound (6-c) by formylation reaction, and the compound (6) was synthesized from the compound (6-c) by Knoevenagel condensation.

### Synthesis of Compound (6-b)

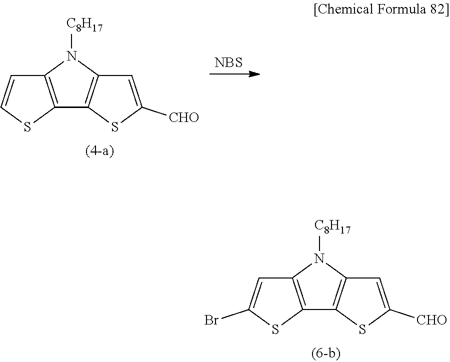

Into a 500 mL three-necked flask equipped with a three-way cock, 24.00 g (75.21 mmol) of the compound (4-a) and 240 mL of dehydrated tetrahydrofuran (THF, manufactured by FUJIFILM Wako Pure Chemical Corporation) were put. A stirrer was further put thereinto, and the inside was replaced with nitrogen. Thereafter, the flask containing the reaction mixture was cooled to 0° C. 13.39 g (75.21 mmol) of N-bromosuccinimide (NBS, manufactured by Tokyo Chemical Industry Co., Ltd.) was added thereto. After completion of the addition, the reaction mixture was heated to room temperature, stirred for one hour, and caused to react. After completion of the reaction, the reaction mixture was washed with deionized water. The obtained organic layer was dried over anhydrous magnesium sulfate. Thereafter, the insoluble matter was separated by filtration, and the filtrate was concentrated and dried by a rotary evaporator to obtain the compound (6-b). The obtained amount was 18.07 g (yield: 62%).

### Synthesis of Compound (6-c)

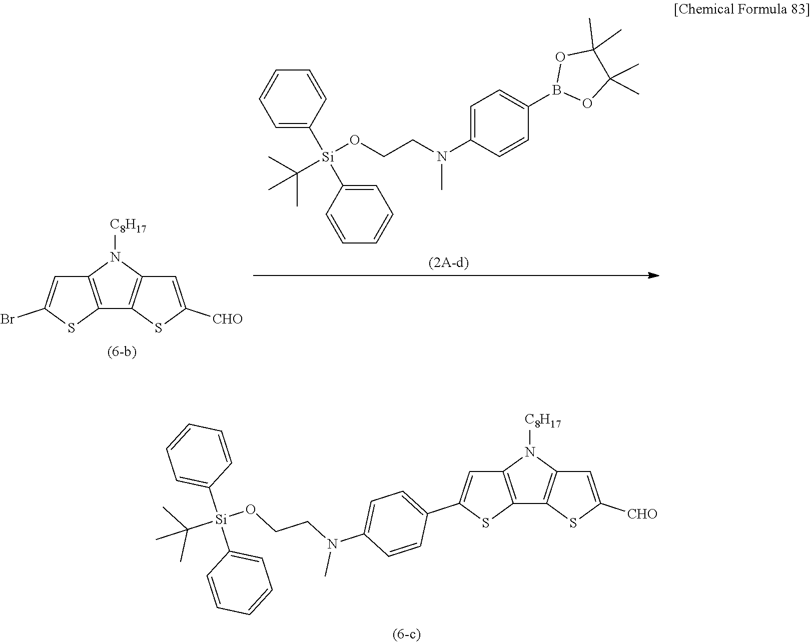

Into a 500 mL three-necked flask equipped with a Dimroth with a three-way cock at a top, 15.00 g (37.65 mmol) of the compound (6-b), 21.35 g (41.42 mmol) of the compound (2A-d), and 225 mL of dehydrated THF were put. A stirrer was further put thereinto, and the inside was replaced with argon. 50 mL (151 mmol) of a 3 M potassium phosphate aqueous solution was added thereto while the reaction mixture was stirred, and 1.10 g (0.94 mmol) of tris(dibenzylideneacetone) dipalladium (0) (manufactured by Strem Chemicals) and 1.15 g (3.77 mmol) of tri-tert-butylphosphonium tetrafluoroborate (manufactured by Tokyo Chemical Industry Co., Ltd.) were added thereto. The flask was immersed in an oil bath at 80° C., and reaction was caused for two hours under reflux while the reaction mixture was vigorously stirred. After completion of the reaction, the reaction mixture was cooled to room temperature, stirring was stopped, and the reaction mixture was allowed to stand still. The aqueous layer of the reaction mixture separated into two layers was removed, and the organic layer was dried over anhydrous magnesium sulfate. The insoluble matter was separated by filtration. The filtrate was transferred to a 500 mL eggplant flask, and concentrated and dried by a rotary evaporator to obtain the target compound (6-c). The obtained amount was 29.52 g (yield: 111%). A measurement result of an ¹H-NMR spectrum of the compound (6-c) is as follows.

¹H-NMR (400 MHz, CDCl₃): 9.83 (s, 1H), 7.64-7.61 (m, 4H), 7.59 (s, 1H) 7.48-7.38 (m, 4H), 7.38 (m, 4H), 7.01 (s, 1H), 6.58 (d, 2H), 4.20 (t, 2H), 3.82 (t, 2H), 3.52 (t, 2H),), 2.99 (s, 3H), 1.91-1.86 (m, 2H), 1.37-1.19 (m, 10H), 1.03 (s, 9H), 0.85 (t, 3H).

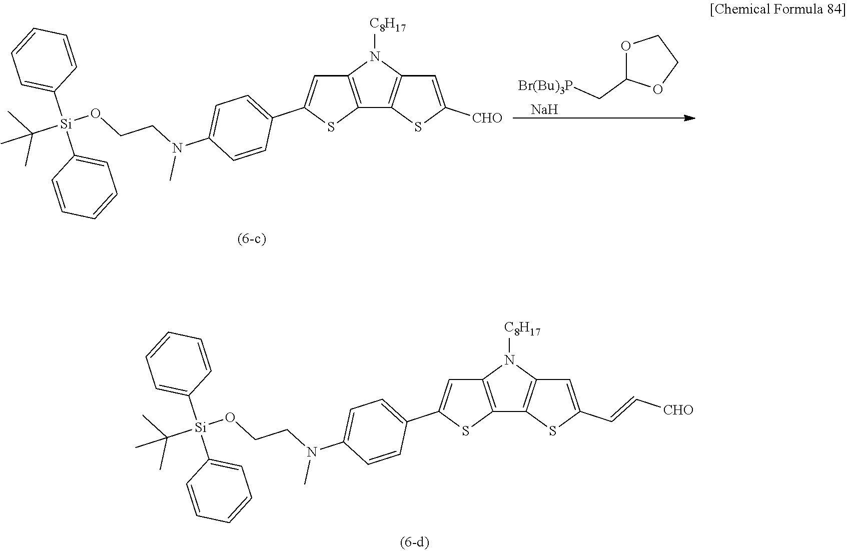

Into a 500 mL three-necked flask equipped with a Dimroth with a three-way cock at a top, 6.00 g (8.49 mmol) of the compound (6-c), 3.45 g (9.33 mmol) of tributyl (1,3 dioxolan-2-ylmethyl) phosphonium bromide (manufactured by Tokyo Chemical Industry Co., Ltd.), and 120 mL of THF (manufactured by FUJIFILM Wako Pure Chemical Corporation) were put. A stirrer was further put thereinto, and the inside was replaced with nitrogen. The flask was immersed in an ice bath and cooled while the reaction mixture was stirred with a stirrer. To the reaction mixture, 1.02 g (25.46 mmol) of a sodium hydride reagent (manufactured by Tokyo Chemical Industry Co., Ltd.) was added. After completion of the addition, the mixture was further stirred for three hours to be caused to react. After completion of the reaction, 120 mL of 10% hydrochloric acid was added thereto to quench the reaction. The organic layer was separated, then further washed with 60 mL of deionized water, and then dried over anhydrous magnesium sulfate. The insoluble matter was separated by filtration. The filtrate was concentrated by a rotary evaporator. The obtained concentrate was purified with a silica gel column (mobile phase: chloroform) to obtain the compound (6-d). The obtained amount was 4.78 g (yield: 77%). A measurement result of an ¹H-NMR spectrum of the compound (6-d) is as follows.

¹H-NMR (400 MHz, CDCl₃): 9.87 (d, 1H, J=7.6 Hz), 7.65-7.61 (m, 4H), 7.58 (d, 1H, J15.0 Hz), 7.45-7.32 (m, 8H), 7.19 (s, 1H), 6.99 (s, 1H), 6.58 (d, 2H), 6.56 (dd, 1H, J=150.0 Hz, 7.6 Hz), 4.16 (t, 2H), 3.81 (t, 2H), 3.52 (t, 2H), 2.99 (s, 3H), 1.91-1.83 (m, 2H), 1.35-1.18 (m, 10H), 1.05 (s, 9H), 0.85 (t, 3H).

### Synthesis of Compound (6)

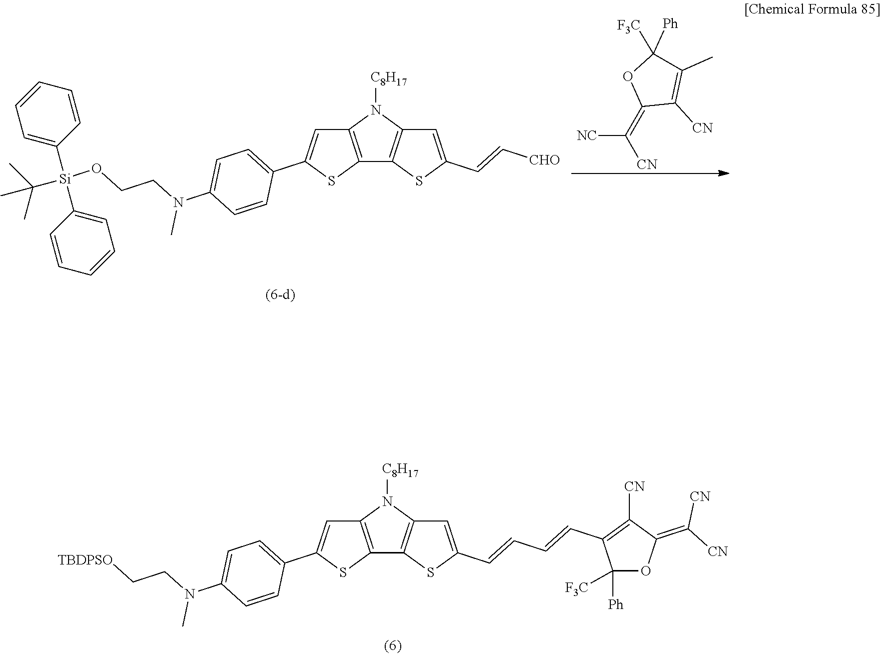

Into a 100 mL eggplant flask equipped with a three-way cock, 2.00 g (2.73 mmol) of the compound (6-d), 1.72 g (5.46 mmol) of 2-(3-cyano-4-methyl-5-phenyl-5-(trifluoromethyl)-2(5H)-furanylidene)-propanedinitrile (manufactured by IChemical), 20 mL of dehydrated ethanol, and 20 mL of dehydrated chloroform were put. A stirrer was further put thereinto, and the inside was replaced with nitrogen. The mixture was caused to react at room temperature for 18 hours while the reaction mixture was stirred with a stirrer. After completion of the reaction, 20 mL of ethanol was added thereto, and the precipitate was separated by filtration. The obtained product was washed twice with 8 mL of chloroform and 42 mL of ethanol to obtain the compound (6) as a black solid. The obtained amount was 2.53 g (yield: 90%). A measurement result of an ¹H-NMR spectrum of the compound (6) is as follows.

¹H-NMR (400 MHz, CDCl₃): 7.76 (dd, J=13.2 Hz, 12.4 Hz, 1H), 7.61 (d, 4H), 7.66-7.29 (m, 14H), 7.18 (s, 1H), 7.02 (s, 1H), 6.73 (dd, J=14.6 Hz, 12.4 Hz, 1H), 6.62 (d, 2H), 6.33 (d, J=14.6 Hz, 1H), 4.13 (t, 2H), 3.81 (t, 2H), 3.55 (t, 2H), 3.00 (s, 3H), 1.89-1.79 (m, 2H), 1.34-1.14 (m, 10H), 1.00 (s, 9H), 0.83 (t, 3H).

### (Example 1-6) Synthesis of Compound (7)

In order to synthesize a compound (7), a compound (7-b) was synthesized by Buchwald amination reaction. Subsequently, a compound (7-c) was synthesized from the compound (7-b) by formylation reaction. Subsequently, a compound (7-d) was synthesized from the compound (7-c) by bromination reaction. Subsequently, a compound (7-e) was synthesized from the compound (7-d) by Suzuki coupling. The compound (7) was synthesized from the compound (7-e) by Knoevenagel condensation.

### Synthesis of Compound (7-b)

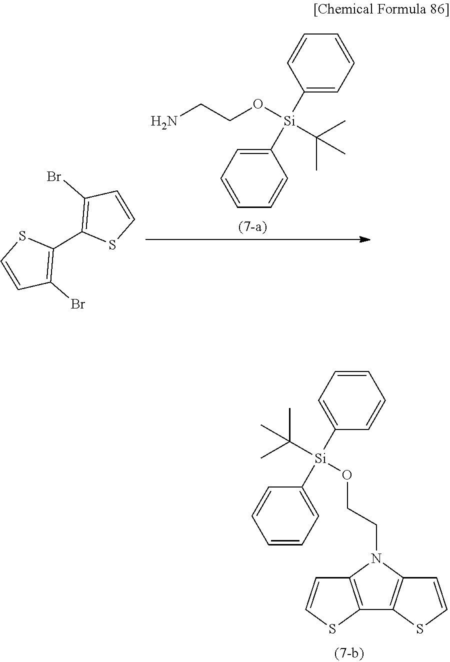 [SMILES: Brc1ccsc1-c1sccc1Br ; CC(C)(C)[Si](OCCN)(c1ccccc1)c1ccccc1 ; CC(C)(C)[Si](OCCn1c2ccsc2c2sccc21)(c1ccccc1)c1ccccc1]

The compound (7-a) was synthesized according to WO-A-2020/039962. Into a 2 L four-necked flask equipped with a three-way cock at a top and an induction stirring type stirrer, 65.00 g (200.59 mmol) of 3,3′-dibromo-2,2′-bithiophene (manufactured by Ambeed), 73.79 g (240.70 mmol) of the compound (7-a), and 1300 mL of dehydrated toluene were put, and the inside was replaced with nitrogen. 77.11 g (802.36 mmol) of sodium tert-butoxide, 11.65 g (10.03 mmol) of tris(benzylideneacetone) dipalladium, and 12.49 g (20.06 mmol) of (±)-2,2′-bis(diphenylphosphino)-1,1′-binaphthyl (manufactured by Tokyo Chemical Industry Co., Ltd.) were added thereto while the reaction mixture was stirred. Thereafter, the reaction vessel was immersed in an oil bath, and reaction was caused at 110° C. for 24 hours. After completion of the reaction, the reaction mixture was cooled to room temperature. Thereafter, the reaction mixture was washed with deionized water, and the organic layer was dried over anhydrous magnesium sulfate. The insoluble matter was filtered. The filtrate was concentrated by a rotary evaporator. The obtained concentrate was purified by column chromatography (mobile phase: hexane:chloroform=3:1) using toluene as a developing solvent, and then recrystallized (ethyl acetate:methanol=2:1) to obtain the target compound (7-b) as a pale yellow solid. The obtained amount was 62.28 g. A measurement result of an ¹H-NMR spectrum of the compound (7-b) is as follows.

¹H-NMR (400 MHz, CDCl₃): 7.44-7.32 (m, 6H), 7.29-7.244 (m, 4H), 7.07 (d, 2H), 6.88 (d, 2H), 4.33 (t, 2H), 3.94 (t, 2H), 0.91 (s, 9H).

### Synthesis of Compound (7-c)

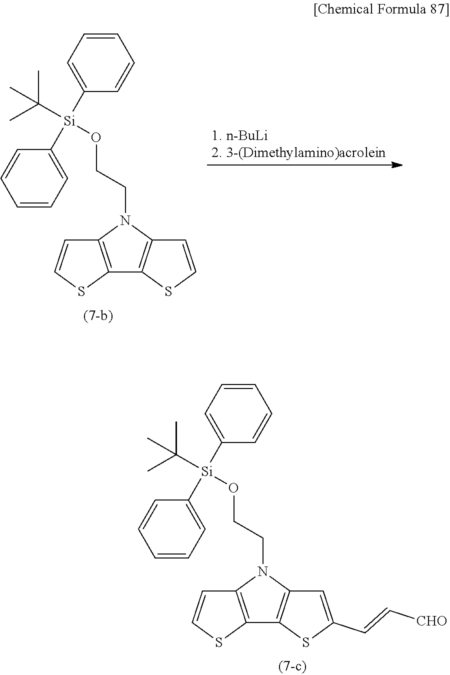 [SMILES: CC(C)(C)[Si](OCCn1c2ccsc2c2sccc21)(c1ccccc1)c1ccccc1 ; CC(C)(C)[Si](OCCn1c2ccsc2c2sc(/C=C/C=O)cc21)(c1ccccc1)c1ccccc1]

Into a 200 mL three-necked flask equipped with a three-way cock at a top, 4.10 g of the synthesized compound (7-a) and 82 mL of dehydrated tetrahydrofuran (manufactured by FUJIFILM Wako Pure Chemical Corporation) were put. A stirrer was further put thereinto, and the inside was replaced with nitrogen. The reaction mixture was immersed in a dry ice bath and cooled to −64° C., and 6.11 mL (9.77 mmol) of a 1.6 M butyllithium hexane solution (manufactured by KANTO CHEMICAL CO., INC.) was added thereto while the reaction mixture was stirred. After completion of the addition, the mixture was further stirred for 30 minutes while being cooled. Thereafter, 2.64 g of dimethylaminoacrolein (manufactured by Tokyo Chemical Industry Co., Ltd.) was added to the reaction mixture. After completion of the addition, the reaction mixture was heated to 0° C. with being stirred. After completion of the reaction, deionized water was added thereto, the separated aqueous layer was separated and removed, and the organic layer was dried over anhydrous magnesium sulfate. The solid content was separated by filtration, and the filtrate was concentrated and dried by a rotary evaporator to obtain the compound (7-c) as a brown viscous substance. The obtained amount was 5.39 g (yield: 98%). A measurement result of an ¹H-NMR spectrum of the compound (7-c) is as follows.

¹H-NMR (400 MHz, CDCl₃): 9.54 (d, 1H), 7.50 (d, 1H), 7.41-7.28 (m, 7H), 7.27-7.20 (m, 5H), 7.17 (s, 1H), 6.93 (d, 1H), 6.41 (dd, 1H), 4.34 (t, 2H), 3.92 (t, 2H), 0.85 (s, 9H).

### Synthesis of Compound (7-d)

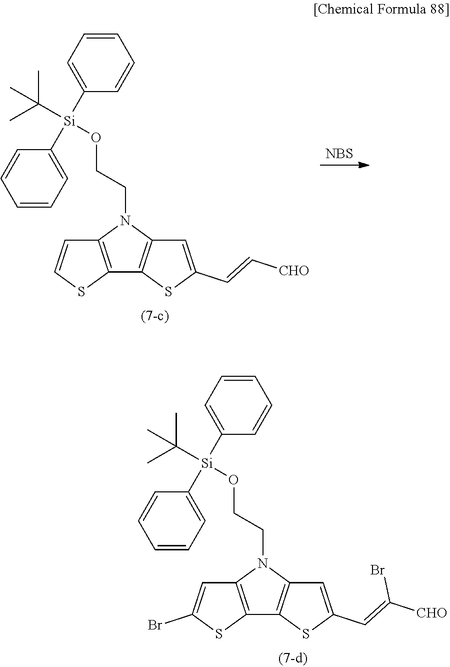 [SMILES: CC(C)(C)[Si](OCCn1c2ccsc2c2sc(/C=C/C=O)cc21)(c1ccccc1)c1ccccc1 ; "NBS" ; CC(C)(C)[Si](OCCn1c2cc(Br)sc2c2sc(/C=C(\Br)C=O)cc21)(c1ccccc1)c1ccccc1]

Into a 200 mL three-necked flask equipped with a three-way cock at a top, 2.00 g (3.36 mmol) of the compound (7-c) and 60 mL of dehydrated tetrahydrofuran (THF, manufactured by FUJIFILM Wako Pure Chemical Corporation) were put. A stirrer was further put thereinto, and the inside was replaced with nitrogen. Thereafter, the flask containing the reaction mixture was cooled to 0° C. Thereafter, 1.26 g (7.06 mmol) of N-bromosuccinimide (NBS, manufactured by Tokyo Chemical Industry Co., Ltd.) was added thereto. After completion of the addition, the reaction mixture was stirred for one hour, and caused to react while being cooled. After completion of the reaction, the reaction mixture was washed with deionized water. The obtained organic layer was dried over anhydrous magnesium sulfate. Thereafter, the insoluble matter was separated by filtration, and the filtrate was concentrated and dried by a rotary evaporator to obtain the compound (7-d). The obtained amount was 1.74 g (yield: 77%).

¹H-NMR (400 MHz, CD₂Cl₂): 9.23 (s, 1H), 7.99 (s, 1H), 7.47 (s, 1H), 7.38-7.28 (m, 6H), 7.26-7.21 (m, 4H), 7.00 (s, 1H), 4.32 (t, 2H), 3.92 (t, 2H), 0.85 (s, 9H).

### Synthesis of Compound (7-e)

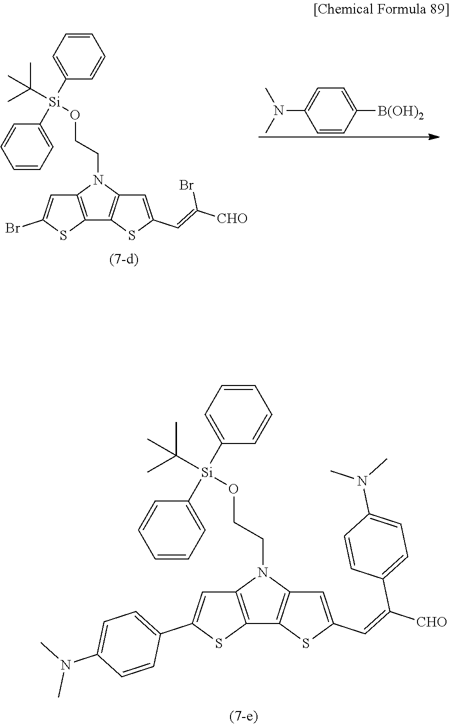 [SMILES: CC(C)(C)[Si](OCCn1c2cc(Br)sc2c2sc(/C=C(\Br)C=O)cc21)(c1ccccc1)c1ccccc1 ; CN(C)c1ccc(B(O)O)cc1 ; CN(C)c1ccc(/C(C=O)=C\c2cc3c(s2)c2sc(-c4ccc(N(C)C)cc4)cc2n3CCO[Si](c2ccccc2)(c2ccccc2)C(C)(C)C)cc1]

Into a 500 mL three-necked flask equipped with a Dimroth with a three-way cock at a top, 1.00 g (1.48 mmol) of the compound (7-d), 0.27 g (1.63 mmol) of 4-(dimethylamino) phenylboronic acid, and 30 mL of dehydrated THF were put. A stirrer was further added thereto, and the inside was replaced with argon. 1.5 mL (4.45 mmol) of a 3 M potassium phosphate aqueous solution was added thereto while the reaction mixture was stirred, and 0.04 g (0.04 mmol) of tris(dibenzylideneacetone) dipalladium (0) (manufactured by Strem Chemicals) and 0.5 g (0.15 mmol) of tri-tert-butylphosphonium tetrafluoroborate (manufactured by Tokyo Chemical Industry Co., Ltd.) were added thereto. The flask was immersed in an oil bath at 50° C., and reaction was caused for two hours while the reaction mixture was vigorously stirred. After completion of the reaction, the reaction mixture was cooled to room temperature, stirring was stopped, and the reaction mixture was allowed to stand still. The aqueous layer of the reaction mixture separated into two layers was removed, and the organic layer was dried over anhydrous magnesium sulfate. The insoluble matter was filtered. The filtrate was concentrated and dried by a rotary evaporator. The obtained crude reaction product was purified by silica gel chromatography (mobile phase: chloroform) to obtain the target compound (7-e). The obtained amount was 0.47 g (yield: 42%). A measurement result of an ¹H-NMR spectrum of the compound (7-e) is as follows.

¹H-NMR (400 MHz, CDCl₃): 9.63 (s, 1H), 7.46-7.32 (m, 9H), 7.28-7.24 (m, 4H), 7.13 (d, 2H), 7.00 (s, 1H), 6.87 (s, 1H), 6.84 (d, 2H), 6.68 (d, 2H), 4.26 (t, 2H), 3.92 (t, 2H), 3.03 (s, 6H), 3.00 (s, 6H), 0.90 (s, 9H)

### Synthesis of Compound (7)

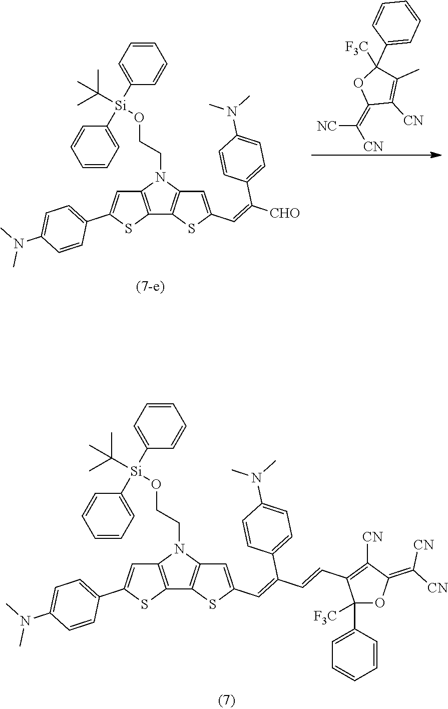 [SMILES: CN(C)c1ccc(/C(C=O)=C\c2cc3c(s2)c2sc(-c4ccc(N(C)C)cc4)cc2n3CCO[Si](c2ccccc2)(c2ccccc2)C(C)(C)C)cc1 ; CC1=C(C#N)C(=C(C#N)C#N)OC1(c1ccccc1)C(F)(F)F ; CN(C)c1ccc(C(=C\c2cc3c(s2)c2sc(-c4ccc(N(C)C)cc4)cc2n3CCO[Si](c2ccccc2)(c2ccccc2)C(C)(C)C)/C=C/C2=C(C#N)C(=C(C#N)C#N)OC2(c2ccccc2)C(F)(F)F)cc1]

Into a 100 mL eggplant flask equipped with a three-way cock at a top, 0.45 g (0.60 mmol) of the compound (7-e), 0.28 g (0.90 mmol) of 2-(3-cyano-4-methyl-5-phenyl-5-(trifluoromethyl)-2(5H)-furanylidene)-propanedinitrile (manufactured by IChemical), 5 mL of dehydrated ethanol, and 5 mL of dehydrated chloroform were put. A stirrer was further put thereinto, and the inside was replaced with nitrogen. The mixture was caused to react at room temperature for 30 hours while the reaction mixture was stirred with a stirrer. After completion of the reaction, the reaction mixture was concentrated and washed with 8 mL of ethanol to obtain a crude reaction product. The crude reaction product was purified by crystallization (ethyl acetate:acetonitrile=1:5) to obtain the compound (7) as a black solid. The obtained amount was 0.44 g (yield: 66%). A measurement result of an ¹H-NMR spectrum of the compound (7) is as follows.

¹H-NMR (400 MHz, CDCl₃): 8.08 (d, 1H, J=14.2 Hz), 7.51-7.30 (m, 13H), 7.26-7.20 (m, 4H), 7.08-6.75 (m, 5H), 6.68 (d, 2H), 5.94 (d, 1H, J=14.2 Hz), 4.22 (t, 4H), 3.91 (t, 2H), 3.09 (s, 6H), 3.01 (s, 6H), 0.88 (s, 9H).

### (Example 1-7) Synthesis of Compound (8)

A compound (8) was synthesized from the compound (6-d) by Knoevenagel condensation.

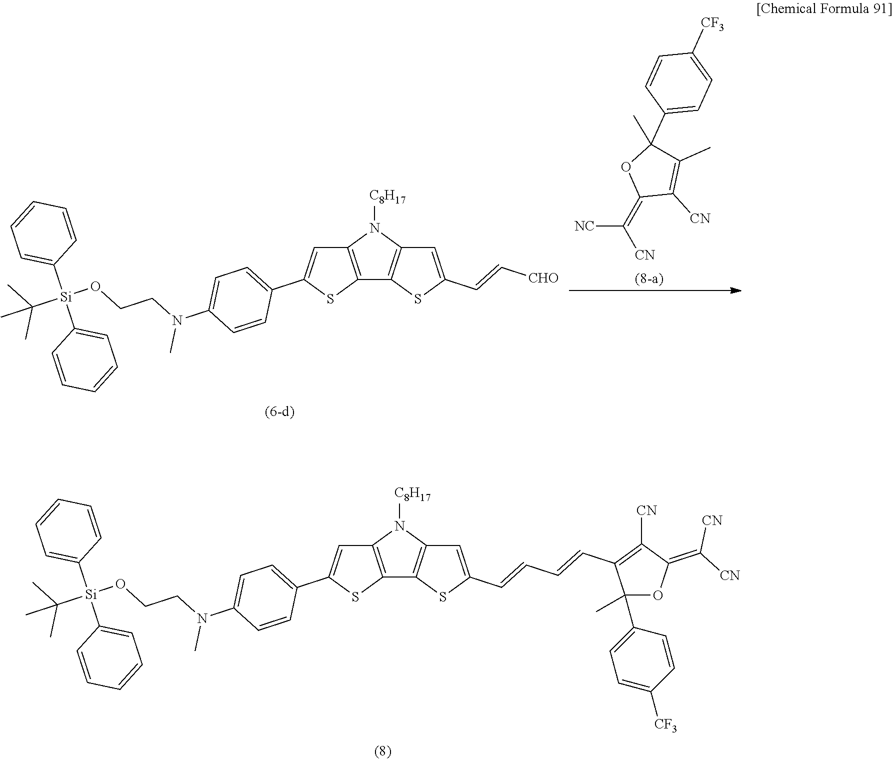

The compound (8-a) was synthesized according to a method described in WO-A-2019151318. Into a 100 mL eggplant flask equipped with a Dimroth with a three-way cock at a top, 0.45 g (0.60 mmol) of the compound (7-e), 1.80 g (5.46 mmol) of the compound (8-a), 20 mL of dehydrated ethanol, and 20 mL of dehydrated chloroform were put. A stirrer was further put thereinto, and the inside was replaced with nitrogen. The flask was immersed in an oil bath heated to 50° C., and reaction was caused for five hours while the reaction mixture was stirred with the stirrer. After completion of the reaction, the reaction mixture was concentrated and washed with 8 mL of ethanol to obtain a crude reaction product. The crude reaction product was purified by crystallization (chloroform:ethanol=1:1) to obtain the compound (8) as a black solid. The obtained amount was 2.51 g (yield: 88%). A measurement result of an ¹H-NMR spectrum of the compound (8) is as follows.

¹H-NMR (400 MHz, CD₂Cl₂): 7.73 (d, 2H), 7.62-7.58 (m, 4H), 7.50 (d, 2H), 7.44 (d, 2H), 7.42-7.22 (m, 8H), 7.12 (s, 1H), 7.02 (s, 1H), 6.67 (dd, 1H, J=14.4 Hz, 11.6 Hz), 6.61 (d, 2H), 6.32 (d, 1H, J=14.4 Hz), 4.13 (t, 2H), 3.08 (t, 2H), 3.54 (t, 2H), 2.99 (s, 3H), 2.10 (s, 3H), 1.89-1.78 (m, 2H), 1.33-1.15 (m, 10H), 1.00 (s, 9H), 0.82 (t, 3H).

### 2. Heating Stability Test

### (Measurement Conditions of High Performance Liquid Chromatography (HPLC))

A value of HPLC area percentage as an index of purity of a compound was determined by high performance liquid chromatography (HPLC, manufactured by Shimadzu Corporation, trade name: LC-20A) at 254 nm unless otherwise specified. 3 μL of an EO ink composition to be measured was injected. As a mobile phase of HPLC, acetonitrile and tetrahydrofuran were used, and water with 0.1% by mass acetic acid added thereto/acetonitrile (50/50):tetrahydrofuran=100:0 to 0:100 (volume ratio) was caused to flow at a flow rate of 1 mL/min by gradient analysis. As a column, SUMIPAXODSZ-CLUE having a particle diameter of 3 μm, an inner diameter of 4.6 mm, and a length of 250 mm (manufactured by Sumika Chemical Analysis Service, Ltd.) was used. As a detector, a photodiode array detector (manufactured by Shimadzu Corporation, trade name: SPD-M20 A) was used.

### (Calculation of Dipole Moment of Organic Solvent)

A dipole moment μ of an organic solvent was calculated by Gaussian 09 which is a quantum chemical calculation program manufactured by Gaussian. Structure optimization calculation was performed by pcm calculation (designating chloroform as a solvent) under an M062X/6-31+g(d) condition.

### Example 2-1

5 mg of a commercially available compound NEO-823 (manufactured by Tokyo Chemical Industry Co., Ltd.) was dissolved in 4 mL of ortho-dichlorobenzene to prepare an EO ink composition of Example 2-1, and the EO ink composition was heated and stirred for two hours on a hot plate heated to 140° C. When HPLC was measured before and after a heating stability test, a maintenance ratio of the compound was 102%. Note that the maintenance ratio r was obtained from the following formula (X).

$$r = S 1 / S 0 \qquad ( X )$$

S1: Value of HPLC area percentage of compound after heating stability test
S0: Value of HPLC area percentage of compound before heating stability test

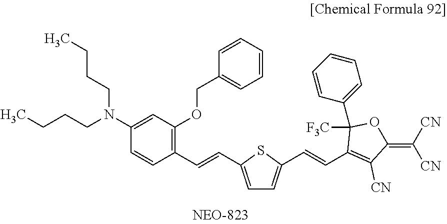 [SMILES: CCCCN(CCCC)c1ccc(/C=C/c2ccc(/C=C/C3=C(C#N)C(=C(C#N)C#N)OC3(c3ccccc3)C(F)(F)F)s2)c(OCc2ccccc2)c1]

### Example 2-2

A heating stability test was performed in a similar manner to Example 2-1 except that an EO ink composition of Example 2-2 was prepared using xylene in place of ortho-dichlorobenzene, and a maintenance ratio of the compound was calculated. The maintenance ratio of the compound was 98% before and after the heating stability test.

### Example 2-3

A heating stability test was performed in a similar manner to Example 2-1 except that an EO ink composition of Example 2-3 was prepared using propylene glycol monomethyl ether acetate (PGMEA) in place of ortho-dichlorobenzene, and a maintenance ratio of the compound was calculated. The maintenance ratio of the compound was 99% before and after the heating stability test.

### Example 2-4

A heating stability test was performed in a similar manner to Example 2-1 except that an EO ink composition of Example 2-4 was prepared using tetralin in place of ortho-dichlorobenzene, and a maintenance ratio of the compound was calculated. The maintenance ratio of the compound was 102% before and after the heating stability test.

### Example 2-5

A heating stability test was performed in a similar manner to Example 2-1 except that an EO ink composition of Example 2-5 was prepared using 2-heptanone in place of ortho-dichlorobenzene, and a maintenance ratio of the compound was calculated. The maintenance ratio of the compound was 94% before and after the heating stability test.

### Comparative Example 2-1

A heating stability test was performed in a similar manner to Example 2-1 except that an EO ink composition of Comparative Example 2-1 was prepared using dimethylacetamide in place of ortho-dichlorobenzene, and a maintenance ratio of the compound was calculated. The maintenance ratio of the compound was 88% before and after the heating stability test.

### Comparative Example 2-2

A heating stability test was performed in a similar manner to Example 2-1 except that an EO ink composition of Comparative Example 2-2 was prepared using cyclopentanone in place of ortho-dichlorobenzene, and a maintenance ratio of the compound was calculated. The maintenance ratio of the compound was 65% before and after the heating stability test.

Examples 2-1 to 2-5 and Comparative Examples 2-1 and 2-2 are summarized in Table 1.

TABLE 1

| | | Organic solvent | | | |
|---|---|---|---|---|---|
| | | | Boiling | | |
| | | | point | Dipole | Maintenance |
| | Compound | Type | (° C.) | moment μ | ratio r |
| Example 2-1 | NEO-823 | o-Dichlorobenzene | 180 | 2.3D | 102% |
| Example 2-2 | NEO-823 | Xylene | 139 | 0.4D | 98% |
| Example 2-3 | NEO-823 | PGMEA | 146 | 1.8D | 99% |
| Example 2-4 | NEO-823 | Tetralin | 208 | 0.4D | 102% |
| Example 2-5 | NEO-823 | 2-Heptanone | 151 | 2.6D | 94% |
| Comparative | NEO-823 | Dimethylacetamide | 164 | 3.7D | 88% |
| Example 2-1 | | | | | |
| Comparative | NEO-823 | Cyclopentanone | 131 | 3.3D | 70% |
| Example 2-2 | | | | | |

### Example 3-1

A heating stability test was performed in a similar manner to Example 2-1 except that an EO ink composition of Example 3-1 was prepared using the compound (1) of Example 1-1 in place of NEO-823, and a maintenance ratio of the compound was calculated. The maintenance ratio of the compound was 94% before and after the heating stability test.

### Example 3-2

A heating stability test was performed in a similar manner to Example 3-1 except that an EO ink composition of Example 3-2 was prepared using chlorobenzene in place of ortho-dichlorobenzene, and a maintenance ratio of the compound was calculated. The maintenance ratio of the compound was 102% before and after the heating stability test.

### Comparative Example 3-1

A heating stability test was performed in a similar manner to Example 3-1 except that an EO ink composition of Comparative Example 3-1 was prepared using cyclopentanone in place of ortho-dichlorobenzene, and a maintenance ratio of the compound was calculated. The maintenance ratio of the compound was 56% before and after the heating stability test.

Examples 3-1 and 3-2 and Comparative Examples 3-1 are summarized in Table 2.

TABLE 2

| | | Organic solvent | | | |
|---|---|---|---|---|---|
| | | | Boiling | | |
| | | | point | Dipole | Maintenance |
| | Compound | Type | (° C.) | moment μ | ratio r |
| Example 3-1 | Compound (1) | o-Dichlorobenzene | 180 | 2.3D | 94% |
| Example 3-2 | Compound (1) | Chlorobenzene | 131 | 1.6D | 102% |
| Comparative | Compound (1) | Cyclopentanone | 131 | 3.3D | 56% |
| Example 3-1 | | | | | |

### Example 4-1

A heating stability test was performed in a similar manner to Example 2-1 except that an EO ink composition of Example 4-1 was prepared using the compound (2) of Synthesis Example 1 in place of NEO-823, and a maintenance ratio of the compound was calculated. The maintenance ratio of the compound was 91% before and after the heating stability test.

### Comparative Example 4-1

A heating stability test was performed in a similar manner to Example 4-1 except that an EO ink composition of Comparative Example 4-1 was prepared using cyclopentanone in place of ortho-dichlorobenzene, and a maintenance ratio of the compound was calculated. The maintenance ratio of the compound was 51% before and after the heating stability test.

Examples 4-1 and Comparative Example 4-1 are summarized in Table 3.

TABLE 3

| | | Organic solvent | | | |
|---|---|---|---|---|---|
| | | | Boiling | | |
| | | | point | Dipole | Maintenance |
| | Compound | Type | (° C.) | moment μ | ratio r |
| Example 4-1 | Compound (2) | o-Dichlorobenzene | 180 | 2.3D | 91% |
| Comparative | Compound (2) | Cyclopentanone | 131 | 3.3D | 51% |
| Example 4-1 | | | | | |

### Example 5-1

A heating stability test was performed in a similar manner to Example 2-1 except that an EO ink composition of Example 5-1 was prepared using the compound (3) of Example 1-2 in place of NEO-823 and the EO ink composition was heated and stirred for eight hours on a hot plate heated to 140° C., and a maintenance ratio of the compound was calculated. The maintenance ratio of the compound was 100% before and after the heating stability test.

### Comparative Example 5-1

A heating stability test was performed in a similar manner to Example 5-1 except that an EO ink composition of Comparative Example 5-1 was prepared using cyclopentanone in place of ortho-dichlorobenzene, and a maintenance ratio of the compound was calculated. The maintenance ratio of the compound was 15% before and after the heating stability test.

Examples 5-1 and Comparative Example 5-1 are summarized in Table 4.

TABLE 4

| | | Organic solvent | | | |
|---|---|---|---|---|---|
| | | | Boiling | | |
| | | | point | Dipole | Maintenance |
| | Compound | Type | (° C.) | moment μ | ratio r |
| Example 5-1 | Compound (3) | o-Dichlorobenzene | 180 | 2.3D | 100% |
| Comparative | Compound (3) | Cyclopentanone | 131 | 3.3D | 15% |
| Example 5-1 | | | | | |

### Example 6-1

A heating stability test was performed in a similar manner to Example 2-1 except that an EO ink composition of Example 6-1 was prepared using the compound (4) of Example 1-3 in place of NEO-823, and a maintenance ratio of the compound was calculated. The maintenance ratio of the compound was 100% before and after the heating stability test.

### Comparative Example 6-1

A heating stability test was performed in a similar manner to Example 6-1 except that an EO ink composition of Comparative Example 6-1 was prepared using cyclopentanone in place of ortho-dichlorobenzene, and a maintenance ratio of the compound was calculated. The maintenance ratio of the compound was 62% before and after the heating stability test.

Examples 6-1 and Comparative Example 6-1 are summarized in Table 5.

TABLE 5

| | | Organic solvent | | | |
|---|---|---|---|---|---|
| | | | Boiling | | |
| | | | point | Dipole | Maintenance |
| | Compound | Type | (° C.) | moment μ | ratio r |
| Example 6-1 | Compound (4) | o-Dichlorobenzene | 180 | 2.3D | 100% |
| Comparative | Compound (4) | Cyclopentanone | 131 | 3.3D | 62% |
| Example 6-1 | | | | | |

### Example 7-1

A heating stability test was performed in a similar manner to Example 2-1 except that an EO ink composition of Example 7-1 was prepared using the compound (5) of Example 1-4 in place of NEO-823, and a maintenance ratio of the compound was calculated. The maintenance ratio of the compound was 99% before and after the heating stability test.

### Comparative Example 7-1

A heating stability test was performed in a similar manner to Example 7-1 except that an EO ink composition of Comparative Example 7-1 was prepared using cyclopentanone in place of ortho-dichlorobenzene, and a maintenance ratio of the compound was calculated. The maintenance ratio of the compound was 29% before and after the heating stability test.

Examples 7-1 and Comparative Example 7-1 are summarized in Table 6.

TABLE 6

| | | Organic solvent | | | |
|---|---|---|---|---|---|
| | | | Boiling | | |
| | | | point | Dipole | Maintenance |
| | Compound | Type | (° C.) | moment μ | ratio r |
| Example 7-1 | Compound (5) | o-Dichlorobenzene | 180 | 2.3D | 99% |
| Comparative | Compound (5) | Cyclopentanone | 131 | 3.3D | 29% |
| Example 7-1 | | | | | |

### Example 8-1

A heating stability test was performed in a similar manner to Example 2-1 except that an EO ink composition of Example 8-1 was prepared using the compound (6) of Example 1-5 in place of NEO-823, and a maintenance ratio of the compound was calculated. The maintenance ratio of the compound was 100% before and after the heating stability test.

### Comparative Example 8-1

A heating stability test was performed in a similar manner to Example 8-1 except that an EO ink composition of Comparative Example 8-1 was prepared using cyclopentanone in place of ortho-dichlorobenzene, and a maintenance ratio of the compound was calculated. The maintenance ratio of the compound was 61% before and after the heating stability test.

Examples 8-1 and Comparative Example 8-1 are summarized in Table 7.

TABLE 7

| | | Organic solvent | | | |
|---|---|---|---|---|---|
| | | | Boiling | | |
| | | | point | Dipole | Maintenance |
| | Compound | Type | (° C.) | moment μ | ratio r |
| Example 8-1 | Compound (6) | o-Dichlorobenzene | 180 | 2.3D | 100% |
| Comparative | Compound (6) | Cyclopentanone | 131 | 3.3D | 61% |
| Example 8-1 | | | | | |

### Example 9-1

A heating stability test was performed in a similar manner to Example 2-1 except that an EO ink composition of Example 9-1 was prepared using the compound (7) of Example 1-6 in place of NEO-823, and a maintenance ratio of the compound was calculated. The maintenance ratio of the compound was 90% before and after the heating stability test.

### Comparative Example 9-1

A heating stability test was performed in a similar manner to Example 9-1 except that an EO ink composition of Comparative Example 9-1 was prepared using cyclopentanone in place of ortho-dichlorobenzene, and a maintenance ratio of the compound was calculated. The maintenance ratio of the compound was 62% before and after the heating stability test.

Examples 9-1 and Comparative Example 9-1 are summarized in Table 8.

TABLE 8

| | | Organic solvent | | | |
|---|---|---|---|---|---|
| | | | Boiling | | |
| | | | point | Dipole | Maintenance |
| | Compound | Type | (° C.) | moment μ | ratio r |
| Example 9-1 | Compound (7) | o-Dichlorobenzene | 180 | 2.3D | 90% |
| Comparative | Compound (7) | Cyclopentanone | 131 | 3.3D | 62% |
| Example 9-1 | | | | | |

### Example 10-1

5 mg of the compound (8) of Example 1-7 was dissolved in 4 mL of ortho-dichlorobenzene to prepare an EO ink composition of Example 10-1, and the EO ink composition was heated and stirred for eight hours on a hot plate heated to 140° C. When HPLC was measured before and after a heating stability test, a maintenance ratio of the compound was 101%.

### Comparative Example 10-1

A heating stability test was performed in a similar manner to Example 10-1 except that an EO ink composition of Comparative Example 10-1 was prepared using cyclopentanone in place of ortho-dichlorobenzene, and a maintenance ratio of the compound was calculated. The maintenance ratio of the compound was 10% before and after the heating stability test.

Examples 10-1 and Comparative Example 10-1 are summarized in Table 9.

TABLE 9

| | | Organic solvent | | | |
|---|---|---|---|---|---|
| | | | Boiling | | |
| | | | point | Dipole | Maintenance |
| | Compound | Type | (° C.) | moment μ | ratio r |
| Example 10-1 | Compound (8) | o-Dichlorobenzene | 180 | 2.3D | 101% |
| Comparative | Compound (8) | Cyclopentanone | 131 | 3.3D | 10% |
| Example 10-1 | | | | | |

### Example 11-1

5 mg of a commercially available compound NEO-823 (manufactured by Tokyo Chemical Industry Co., Ltd.) and PMMA (manufactured by Aldrich) were dissolved in 4 mL of ortho-dichlorobenzene, and heated and stirred for two hours on a hot plate heated to 140° C. When HPLC was measured before and after a heating stability test, a maintenance ratio of the compound was 105%.

### Comparative Example 11-1

A heating stability test was performed in a similar manner to Example 11-1 except that an EO ink composition of Comparative Example 11-1 was prepared using cyclopentanone in place of ortho-dichlorobenzene, and a maintenance ratio of the compound was calculated. The maintenance ratio of the compound was 33% before and after the heating stability test.

### Example 11-2

A heating stability test was performed in a similar manner to Example 11-1 except that an EO ink composition of Example 11-2 was prepared using the compound (1) of Example 1-1 in place of NEO-823, and a maintenance ratio of the compound was calculated. The maintenance ratio of the compound was 94% before and after the heating stability test.

### Comparative Example 11-2

A heating stability test was performed in a similar manner to Example 11-2 except that an EO ink composition of Comparative Example 11-2 was prepared using cyclopentanone in place of ortho-dichlorobenzene, and a maintenance ratio of the compound was calculated. The maintenance ratio of the compound was 45% before and after the heating stability test.

Examples 11-1 and 11-2 and Comparative Examples 11-1 and 11-2 are summarized in Table 10.

TABLE 10

| | | | Amorphous | |
|---|---|---|---|---|
| | | Organic solvent | resin | Maintenance |
| | Compound | Type | Type | ratio r |
| Example 11-1 | NEO-823 | o-Dichlorobenzene | PMMA | 105% |
| Comparative | NEO-823 | Cyclopentanone | PMMA | 33% |
| Example 11-1 | | | | |
| Example 11-2 | Compound (1) | o-Dichlorobenzene | PMMA | 94% |
| Comparative | Compound (1) | Cyclopentanone | PMMA | 45% |
| Example 11-2 | | | | |

### Example 12-1

### (A) Preparation of Ink Composition

In 1.03 g of chlorobenzene (manufactured by FUJIFILM Wako Pure Chemical Corporation), 0.08 g of the compound (1) of Example 1-1 and 0.11 g of PMMA (manufactured by FUJIFILM Wako Pure Chemical Corporation) were dissolved to prepare an EO ink composition of Example 12-1.

### (B) Preparation of EO Film

The EO ink composition of Example 12-1 was applied onto a cleaned ITO substrate using a spin coater MS-A100 (manufactured by Mikasa Co., Ltd.), and then vacuum-dried at 95° C. for 2.5 hours. As a result, an EO film having a film thickness of 550 nm was obtained. On this film, an IZO thin film having a thickness of 270 nm was prepared by a sputtering method, and used as an upper electrode. Each of these thin films was heated to 110° C. Thereafter, an electric field of 140 V/μm was applied between the electrodes, and 110° C. was maintained for one minute. Each of these thin films was gradually cooled to room temperature with the electric field applied. Thereafter, the electric field was turned off to prepare an EO film of Example 12-1.

### (C) Measurement of EO Coefficient

An EO coefficient r33 of the obtained EO film was measured in a similar manner to a method described in a reference paper (“Transmission ellipsometric method without an aperture for simple and reliable evaluation of electro-optic properties”, Toshiki Yamada and Akira Otomo, Optics Express, voI. 21, pages 29240-48 (2013)). As laser light sources, LP1310-SAD2 (1310 nm) and LP1550-SAD2 (1550 nm) of semiconductor DFB laser (manufactured by THORLABS) were used. The EO coefficient r33 of the EO film of Example 12-1 at 1310 nm was 78 pm/V and 56 pm/V at 1550 nm.

As presented in Tables 1 to 10, each of the EO ink compositions of Examples, which is a combination of a predetermined compound and an organic solvent having a boiling point of 120° C. or higher and a dipole moment of less than 3.0 debye, had a higher compound maintenance ratio before and after the heating stability test than each of the EO ink compositions of Comparative Examples, which is not such a combination. In addition, the EO film of Example 12-1 containing a predetermined compound and an amorphous resin was found to have a sufficiently high EO coefficient. From these results, it was confirmed that the electro-optic ink composition of the present invention had excellent heating stability.

1. An electro-optic ink composition comprising:
at least one compound selected from the group consisting of a compound represented by the following formula (1′) and a compound represented by the following formula (1″); and
an organic solvent having a boiling point of 120° C. or higher and a dipole moment of less than 3.0 debye:
[Chemical Formula 1]
D¹-X¹-A¹ (1′)
[in formula (1′), D¹ represents an electron-donating group;
X¹ represents a divalent conjugated linking group or a single bond; and
A¹ represents a group represented by the following formula (a1)]: 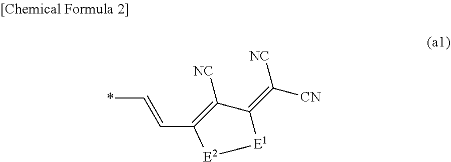
[in formula (a1), E¹ and E² each independently represent —C(R¹)(R²)—, —C(O)—, —O—, or —NR³—, and note that at least one of E¹ and E² is —O— or —NR³—;
R¹ and R² each independently represent a hydrogen atom, an alkyl group, a haloalkyl group, an aryl group, or a haloaryl group, and note that at least one of R¹ and R² is a group containing a halogen atom;
R³ represents a hydrogen atom or an alkyl group; and
* represents a bonding position],
[Chemical Formula 3]
D²-X²-A² (1″)
[in formula (1″), D² represents an electron-donating group;
X² represents a divalent conjugated linking group containing a divalent polycyclic condensed ring group, and the divalent polycyclic condensed ring group is a divalent polycyclic condensed ring group having one or two thienothiophene rings, having at least one selected from the group consisting of an sp3 carbon atom and a silicon atom as a constituent element, and not containing a benzene ring, and the number of rings in the entire condensed ring of the divalent polycyclic condensed ring group is 4 to 10; and
A² represents a group represented by the following formula (a2)]: 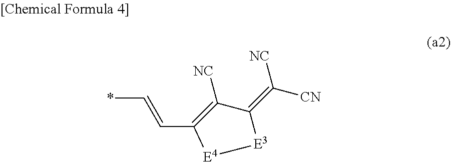
[in formula (a2), E³ and E⁴ each independently represent —C(R¹¹)(R¹²)—, —C(O)—, —O—, or —NR¹³—, and note that at least one of E³ and E⁴ is —O— or —NR¹³—;
R¹¹ and R¹² each independently represent a hydrogen atom, an alkyl group, or an aryl group;
R¹³ represents a hydrogen atom or an alkyl group; and
* represents a bonding position].

2. The electro-optic ink composition according to claim 1, wherein the D¹ and the D² are groups represented by the following formula (d1): 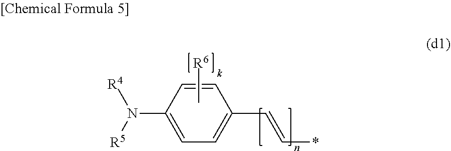
[in formula (d1), R⁴ and R⁵ each independently represent an alkyl group, a haloalkyl group, an acyloxyalkyl group, a trialkylsilyloxyalkyl group, an aryldialkylsilyloxyalkyl group, an alkyldiarylsilyloxyalkyl group, an aryl group, —R⁴¹—OH (R⁴¹ represents a divalent hydrocarbon group), —R⁴²—NH₂ (R⁴² represents a divalent hydrocarbon group), —R⁴³—SH (R⁴³ represents a divalent hydrocarbon group), or —R⁴⁴—NCO (R⁴⁴ represents a divalent hydrocarbon group), these groups may each have a crosslinkable group, and R⁴ and R⁵ may be bonded to each other to form a ring together with atoms to which R⁴ and R⁵ are bonded;
R⁶ represents an alkyl group, an alkyloxy group, an aryl group, an aryloxy group, an aralkyloxy group, a trialkylsilyloxyalkyl group, an aryldialkylsilyloxyalkyl group, an alkyldiarylsilyloxyalkyl group, an alkenyloxy group, an alkynyloxy group, a hydroxy group, an amino group, a sulfanyl group, an isocyanate group, —R⁶¹—OH (R⁶¹ represents a divalent hydrocarbon group), —O—R⁶²—OH (R⁶² represents a divalent hydrocarbon group), —R⁶³—NH₂ (R⁶³ represents a divalent hydrocarbon group), —R⁶⁴—SH (R⁶⁴ represents a divalent hydrocarbon group), —R⁶⁵—NCO (R⁶⁵ represents a divalent hydrocarbon group), or —OC(═O)R⁶⁶ (R⁶⁶ represents a monovalent hydrocarbon group), these groups may each have a crosslinkable group, when there are a plurality of R⁶s, R⁶s may be the same as or different from each other, and R⁶ may be bonded to R⁴ or R⁵ to form a ring together with atoms to which R⁶ and R⁴ or R⁵ are bonded;
k represents an integer of 0 to 4;
n represents 0 or 1; and
* represents a bonding position].

3. The electro-optic ink composition according to claim 1, further comprising an amorphous resin, wherein
the amorphous resin may form a covalent bond with the compound, or may form a crosslinked structure by reacting with a crosslinkable group of the compound.

4. A compound represented by the following formula (1A): 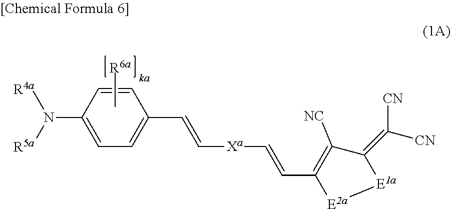
[in formula (1A), X^{a} represents a divalent polycyclic condensed ring group having two or more thiophene rings, having at least one selected from the group consisting of an sp3 carbon atom and a nitrogen atom as a constituent element, and not containing a benzene ring, and the divalent polycyclic condensed ring group may have a substituent;
E^{1a} and E^{2a} each independently represent —C(R^{1a})(R^{2a})—, —C(O)—, —O—, or —NR^{3a}—, and note that at least one of E^{1a} and E^{2a} is —O— or —NR^{3a}—;
R^{1a} and R^{2a} each independently represent a hydrogen atom, an alkyl group, a haloalkyl group, an aryl group, or a haloaryl group, and note that at least one of R^{1a} and R^{2a} is a group containing a halogen atom;
R^{3a} represents a hydrogen atom or an alkyl group;
R^{4a} and R^{5a} each independently represent an alkyl group, a haloalkyl group, an acyloxyalkyl group, a trialkylsilyloxyalkyl group, an aryldialkylsilyloxyalkyl group, an alkyldiarylsilyloxyalkyl group, an aryl group, —R^{41a}—OH (R^{41a} represents a divalent hydrocarbon group), —R^{42a}—NH₂ (R^{42a} represents a divalent hydrocarbon group), —R^{43a}—SH (R^{43a} represents a divalent hydrocarbon group), or —R^{44a}—NCO (R^{44a} represents a divalent hydrocarbon group), these groups may each have a crosslinkable group, and R^{4a} and R^{5a} may be bonded to each other to form a ring together with atoms to which R^{4a} and R^{5a} are bonded;
R^{6a} represents an alkyl group, an alkyloxy group, an aryl group, an aryloxy group, an aralkyloxy group, a trialkylsilyloxyalkyl group, an aryldialkylsilyloxyalkyl group, an alkyldiarylsilyloxyalkyl group, an alkenyloxy group, an alkynyloxy group, a hydroxy group, an amino group, a sulfanyl group, an isocyanate group, —R^{61a}—OH (R^{61a} represents a divalent hydrocarbon group), —O—R^{62a}—OH (R^{62a} represents a divalent hydrocarbon group), —R^{63a}—NH₂ (R^{63a} represents a divalent hydrocarbon group), —R^{64a}—SH (R^{64a} represents a divalent hydrocarbon group), —R^{65a}—NCO (R^{65a} represents a divalent hydrocarbon group), or —OC(═O)R^{66a} (R^{66a} represents a monovalent hydrocarbon group), these groups may each have a crosslinkable group, when there are a plurality of R^{6a}s, R^{6a}s may be the same as or different from each other, and R^{6a} may be bonded to R^{4a} or R^{5a} to form a ring together with atoms to which R^{6a} and R^{4a} or R^{5a} are bonded; and
ka represents an integer of 0 to 4].

5. The compound according to claim 4, wherein the compound represented by the above formula (1A) is a compound represented by the following formula (2): 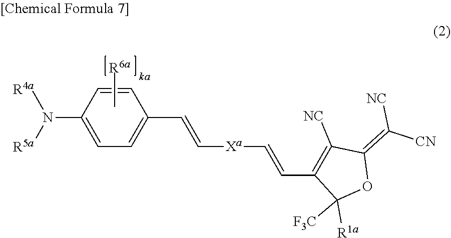
[in formula (2), X^{a}, R^{1a}, R^{4a}, R^{5a}, R^{6a}, and k^{a} have the same meanings as those described above, respectively].

6. A compound represented by the following formula (1B): 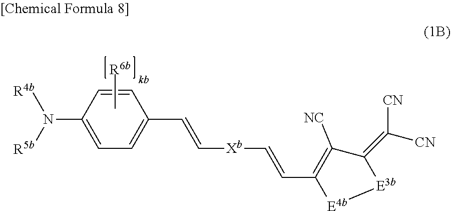
[in formula (1B), X^{b} represents a divalent polycyclic condensed ring group having one or two thienothiophene rings, having at least one selected from the group consisting of an sp3 carbon atom and a silicon atom as a constituent element, and not containing a benzene ring, and the number of rings in the entire condensed ring of the divalent polycyclic condensed ring group is 4 to 10, and the divalent polycyclic condensed ring group may have a substituent;
E^{3b} and E^{4b} each independently represent —C(R^{11b})(R^{12b})—, —C(O)—, —O—, or —NR^{13b}—, and note that at least one of E^{3b} and E^{4b} is —O— or —NR^{13b}—;
R¹ b and R^{12b} each independently represent a hydrogen atom, an alkyl group, or an aryl group;
R^{13b} represents a hydrogen atom or an alkyl group;
R^{4b} and R^{5b} each independently represent an alkyl group, a haloalkyl group, an acyloxyalkyl group, a trialkylsilyloxyalkyl group, an aryldialkylsilyloxyalkyl group, an alkyldiarylsilyloxyalkyl group, an aryl group, —R^{41b}—OH (R^{41b} represents a divalent hydrocarbon group), —R^{42b}—NH₂ (R^{42b} represents a divalent hydrocarbon group), —R^{43b}—SH (R^{43b} represents a divalent hydrocarbon group), or —R^{44b}—NCO (R^{44b} represents a divalent hydrocarbon group), these groups may each have a crosslinkable group, and R^{4a} and R^{5a} may be bonded to each other to form a ring together with atoms to which R^{4a} and R^{5a} are bonded;
R^{6b} represents an alkyl group, an alkyloxy group, an aryl group, an aryloxy group, an aralkyloxy group, a trialkylsilyloxyalkyl group, an aryldialkylsilyloxyalkyl group, an alkyldiarylsilyloxyalkyl group, an alkenyloxy group, an alkynyloxy group, a hydroxy group, an amino group, a sulfanyl group, an isocyanate group, —R^{61b}—OH (R^{61b} represents a divalent hydrocarbon group), —O—R^{62b}—OH (R^{62b} represents a divalent hydrocarbon group), —R^{63b}—NH₂ (R^{63b} represents a divalent hydrocarbon group), —R^{64b}—SH (R^{64b} represents a divalent hydrocarbon group), —R^{65b}—NCO (R^{65b} represents a divalent hydrocarbon group), or —OC(═O)R^{66b} (R^{66b} represents a monovalent hydrocarbon group), these groups may each have a crosslinkable group, when there are a plurality of R^{6b}s, R^{6b}s may be the same as or different from each other, and R^{6b} may be bonded to R^{4b} or R^{5b} to form a ring together with atoms to which R^{6b} and R^{4b} or R^{5b} are bonded; and
kb represents an integer of 0 to 4].

7. A compound represented by the following formula (1C): 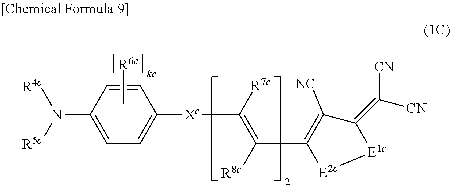
[in formula (1C), X^{c} represents a divalent polycyclic condensed ring group having two or more thiophene rings or a heteroarylene group having two or more thiophene rings, and the divalent polycyclic condensed ring group and the heteroarylene group may each have a substituent;
E^{1C} and E^{2C} each independently represent —C(R^{1C})(R^{2C})—, —C(O)—, —O—, or —NR^{3C}—, and note that at least one of E^{1C} and E^{2C} is —O— or —NR^{a}—;
R^{1C} and R^{2C} each independently represent a hydrogen atom, an alkyl group, a haloalkyl group, an aryl group, or a haloaryl group, and note that at least one of R^{1C} and R^{2C} is a group containing a halogen atom;
R^{3C} represents a hydrogen atom or an alkyl group;
R^{4C} and R^{5C} each independently represent an alkyl group, a haloalkyl group, an acyloxyalkyl group, a trialkylsilyloxyalkyl group, an aryldialkylsilyloxyalkyl group, an alkyldiarylsilyloxyalkyl group, an aryl group, —R^{41C}—OH (R^{41c} represents a divalent hydrocarbon group), —R^{42C}—NH₂ (R^{42c} represents a divalent hydrocarbon group), —R^{43C}—SH (R^{43c} represents a divalent hydrocarbon group), or —R^{44C}—NCO (R^{44c} represents a divalent hydrocarbon group), these groups may each have a crosslinkable group, and R^{4C} and R^{5C} may be bonded to each other to form a ring together with atoms to which R^{4C} and R^{5C} are bonded;
R^{6C} represents an alkyl group, an alkyloxy group, an aryl group, an aryloxy group, an aralkyloxy group, a trialkylsilyloxyalkyl group, an aryldialkylsilyloxyalkyl group, an alkyldiarylsilyloxyalkyl group, an alkenyloxy group, an alkynyloxy group, a hydroxy group, an amino group, a sulfanyl group, an isocyanate group, —R^{61C}—OH (R^{61C} represents a divalent hydrocarbon group), —O—R^{62C}—OH (R^{62c} represents a divalent hydrocarbon group), —R^{63C}—NH₂ (R^{63C} represents a divalent hydrocarbon group), —R^{64C}—SH (R^{64C} represents a divalent hydrocarbon group), —R^{65C}—NCO (R^{65c} represents a divalent hydrocarbon group), or —OC(═O)R^{66c} (R^{66c} represents a monovalent hydrocarbon group), these groups may each have a crosslinkable group, when there are a plurality of R^{6C}s, R^{6C}s may be the same as or different from each other, and R^{6C} may be bonded to R^{4C} or R^{5C} to form a ring together with atoms to which R^{6C} and R^{4C} or R^{5C} are bonded;
kc represents an integer of 0 to 4; and
R^{7c} and R^{8c} each independently represent a hydrogen atom, an alkyl group, or an aryl group].

8. An electro-optic ink composition comprising the compound according to claim 4.

9. An electro-optic film comprising the electro-optic ink composition according to claim 1 as a forming material.

10. An electro-optic film comprising the compound according to claim 4.

11. An electro-optic element comprising the electro-optic film according to claim 9.

12. An electro-optic element comprising the electro-optic film according to claim 10.
